(19) United States
(12) Patent Application Publication
(10) Pub. No.: US 2012/0272457 A1
(43) Pub. Date: Nov. 1, 2012

(54) UNITARY COMPOSITE/HYBRID CUSHIONING STRUCTURE(S) AND PROFILE(S) COMPRISED OF A THERMOPLASTIC FOAM(S) AND A THERMOSET MATERIAL(S) AND RELATED METHODS

(75) Inventors: Michael Allman, Wilson, NC (US); Bangshu Cao, Raleigh, NC (US); Andrew Costas Yiannaki, Raleigh, NC (US); Ivan Sobran, Raleigh, NC (US); Randal Lee Henderson, Zebulon, NC (US)

(73) Assignee: NOMACO INC., Zebulon, NC (US)

(21) Appl. No.: 13/458,239

(22) Filed: Apr. 27, 2012

Related U.S. Application Data
(60) Provisional application No. 61/480,780, filed on Apr. 29, 2011.

(51) Int. Cl. A47C 23/04; A47C 17/00; B29C 47/02; B32B 5/22; B32B 5/18

(52) U.S. Cl. 5/716; 428/105; 428/76; 264/151; 5/690

(57) ABSTRACT

Related methods to produce unitary or monolithic composite or hybrid cushioning structure(s) and profile(s) comprised of a thermoplastic foam and a thermoset material are also disclosed. As non-limiting examples, the thermoset material may also be provided as cellular foam. The unitary composite cushioning structure may be formed from the thermoplastic material and the thermoset material. The thermoplastic material provides support characteristics to the unitary composite cushioning structure. The thermoset material provides a resilient structure with cushioning characteristics to the cushioning structure. A stratum, which may be continuously produced, is formed between at least a portion of the cellular thermoplastic foam and at least a portion of the thermoset material as the thermoset material transforms from a non-solid to a solid phase to secure the at least a portion of the thermoset material to the at least a portion of the thermoplastic material to provide a unitary composite cushioning structure.

### PRIORITY APPLICATION

This application is related to U.S. Provisional Patent Application Ser. No. 61/480,780, filed on Apr. 29, 2011, entitled “UNITARY COMPOSITE/HYBRID CUSHIONING STRUCTURE(S) AND PROFILE(S) COMPRISED OF A THERMOPLASTIC FOAM(S) AND A THERMOSET MATERIAL(S) AND RELATED METHODS,” which is hereby incorporated herein by reference in its entirety.

### RELATED APPLICATION

This application is related to U.S. patent application Ser. No. 12/716,804, filed on Mar. 3, 2010, entitled “UNITARY COMPOSITE/HYBRID CUSHIONING STRUCTURE(S) AND PROFILE(S) COMPRISED OF A THERMOPLASTIC FOAM(S) AND A THERMOSET MATERIAL(S),” which claims priority to U.S. Provisional Patent Application No. 61/157,970, filed on Mar. 6, 2009, entitled “COMPOSITE/HYBRID STRUCTURES AND FORMULATIONS OF THERMOSET ELASTOMER FOAMS AND THERMOPLASTIC ENGINEERED GEOMETRIC FOAM PROFILES,” both of which are hereby incorporated herein by reference in their entireties.

### BACKGROUND

1. Field of the Disclosure

The technology of this disclosure relates generally to cushioning structures. The cushioning structures can be used for any cushion applications desired, including but not limited to mattresses, seats, foot and back support, and upholstery, as examples.

2. Technical Background

Cushioning structures are employed in support applications. Cushioning structures can be employed in bedding and seating applications, as examples, to provide cushioning and support. Cushioning structures may also be employed in devices for safety applications, such as helmets and automobiles for example.

The design of a cushioning structure may be required to have both high and low stiffness. For example, it may be desirable to provide a cushioning material or device in which a body or object will easily sink into the cushion a given distance before the applied weight is supported. As another example, it may be desired to provide surfaces having low stiffness initially during application of weight, while the underlying structure needs to have high stiffness for support. These surfaces may be provided in safety applications, such as helmets and automobile dashboards as examples. In this regard, a cushioning structure may be designed that provides an initial large deflection at a low applied force with nonlinearly increasing stiffness at increasing deflection.

To provide a cushioning structure with high and low stiffness features, cushioning structures can be composed of layers of varying thicknesses and properties. Each of these components has different physical properties, and as a result of these properties and variations in thicknesses and location of the components, the cushioning structure has a certain complex response to applied pressure. For example, cushioning structures generally include components made from various types of foam, cloth, fibers and/or steel to provide a general response to pressure that is perceived as comfortable to the individual seeking a place to lie, sit, or rest either the body as a whole or portions thereof. General foam plastic materials can also be used as materials of choice for cushion applications. Foam plastic materials provide a level of cushionability in and of themselves, unlike a steel spring or the like structure. Generally accepted foams fall within two categories: thermosets and thermoplastics.

Thermoset materials exhibit the ability to recover after repeated deformations and provide a generally accepted sleep and/or cushioning surface. Thermoplastic materials including thermoplastic foams, and specifically closed cell thermoplastic foams, on the other hand, while not having the long time frame repeatable deformation capabilities of the thermoset foams, typically provide greater firmness and support. Further, thermoplastic materials are suitable to lower density, less weight, and therefore less costly production while maintaining a more structurally stable aspect to their construction.

One example of a cushioning structure employing layers of varying thicknesses and properties for discussion purposes is provided in a mattress 10 of FIG. 1. As illustrated therein, a mattress innerspring 12 (also called “innerspring 12”) is provided. The innerspring 12 is comprised of a plurality of traditional coils 14 arranged in an interconnected matrix to form a flexible core structure and support surfaces of the mattress 10. The coils 14 are also connected to each other through interconnection helical wires 16. Upper and lower border wires 18, 20 are attached to upper and lower end turns of the coils 14 at the perimeter of the array to create a frame for the innerspring 12. The upper and lower border wires 18, 20 also create firmness for edge support on the perimeter of the innerspring 12 where an individual may disproportionally place force on the innerspring 12, such as during mounting onto and dismounting from the mattress 10. The innerspring 12 is disposed on top of a box spring 22 to provide base support.

The coils 14 located proximate to an edge 23 of the innerspring 12 are subjected to concentrated loads as opposed to coils 14 located in an interior 24. To provide further perimeter structure and edge support for the innerspring 12, support members 25 may be disposed around the coils 14 proximate to the edge 23 of the innerspring 12 between the box spring 22 and the upper and lower border wires 18, 20. The support members 25 may be extruded from polymer-foam as an example.

To provide a cushioning structure with high and low stiffness features, various layers of sleeping surface or padding material 26 can be disposed on top of the innerspring 12. The padding material 26 provides a cushioning structure for a load placed on the mattress 10. In this regard, the padding material 26 may be made from various types of foam, cloth, fibers and/or steel to provide a generally repeatable comfortable feel to the individual seeking a place to either lie, sit, or rest, either the body as a whole or portions thereof. To provide the cushioning structure with high and low stiffness features, the padding material 26 may consist of multiple layers of materials that may exhibit different physical properties.

For example, foam plastic materials can be used as materials of choice for the padding material 26. Foam plastic materials provide a level of cushionability in and of themselves, unlike a steel spring, or the like structure. For example, an uppermost layer 28 may be a soft layer comprised of a thermoset material. Thus, in the example of FIG. 1, the uppermost layer 28 being provided as a thermoset material allows a load to sink into the mattress 10 while exhibiting the ability to recover after repeated deformations. One or more intermediate layers 30 underneath the uppermost layer 28 may be provided to have greater stiffness than the uppermost layer 28 to provide support and pressure spreading that limits the depth to which a load sinks. For example, the intermediate layers 30 may also include a thermoset material, such as latex as an example. A bottom layer 32 may be provided below the intermediate layers 30 and uppermost layer 28. The uppermost layer 28, the intermediate layers 30, and the bottom layer 32 serve to provide a combination of desired cushioning characteristics. An upholstery 34 is placed around the entire padding material 26, innerspring 12, and box spring 22 to provide a fully assembled mattress 10.

The material selection and thicknesses of the uppermost layer 28, the intermediate layers 30, and the bottom layer 32 of the mattress 10 can be designed to control and provide the desired cushioning characteristics. However, it may be desired to also provide support characteristics in the padding material 26. However, the disposition of layers in the padding material 26 does not easily allow for providing variations in both cushioning and support characteristics. For example, a thermoplastic foam could be included in the padding material 26 to provide greater firmness. However, compression will occur in the thermoplastic foam over time. Regardless, further complications that can occur as a result of including an additional thermoplastic material include the separate manufacturing and stocking for assembly of the mattress 10, thus adding inventory and storage costs. Further, an increase in the number of structures provided in the padding material 26 during assembly of the mattress 10 increases labor costs.

### SUMMARY OF THE DETAILED DESCRIPTION

Embodiments disclosed in the detailed description include a unitary or monolithic composite (or hybrid) cushioning structure(s) and profile(s) comprised of a thermoplastic foam and a thermoset material. Embodiments disclosed in the detailed description also include methods of producing unitary or monolithic composite (or hybrid) cushioning structure(s) and profile(s) comprised of a thermoplastic foam and a thermoset material.

In this regard in one embodiment, a cushioning layer formed from a thermoplastic material and a thermoset material is disclosed. The cushioning layer includes a plurality of unitary composite cushioning structures spaced apart in a first direction within each row of a plurality of rows. Each row of the plurality of rows is spaced apart from an adjacent row in a second direction. Each of the plurality of unitary composite cushioning structures includes a stratum disposed between at least a portion of the thermoplastic foam material and at least a portion of the thermoset material to thereby secure the at least a portion of the thermoset material to the at least a portion of the thermoplastic foam material to form the unitary composite cushioning structure. The first direction and the second direction are orthogonal to each other.

In another embodiment, a mattress assembly for bedding or seating is disclosed. The mattress assembly includes at least one cushioning layer formed from a thermoplastic material and a thermoset material. The cushioning layer includes a plurality of unitary composite cushioning structures spaced apart in a first direction within each row of a plurality of rows. Each row of the plurality of rows is spaced apart from an adjacent row in a second direction. Each of the plurality of unitary composite cushioning structures includes a stratum disposed between at least a portion of the thermoplastic foam material and at least a portion of the thermoset material to thereby secure the at least a portion of the thermoset material to the at least a portion of the thermoplastic foam material to form the unitary composite cushioning structure. The first direction and the second direction are orthogonal to each other.

In another embodiment, a unitary composite cushioning structure is disclosed. The unitary composite cushioning structure includes an outer material including a closed profile comprising a base portion and a head portion including a neck portion therebetween. The outer material including one of the thermoplastic material and the thermoset material. The unitary composite cushioning structure also includes core material disposed in the outer material. The core material including one of the thermoplastic material and the thermoset material. The unitary composite cushioning structure also includes a stratum disposed between at least a portion of the outer material and at least a portion of the core material to secure the at least a portion of the thermoset material to the at least a portion of the thermoplastic material to form the unitary composite cushioning structure

In another embodiment, a continuous process to produce a unitary composite cushioning structure is disclosed. The continuous process includes extruding thermoplastic material into a desired profile using an extruder die. The continuous process also includes conveying the thermoplastic material using a conveyor in a direction away from the extruder die. The continuous process includes dispensing with a dispensing unit a thermoset material in a non-solid phase into an internal chamber of the desired profile of the thermoplastic material to form a unitary composite cushioning structure with a stratum of between a portion of the thermoset material and a portion of the thermoplastic material. The continuous process includes cutting the unitary composite cushioning structure into segments.

In another embodiment, a mattress assembly is disclosed. The mattress assembly includes a base containing a matrix of openings configured to support an outer diameter of foam springs to retain the foam springs in designated areas. The mattress assembly includes a top containing a similar matrix of openings configured to retain top portions of the foam springs. The mattress assembly includes a cover portion disposed atop the top to limit movement of the foam springs. The mattress assembly includes side cuts disposed between adjacent foam springs to control cushioning and support characteristics.

In another embodiment, the thermoset material may also be provided as cellular foam as well. In one embodiment disclosed herein, the unitary composite or hybrid cushioning structure is formed from a thermoplastic foam and a thermoset material. The thermoplastic foam provides support characteristics to the unitary composite cushioning structure. The thermoset material provides a resilient structure with cushioning characteristics to the cushioning structure. A stratum is disposed between at least a portion of the cellular thermoplastic foam and at least a portion of the thermoset material to secure the at least a portion of the thermoset material to the at least a portion of the thermoplastic foam to provide a unitary composite cushioning structure.

The stratum may be continuously propagated between a portion of the cellular thermoplastic foam and a portion of the thermoset material during manufacture to secure the portion of the thermoset material to the portion of the cellular thermoplastic foam as the thermoset material is continuously dispensed into a continuously extruded cellular thermoplastic foam. In one embodiment, the stratum is formed by disposing a non-solid phase of the cellular thermoset material on or into a cellular thermoplastic foam profile. The cellular thermoset material undergoes a transition into a solid phase to form a bond with the cellular thermoplastic material, to secure the at least a portion of the cellular thermoset material to the at least a portion of the cellular thermoplastic material to form the unitary composite cushioning structure. The unitary composite cushioning structure exhibits a combination of the support characteristics and the resilient structure with cushioning characteristics when the unitary composite cushioning structure is placed under a load.

The stratum can include a cohesive or adhesive bond, such as a mechanical or chemical bond, as examples. The stratum may provide an intimate engagement between at least a portion of the thermoset material and at least a portion of the cellular thermoplastic foam to provide the unitary composite cushioning structure. The cellular thermoplastic foam may also be provided as a custom engineered profile to provide a custom engineered profile for engagement of the thermoset material and thus the unitary composite cushioning structure. The stratum may be continuously propagated between a portion of the cellular thermoplastic foam and a portion of the thermoset material during manufacture to secure the portion of the thermoset material to the portion of the cellular thermoplastic foam as the thermoset material is continuously dispensed into a continuously extruded cellular thermoplastic foam.

A unitary structure within the context of this disclosure is a structure having the character of a unit, undivided and integrated. The term composite or hybrid within the context of this disclosure is a complex structure having two or more distinct structural properties provided by two or more distinct material structures that are cohesively or adhesively bonded together to provide the combined functional properties of the two or more distinct structural properties which are not present in combination in any individual material structure.

There are several non-limiting and non-required advantages of the unitary composite cushioning structures disclosed herein. For example, the unitary composite cushioning structure is provided as a unitary structure as opposed to providing disparate, non-bonded structures each comprised exclusively of thermoplastic or thermoset materials. This allows the tactile cushioning and resiliency benefits of thermoset materials and the supportive and structural capabilities of the cellular thermoplastic foams to create a cushioning structure combining the desired characteristics and features of both material types into one unitary composite cushioning structure.

Further, the thermoset material provided as part of the unitary composite cushioning structure allows the cellular thermoplastic foam to exhibit excellent offset of compression set while retaining support characteristics to provide stability to the unitary composite cushioning structure. Thermoset materials can be selected that exhibit the desired offset of compression set. Without the employment of the thermoset material, the thermoplastic profile may not be able to provide the desired support characteristics without the undesired effects of compression set, also known as “sagging.” This engagement of a thermoset material with a cellular thermoplastic foam utilizes the thermoset material's ability to recover over long periods of repeated deformations. Another advantage can be cost savings. The cellular thermoplastic foam may be less expensive than the thermoset material while still providing a suitable composite cushioning structure exhibiting desired stability and offset of compression set.

Non-limiting examples of thermoplastic materials that can be used to provide a cellular thermoplastic foam in the unitary composite cushioning structure include polypropylene, polypropylene copolymers, polystyrene, polyethylenes, ethylene vinyl acetates (EVAs), polyolefins, including metallocene catalyzed low density polyethylene, thermoplastic olefins (TPOs), thermoplastic polyester, thermoplastic vulcanizates (TPVs), polyvinyl chlorides (PVCs), chlorinated polyethylene, styrene block copolymers, ethylene methyl acrylates (EMAs), ethylene butyl acrylates (EBAs), and the like, and derivatives thereof. The density of the thermoplastic material may be provided to any density desired to provide the desired weight and support characteristics for the unitary composite cushioning structure. Further, a thermoplastic material can be selected that is inherently resistant to microbes and bacteria, making such desirable for use in the application of cushioning structures. These thermoplastic materials can also be made biodegradable and fire retardant through the use of additive master batches.

Non-limiting examples of thermoset materials include polyurethanes, natural and synthetic rubbers, such as latex, silicones, EPDM, isoprene, chloroprene, neoprene, melamine-formaldehyde, and polyester, and derivatives thereof. The density of the thermoset material may be provided to any density desired to provide the desired resiliency and cushioning characteristics to the unitary composite cushioning structure. The thermoset material and can be soft or firm depending on formulations and density selections. Further, if the thermoset material selected is a natural material, such as latex for example, it may be considered biodegradable. Further, bacteria, mildew, and mold cannot live in certain thermoset foams.

Numerous variations of the unitary composite cushioning structure and its thermoplastic and thermoset components are disclosed. For example, the cellular thermoplastic foam may be closed-cell foam, open-cell foam, or partially open or closed-cell foam. The cellular thermoplastic foam may be provided or engineered as a cellular foam profile with desired geometrical configurations to provide controlled deformation support characteristics. For example, one or more open or closed channels can be disposed in a cellular thermoplastic foam profile, wherein the thermoset material is disposed within the channels to provide the resiliency and cushioning characteristics of the thermoset material to the support characteristics of the cellular thermoplastic foam profile. Alternatively, a cellular thermoplastic profile may be encapsulated fully or partially by a thermoset material to provide the resiliency and cushioning characteristics of the thermoset material to the support characteristics of the cellular thermoplastic foam profile. These cellular thermoplastic foam profiles may be produced by any method or process desired including but not limited to direct continuous extrusion, extrusion injection molding, blow molding, casting, thermal forming, and the like.

The unitary composite cushioning structure may be used as a cushion structure for any application desired. Examples include, but are not limited to, cushions, pillows, mattress assemblies, seat assemblies, helmet assemblies, mats, grips, packagings, and bolsters. Specifically in regard to mattress assemblies, the unitary composite cushioning structure could be employed in any part or component of the mattress assembly, including but not limited to bases, edge supports, side supports, corner supports, support components, and padding materials, and as coil-like structures to replace or be used in combination with traditional metal coils to provide support. Further, the unitary composite cushioning structures could be provided in particular regions or zones of a support structure to provide different zones of cushioning characteristics. For example, the unitary composite cushioning structures could be deployed to areas where heavier loads are supported to provide increased support, such as lumbar, head, and/or foot support, as examples.

Additional features and advantages will be set forth in the detailed description which follows, and in part will be readily apparent to those skilled in the art from that description or recognized by practicing the invention as described herein, including the detailed description that follows, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1 is an exemplary prior art mattress employing an innerspring of wire coils;

FIG. 2 is an exemplary chart of performance curves showing strain (i.e., deflection) under a given stress (i.e., pressure) for an exemplary thermoplastic material and thermoset material to illustrate their individual support characteristics and resiliency and cushioning characteristics, and the combined support characteristics of the thermoplastic material and the resilient structure with cushioning characteristics of the thermoset material when provided in a unitary composite cushioning structure;

FIG. 3 is an exemplary unitary composite cushioning structure comprised of a thermoset material cohesively or adhesively bonded to a thermoplastic material with a stratum disposed therebetween;

FIG. 4 is an exemplary chart of performance curves showing strain (i.e., deflection) under a given stress (i.e., pressure) for different types of thermoplastic foam structures to show the ability to engineer a cellular thermoplastic foam profile to provide for manufacturing a unitary composite cushioning structure;

FIG. 5 is a side view of a cross-section of another exemplary cellular thermoset foam profile substantially surrounded by and cohesively or adhesively bonded to a cellular thermoplastic foam and a stratum disposed therebetween, to form a unitary composite cushioning structure;

FIG. 6 is an exemplary chart illustrating the recovery characteristics of the unitary composite cushioning structure of FIG. 5 versus the recovery characteristics of the cellular thermoplastic foam profile of FIG. 5 over elapsed time to illustrate the improved compression set characteristics of the unitary composite cushioning structure over the cellular thermoplastic foam profile;

FIG. 7 is a cross-section of an exemplary mattress illustrating various cushioning layers where a unitary composite cushioning structure according to exemplary embodiments disclosed herein may be deployed;

FIG. 8 is a perspective view of an exemplary sleep or seat surface comprised of a plurality of the unitary composite cushioning structures in FIG. 5 comprised of cellular thermoset foam profiles substantially surrounded by and cohesively or adhesively bonded to a cellular thermoplastic foam and a stratum disposed therebetween, to form a unitary composite cushioning structures;

FIG. 9 is a perspective view of another exemplary sleep or seat surface comprised of a plurality of the unitary composite cushioning structures in FIG. 5 offset from adjacent unitary composite cushioning structures to provide motion isolation on the sleep or seat surface;

FIGS. 10A and 10B are perspective and side views, respectively, of an exemplary unitary composite cushioning structure comprised of an extruded thermoplastic foam profile incorporating chambers with a thermoset material disposed in the chambers and a stratum provided therebetween to provide zoned cushioning characteristics in a sleep or seat surface;

FIG. 11 is a perspective view of the unitary composite cushioning structure of FIGS. 10A and 10B disposed on top of a mattress innerspring to provide a padding material for the mattress innerspring;

FIG. 12 is a perspective view of another exemplary unitary composite cushioning structure comprised of a molded thermoplastic foam profile incorporating chambers with a thermoset material disposed in the chambers and a stratum provided therebetween, with a top surface of the thermoset material including convolutions to provide zoned cushioning characteristics in a sleep or seat surface;

FIG. 13 is an exemplary cross-section profile of another exemplary unitary composite cushioning structure comprised of a cellular thermoplastic foam profile incorporating chambers with a thermoset material disposed in the chambers and a stratum provided therebetween, and that may be employed to provide zoned cushioning characteristics in a sleep or seat surface;

FIG. 14 is an exemplary cross-section profile of another exemplary unitary composite cushioning structure comprised of a cellular thermoplastic foam profile having extruded closed chambers with a thermoset material disposed in the chambers and a stratum provided therebetween that may be employed to provide a cushioning structure, including but not limited to a sleep or seat surface and edge or side supports;

FIGS. 15A and 15B illustrate side view profiles of other exemplary embodiments of unitary composite cushioning structure;

FIG. 16 illustrates a side view profile of another exemplary embodiment of unitary composite cushioning structure;

FIG. 17 illustrates a side view profile of another exemplary embodiment of unitary composite cushioning structure;

FIG. 18 illustrates a side view profile of another exemplary embodiment of unitary composite cushioning structure;

FIGS. 19A and 19B illustrate side view profiles of other exemplary embodiments of unitary composite cushioning structure;

FIGS. 20A and 20B illustrate side view profiles of other exemplary embodiments of unitary composite cushioning structure;

FIGS. 21A-21D illustrate side view profiles of other exemplary embodiments of unitary composite cushioning structure;

FIG. 22 illustrates a side view profile of another exemplary embodiment of unitary composite cushioning structure;

FIGS. 23A and 23B illustrate side view profiles of other exemplary embodiments of unitary composite cushioning structure;

FIGS. 24A and 24B illustrate side view profiles of other exemplary embodiments of unitary composite cushioning structure;

FIG. 25 illustrates a side view profile of another exemplary embodiment of unitary composite cushioning structure;

FIG. 26 illustrates a side view profile of another exemplary embodiment of unitary composite cushioning structure;

FIG. 27 illustrates a side view profile of another exemplary embodiment of unitary composite cushioning structure;

FIG. 28 illustrates a side view profile of another exemplary embodiment of unitary composite cushioning structure;

FIGS. 29A-29C illustrate side view profiles of other exemplary embodiments of unitary composite cushioning structure;

FIG. 30 illustrates a side view profile of another exemplary embodiment of unitary composite cushioning structure;

FIG. 31 illustrates a side view profile of another exemplary embodiment of unitary composite cushioning structure;

FIGS. 32A and 32B illustrate side view profiles of other exemplary embodiments of unitary composite cushioning structure;

FIGS. 33A-33D illustrate side view profiles of other exemplary embodiments of unitary composite cushioning structure;

FIGS. 34A-34D illustrate side view profiles of other exemplary embodiments of unitary composite cushioning structure;

FIGS. 35A and 35B illustrate side view profiles of other exemplary embodiments of unitary composite cushioning structure;

FIG. 36 illustrates a side view profile of another exemplary embodiment of unitary composite cushioning structure;

FIG. 37 illustrates a side view profile of another exemplary embodiment of unitary composite cushioning structure;

FIG. 38 illustrates a side view profile of another exemplary embodiment of unitary composite cushioning structure;

FIG. 39 illustrates a side view profile of another exemplary embodiment of unitary composite cushioning structure;

FIG. 40 is a top view of an exemplary unitary composite cushioning structure comprised of a cellular thermoplastic foam profile surrounded by a thermoset material;

FIG. 41 is a top perspective view of exemplary unitary composite cushioning structure comprised of a coil-shaped cellular thermoplastic foam profile having an internal chamber with a thermoset material disposed in the chamber of the cellular thermoplastic foam profile;

FIG. 42 is a top perspective view of the unitary composite cushioning structure in FIG. 41 with an additional filler material in the form of corc dust mixed with the thermoset material to provide stability to the thermoset material;

FIG. 43 is a top view of a plurality of exemplary unitary composite cushioning structures provided in an array;

FIG. 44 is a side perspective view of a mattress innerspring employing exemplary coil-shaped unitary composite cushioning structures, which may include the composite coil structures of FIGS. 40-42;

FIGS. 45A-45M are side perspective views of alternative cellular thermoplastic foam profiles that can either be encapsulated or filled with a thermoset material to provide unitary composite cushioning structures;

FIGS. 46A-46F are side perspective views of alternative cellular thermoplastic foam profiles that can either be encapsulated or filled with a thermoset material to provide unitary composite cushioning structures;

FIGS. 47A and 47B are side perspective views of alternative cellular thermoplastic foam spring arrangements that can provide unitary composite cushioning structures;

FIGS. 48A-48C are side perspective views of alternative cellular thermoplastic foam spring arrangements that can provide unitary composite cushioning structures;

FIGS. 49A and 49B illustrate a perspective view of an exemplary mattress assembly comprised of unitary composite cushioning structures in the form of foam springs;

FIG. 50 illustrates another perspective view of an exemplary mattress assembly comprised of unitary composite cushioning structures in the form of foam springs;

FIG. 51 illustrates a graph of exemplary stress (i.e., pressure) for a given percentage strain (i.e., deflection) for polyurethane and certain unitary composite cushioning structures;

FIG. 52 illustrates a graph of exemplary stress (i.e., pressure) for a given percentage strain (i.e., deflection) for polyurethane, viscoelastic, and certain unitary composite cushioning structures;

FIG. 53 illustrates a graph of exemplary stress (i.e., pressure) for a given percentage strain (i.e., deflection) for certain unitary composite cushioning structures;

FIG. 54 illustrates a graph of exemplary stress (i.e., pressure) for a given percentage strain (i.e., deflection) for certain unitary composite cushioning structures;

FIG. 55 illustrates a graph of exemplary stress (i.e., pressure) for a given percentage strain (i.e., deflection) for certain unitary composite cushioning structures;

FIG. 56 illustrates a graph of exemplary stress (i.e., pressure) for a given percentage strain (i.e., deflection) for certain unitary composite cushioning structures;

FIG. 57 illustrates a graph of exemplary stress (i.e., pressure) for a given percentage strain (i.e., deflection) for certain unitary composite cushioning structures;

FIG. 58 illustrates a graph of exemplary stress (i.e., pressure) for a given percentage strain (i.e., deflection) for certain unitary composite cushioning structures;

FIG. 59 illustrates a bar graph of exemplary support factors for various cushioning structures, including viscoelastic, latex, and unitary composite cushioning structures;

FIG. 60 illustrates a bar graph of exemplary percentage reduction in height vs. deflection cycles for various cushioning structures, including polyurethane and unitary composite cushioning structures;

FIG. 61 illustrates a bar graph of exemplary percentage stiffness reduction in height vs. deflection cycles for various cushioning structures, including polyurethane and unitary composite cushioning structures;

FIG. 62 illustrates a graph of exemplary mean reduction in height vs. deflection cycles for various cushioning structures, including polyurethane and unitary composite cushioning structures;

FIG. 63 illustrates a graph of exemplary mean change in firmness vs. deflection cycles for various cushioning structures, including polyurethane and unitary composite cushioning structures;

FIG. 64A illustrates an exemplary continuous extrusion system in an upstream view when looking back towards an extruder that extrudes the cellular thermoplastic material into a desired profile onto a conveyor;

FIG. 64B illustrates the continuous extrusion system in FIG. 64B in a downstream view when away from the extruder that extrudes the cellular thermoplastic material into a desired profile towards the conveyor;

FIG. 65 illustrates a close-up view of the extruder in the continuous extrusion system in FIGS. 64A and 64B;

FIG. 66 illustrates the extruder die in the extruder in FIG. 65;

FIG. 67 illustrates an exemplary cellular thermoplastic profile extruded by the continuous extrusion system in FIGS. 64A and 64B;

FIG. 68 illustrates an exemplary pulling apparatus of the continuous extrusion system in FIGS. 64A and 64B disposed on the opposite end of the extruder;

FIG. 69 illustrates an exemplary conveyor disposed between the extruder and the pulling apparatus in FIG. 68 configured to convey the cellular thermoplastic profile extruded from the extruder and pulled by the pulling apparatus;

FIGS. 70A and 70B illustrate dispensing a thermoset material in a non-solid phase into the internal chamber of the cellular thermoplastic profile in the continuous extrusion system in FIGS. 64A and 64B;

FIG. 71 illustrates exemplary pulling members disposed on the conveyor in the continuous extrusion system in FIGS. 64A and 64B to assist in provide access to the internal chamber of the cellular thermoplastic profile for dispensing thermoset material into the internal chamber of the thermoplastic cellular profile; and

FIG. 72 illustrates an exemplary cutting apparatus that may be employed after the unitary composite cushioning structure is produced by the continuous extrusion system in FIGS. 64A and 64B to cut the continuously produced unitary composite cushioning structure into sections.

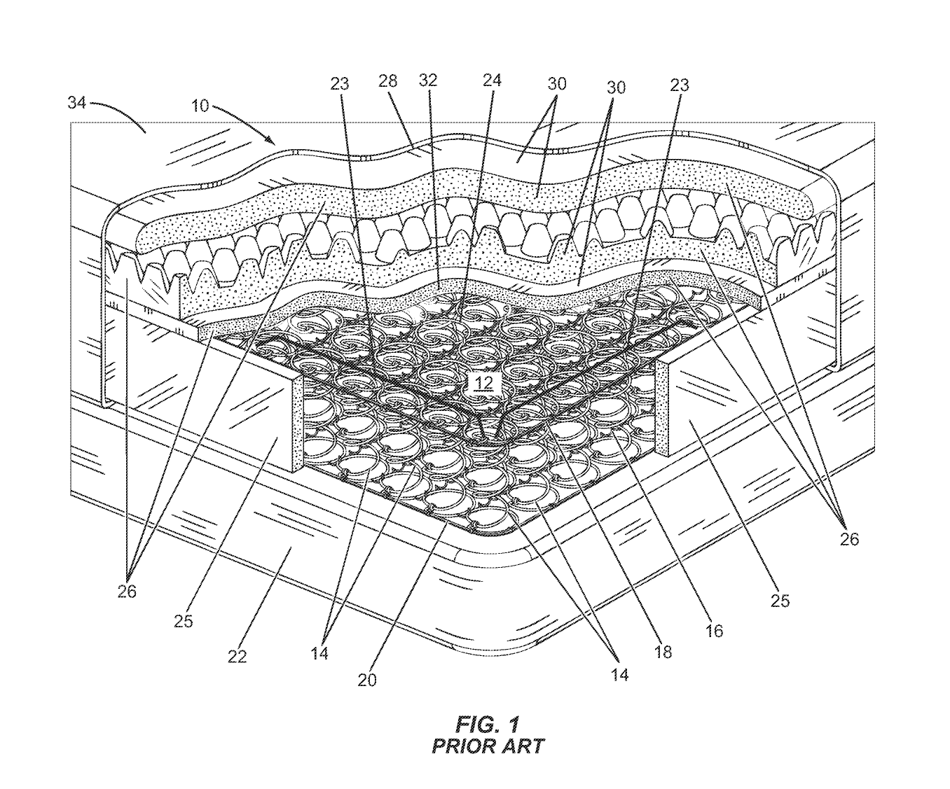

### DETAILED DESCRIPTION

Embodiments disclosed in the detailed description include a unitary or monolithic composite (or hybrid) cushioning structure(s) and profile(s) comprised of a cellular thermoplastic foam and a thermoset material. Embodiments disclosed in the detailed description also include methods of producing a unitary or monolithic composite (or hybrid) cushioning structure(s) and profile(s) comprised of a cellular thermoplastic foam and a thermoset material.

In this regard in one embodiment, a cushioning layer formed from a cellular thermoplastic material and a cellular thermoset material is disclosed. The cushioning layer includes a plurality of unitary composite cushioning structures spaced apart in a first direction within each row of a plurality of rows. Each row of the plurality of rows is spaced apart from an adjacent row in a second direction. Each of the plurality of unitary composite cushioning structures includes a stratum disposed between at least a portion of the cellular thermoplastic foam material and at least a portion of the cellular thermoset material to thereby secure the at least a portion of the cellular thermoset material to the at least a portion of the cellular thermoplastic foam material to form the unitary composite cushioning structure. The first direction and the second direction are orthogonal to each other.

In one embodiment, the thermoset material may also be provided as cellular foam as well. In one embodiment disclosed herein, the unitary composite or hybrid cushioning structure is formed from a cellular thermoplastic foam and a thermoset material. The cellular thermoplastic foam provides support characteristics to the unitary composite cushioning structure. The thermoset material provides a resilient structure with cushioning characteristics to the cushioning structure. A stratum is disposed between at least a portion of the cellular thermoplastic foam and at least a portion of the thermoset material to secure the at least a portion of the thermoset material to the at least a portion of the cellular thermoplastic foam to provide a unitary composite cushioning structure. The stratum includes a cohesive or adhesive bond, such as a mechanical or chemical bond, as examples. The stratum may provide an intimate engagement between at least a portion of the thermoset material and at least a portion of the cellular thermoplastic foam to provide the unitary composite cushioning structure. The cellular thermoplastic foam may also be provided as a custom engineered profile to provide a custom engineered profile for engagement of the thermoset material and thus the unitary composite cushioning structure.

As will be discussed in more detail below, the stratum may be continuously propagated between a portion of the cellular thermoplastic foam and a portion of the thermoset material during manufacture to secure the portion of the thermoset material to the portion of the cellular thermoplastic foam as the thermoset material is continuously dispensed into a continuously extruded cellular thermoplastic foam. In one embodiment, the stratum is formed by disposing a non-solid phase of the cellular thermoset material on or into a cellular thermoplastic foam profile. The cellular thermoset material undergoes a transition into a solid phase to form a bond with the cellular thermoplastic material, to secure the at least a portion of the cellular thermoset material to the at least a portion of the cellular thermoplastic material to form the unitary composite cushioning structure. The unitary composite cushioning structure exhibits a combination of the support characteristics and the resilient structure with cushioning characteristics when the unitary composite cushioning structure is placed under a load.

A unitary structure within the context of this disclosure is a structure having the character of a unit, undivided and integrated. The term composite or hybrid within the context of this disclosure is a complex structure having two or more distinct structural properties provided by two or more distinct material structures that are cohesively or adhesively bonded together to provide the combined functional properties of the two or more distinct structural properties which are not present in combination in any individual material structure.

There are several non-limiting and non-required advantages of the unitary composite cushioning structures disclosed herein. For example, the unitary composite cushioning structure is provided as a unitary structure as opposed to providing disparate, non-bonded structures each comprised exclusively of thermoplastic or thermoset materials. This allows the tactile cushioning and resiliency benefits of thermoset materials and the supportive and structural capabilities of the cellular thermoplastic foams to create a cushioning structure combining the desired characteristics and features of both material types into one unitary composite cushioning structure.

Further, the thermoset material provided as part of the unitary composite cushioning structure allows the cellular thermoplastic foam to exhibit excellent offset of compression set while retaining support characteristics to provide stability to the unitary composite cushioning structure. Thermoset materials can be selected that exhibit the desired offset of compression set. Without the employment of the thermoset material, the thermoplastic profile may not be able to provide the desired support characteristics without the undesired effects of compression set, also known as “sagging.” This engagement of a thermoset material with a cellular thermoplastic foam utilizes the thermoset material's ability to recover over long periods of repeated deformations. Another advantage can be cost savings. The cellular thermoplastic foam may be less expensive than the thermoset material while still providing a suitable composite cushioning structure exhibiting desired stability and offset of compression set.

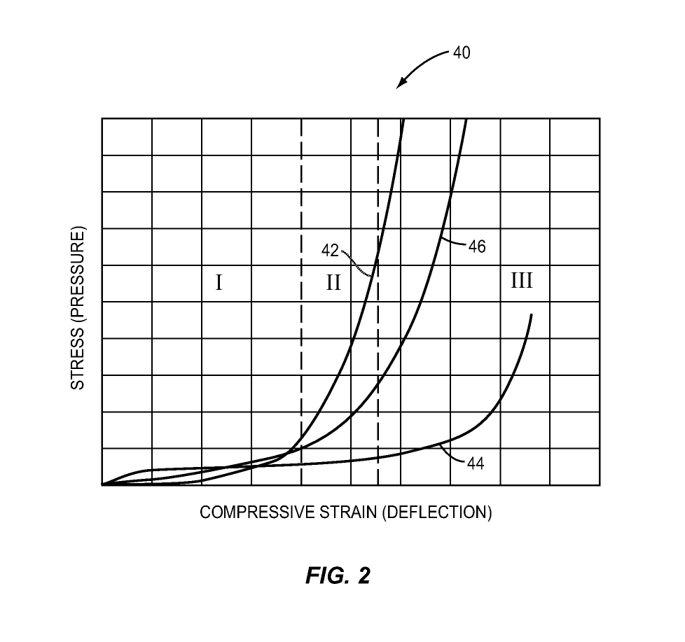

Before discussing examples of unitary composite cushioning structures comprised of a cellular thermoplastic foam cohesively or adhesively bonded to a thermoset material at a stratum, a discussion of strains (i.e., deflections) over given stresses (i.e., pressures) for cushioning structures not included in a unitary composite cushioning structure, as provided herein, is first discussed. In this regard, FIG. 2 illustrates an exemplary chart 40 of performance curves 42, 44, 46 showing compressive strain or deflection for given stress or pressure levels for different types of cushioning materials. The performance curve 42 illustrates strain versus stress for an exemplary thermoplastic material used as a cushioning structure. As illustrated in Section I of the chart 40, when a low stress or pressure is placed on the thermoplastic material represented by the performance curve 42, the thermoplastic material exhibits a large strain as a percentage of stress. As stress increases, as shown in Section II of the chart 40, the thermoplastic material represented by the performance curve 42 continues to strain or deflect, but the strain is smaller as a percentage of stress than the strain in Section I of the chart 40. This represents the firmer structural properties of the thermoplastic material providing a greater role in response to increased stress, thus decreasing the softness feel. As the stress further increases, as shown in Section III of the chart 40, eventually, the thermoplastic material represented by the performance curve 42 will exhibit even greater firmness where strain or deflection is very small as a percentage of stress, or non-existent.

It may be determined that the thermoplastic material represented by the performance curve 42 in FIG. 2 does not exhibit enough softness or cushioning to a load as stress increases. In other words, the thermoplastic material may provide a greater firmness more quickly as a function of stress than desired, thereby not providing the desired softness or cushioning characteristic desired. Thus, a thermoset material may be selected for the cushioning structure in lieu of a thermoplastic material.

In this regard, the performance curve 44 in FIG. 2 illustrates strain versus stress for an exemplary thermoset material. As illustrated in Section I of the chart 40, when a low stress or pressure is placed on the thermoset material represented by the performance curve 44, the thermoplastic material exhibits a large strain as a percentage of stress similar to the thermoplastic material represented by performance curve 42. As stress increases, as provided in Section II of the chart 40, the thermoset material represented by the performance curve 44 continues to strain, but only slightly greater than the strain in Section I of the chart 40. Thus, the thermoset material is continuing to exhibit softness even as the stress of a load disposed thereon increases, as opposed to the thermoplastic material represented by the performance curve 42 in FIG. 2. However, the thermoset material represented by the performance curve 44 does not provide the support or firmness characteristics as provided by the thermoplastic material represented by the performance curve 42, thereby providing a spongy or lack of support feel to a load. As the stress further increases, as shown in Section III of the chart 40, eventually, the thermoset material represented by the performance curve 44 will reach a point where it will exhibit greater firmness where strain or deflection is very small as a percentage of stress, or non-existent.

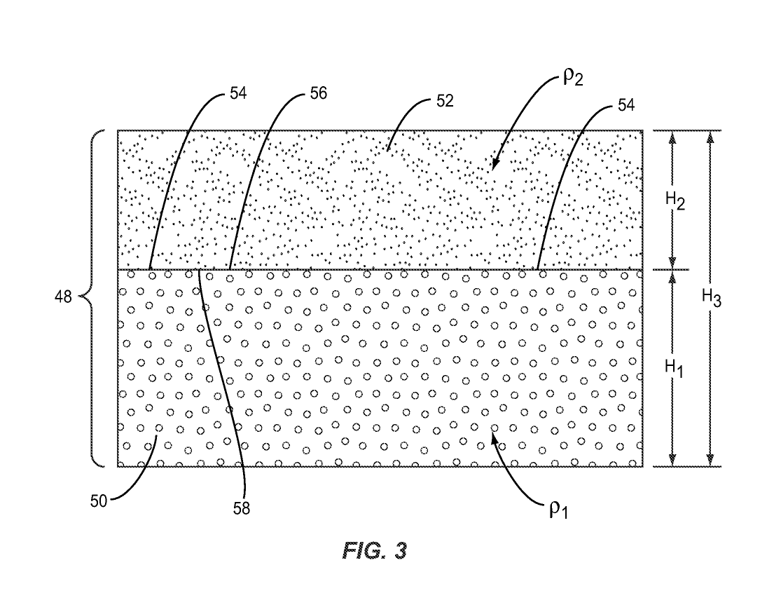

Embodiments disclosed herein provide a cushioning structure that has a hybrid or combined strain versus stress characteristic of the performance curves 42 and 44. This is illustrated by the performance curve 46 in FIG. 2. The performance curve 46 in FIG. 2 illustrates a unitary composite or hybrid cushioning structure comprised of the thermoplastic material represented by the performance curve 42 and the thermoset material represented by the performance curve 44. FIG. 3 illustrates an example of a unitary composite cushioning structure that can provide the performance according to the performance curve 46 in FIG. 2.

As illustrated in FIG. 3, a profile of a unitary composite cushioning structure 48 is provided. The unitary composite cushioning structure 48 is a hybrid that includes both a thermoplastic material 50 and a thermoset material 52. A unitary structure within the context of this disclosure is a structure having the character of a unit, undivided and integrated. A composite or hybrid structure within the context of this disclosure is a complex structure having two or more distinct structural properties provided by two or more distinct material structures that are cohesively or adhesively bonded together to provide the combined functional properties of the two or more distinct structural properties which are not present in combination in any individual material structure.

The thermoplastic material 50 and the thermoset material 52 are cohesively or adhesively bonded together to provide a unitary or monolithic cushioning structure. In this regard, the unitary composite cushioning structure 48 exhibits combined characteristics of the support characteristics of the thermoplastic material 50 and the resiliency and cushioning characteristics of the thermoset material 52. The thermoplastic material 50 is provided to provide support characteristics desired for the unitary composite cushioning structure 48. The thermoplastic material 50 could be selected to provide a high degree of stiffness to provide structural support for the unitary composite cushioning structure 48. The thermoset material 52 can provide resiliency and softer cushioning characteristics to the unitary composite cushioning structure 48. A stratum 54 is disposed between at least a portion of the thermoplastic material 50 and at least a portion of the thermoset material 52 that includes a cohesive or adhesive bond between at least a portion of the thermoset material 52 to the at least a portion of the thermoplastic material 50 to provide the unitary composite cushioning structure 48.

Non-limiting examples of thermoplastic materials that can be used to provide the thermoplastic material 50 in the unitary composite cushioning structure 48 include polypropylene, polypropylene copolymers, polystyrene, polyethylenes, ethylene vinyl acetates (EVAs), polyolefins, including metallocene catalyzed low density polyethylene, thermoplastic olefins (TPOs), thermoplastic polyester, thermoplastic vulcanizates (TPVs), polyvinyl chlorides (PVCs), chlorinated polyethylene, styrene block copolymers, ethylene methyl acrylates (EMAs), ethylene butyl acrylates (EBAs), and the like, and derivatives thereof. The density of the thermoplastic material 50 may be provided to any density desired to provide the desired weight and support characteristics for the unitary composite cushioning structure 48. Further, the thermoplastic material 50 may be selected to also be inherently resistant to microbes and bacteria, making the thermoplastic material 50 desirable for use in cushioning structures and related applications. The thermoplastic material 50 can also be made biodegradable and fire retardant through the use of additive master batches.

Non-limiting examples of thermoset materials that can be used to provide thermoset material 52 in the unitary composite cushioning structure 48 include polyurethanes, natural and synthetic rubbers, such as latex, silicones, ethylene propylene diene Monomer (M-class) (EPDM) rubber, isoprene, chloroprene, neoprene, melamine-formaldehyde, and polyester, and derivatives thereof. The density of the thermoset material 52 may be provided to any density desired to provide the desired resiliency and cushioning characteristics to the unitary composite cushioning structure 48, and can be soft or firm depending on formulations and density. The thermoset material 52 could also be foamed. Further, if the thermoset material 52 selected is a natural material, such as latex for example, it may be considered biodegradable. Further, bacteria, mildew, and mold cannot live in certain thermoset foams. Also note that although the unitary composite cushioning structure 48 illustrated in FIG. 3 is comprised of at least two materials, the thermoplastic material 50 and the thermoset material 52, more than two different types of thermoplastic and/or thermoset materials may be provided in the unitary composite cushioning structure 48.

Taking the example of latex as the thermoset material 52 that may be used in providing the unitary composite cushioning structure 48, latex is a naturally derived biodegradable product that comes from the rubber tree. Latex is hypo-allergenic, and breathes to retain heat in the winter and not absorb heat in the summer. Bacteria, mildew, and mold cannot live in latex foam. Tests have shown that latex foam can be three times more resistant to dust mites and bacteria than ordinary cushioning structures, and thus may be desirable, especially as it would pertain to being natural and biodegradable. There are also synthetic versions of latex that do not fit into the natural category, but could also be used either solely or in combination with a natural product.

In the example of the unitary composite cushioning structure 48 of FIG. 3, the thermoplastic material 50 is provided. A bottom surface 56 of the thermoset material 52 disposed on a top surface 58 of the thermoplastic material 50. The stratum 54 is formed where the bottom surface 56 of the thermoset material 52 contacts or rests on and is cohesively or adhesively bonded to the top surface 58 of the thermoplastic material 50. The thermoplastic material 50 may be provided in a solid phase, such as a cellular foam for example. The thermoset material 52 may be provided initially in the unitary composite cushioning structure 48 as a non-solid phase, such as in a liquid form. The thermoplastic material 50 and the thermoset material 52 are not mixed together. The thermoset material 52 will undergo a transition into a solid form, thereby forming a cohesive or adhesive union with the thermoset material 52 at the stratum 54, as illustrated in FIG. 3. Thus, the thermoplastic material 50 and the thermoset material 52 cohesively or adhesively bond together to form a unitary structure that provides combined properties of the support characteristics of the thermoplastic material 50 and the resiliency and cushioning characteristics of the thermoset material 52 that may not otherwise be possible by providing the thermoplastic material 50 and thermoset material 52 in separate, non-unified structures or layers. Advantages in this example include, but are not limited to, compression recovery, reduced weight, fewer layers of cushioning material, less labor in assembly, smaller form factor of the cushioning structure, less inventory, and/or antimicrobial features.

A curing process can be performed on the unitary composite cushioning structure 48 to set and cohesively or adhesively bond the thermoset material 52 to the thermoplastic material 50. The thermoset material 52 is mechanically bonded to the thermoplastic material 50 in this embodiment, but chemical bonding can be provided. Further, a chemical bonding agent can be mixed in with the thermoplastic material 50, such as before or during a foaming process for example, to produce the thermoplastic material 50, or when the thermoset material 52 is disposed in contact with the thermoplastic material 50 to provide a chemical bond with the thermoset material 52 during the curing process.

It may be desired to control the combined cushioning properties of the unitary composite cushioning structure 48 in FIG. 3. For example, it may be desired to control the degree of support or firmness provided by the thermoplastic material 50 as compared to the resiliency and cushioning characteristics of the thermoset material 52. In this regard, as an example, the thermoplastic material 50 is provided as a solid block of height H₁, as illustrated in FIG. 3. The thermoset material 52 is provided of height H₂, as also illustrated in FIG. 3. The relative volume of the thermoplastic material 50 as compared to the thermoset material 52 can control the combined cushioning properties, namely the combined support characteristics and the resiliency and cushioning characteristics, in response to a load. These combined characteristics can also be represented as a unitary strain or deflection for a given stress or pressure, as previously discussed.

Further, by being able to control the volume of the thermoplastic material 50 and the thermoset material 52, the same combined cushioning properties may be able to be provided in a smaller overall volume or area. For example, with reference to FIG. 3, the individual heights H₁ and H₂ may be less important in providing the combined cushioning characteristics of the unitary composite cushioning structure 48 than the ratio of the respective heights H₁ and H₂ Thus, the overall height H₃ (i.e., H₁+H₂) of the unitary composite cushioning structure 48 may be able to be reduced over providing distinct, non-bonded layers of cushioning structures.

Further, a relative density ρ₁ of the thermoplastic material 50 as compared to a density ρ₂ of the thermoset material 52 can control the responsiveness of the combined cushioning properties. For example, the density ρ₁ of the thermoplastic material 50 could be in the range between one-half pound (lb.) per cubic foot (ft³) to 30 lbs./ft³ (i.e., 8 kilograms (kg) per cubic meter (m³) to 480 kg/m³), as an example. The density _{ρ2} of the thermoset material 52 could be in the range between one pound (lb.) per cubic foot (ft³) to 15 lbs./ft³ (i.e., 16 kilograms (kg) per cubic meter (m³) to 240 kg/m³), as an example. The variability of densities _{ρ1} of the thermoplastic material 50 relative to _{ρ2} of the thermoset material 52 can be selected to customize the resultant properties of the unitary composite cushioning structure 48 that may not otherwise be possible by providing the thermoset material 52 as a distinct, non-unitary component or structure from the thermoplastic material 50.

Further, the thermoplastic material 50 and thermoset material 52 may each have different indentation load deflections (ILDs). ILD is a measurement of foam firmness. Firmness is independent of foam density, although it is often thought that higher density foams are firmer. It is possible to have high density foams that are soft- or low density foams that are firm, depending on the ILD specification. ILD specification relates to comfort. It is a measurement of the surface feel of the foam. ILD may be measured by indenting (compressing) a foam sample twenty-five (25) percent of its original height. The amount of force required to indent the foam is its twenty-five (25) percent ILD measurement. The more force required, the firmer the foam. Flexible foam ILD measurements can range from ten (10) pounds (supersoft) to about eighty (80) pounds (very firm).

The thermoplastic material 50 of the unitary composite cushioning structure 48 can be provided as a cellular thermoplastic foam profile, if desired. By providing the thermoplastic material 50 of the unitary composite cushioning structure 48 as a cellular foam profile, control of the shape and geometry of the unitary composite cushioning structure 48 can be provided, as desired. For example, the extrusion foaming art, with the ability to continuously produce and utilize specific die configurations having the ability to geometrically design and profile elements for cushioning support is a method to obtain the desired thermoplastic engineered geometry foam profiles to be used with a thermoset material or materials to provide the unitary composite cushioning structure 48. In this manner, the unitary composite cushioning structure 48 can be provided for different applications based on the desired geometric requirements of the cushioning structure. Machine direction (MD) attributes as well as transverse direction (TD) attributes may be employed to extrude a thermoplastic foam profile. However, other methods of providing thermoplastic foam profiles may also be employed, including molding, casting, thermal forming, and other processes known to those skilled in the art.

Thermoset foam profiles can be obtained in emulsified form and are frothed to introduce air into the emulsion to reduce density, and are then cured (vulcanized) to remove additional waters and volatiles as well as to set the material to its final configuration. Thermoset materials can also be further cost reduced through the addition of fillers such as ground foam reclaim materials, nano clays, carbon nano tubes, calcium carbonate, flyash and the like, but also corc dust as this material can provide for increased stability to reduce the overall density and weight of the thermoset material. Further, thermoplastic foams, when used in combination with a thermoset foam, will consume space within a cushion structure, thereby displacing the heavier-weight, more expensive thermoset materials, such as latex rubber foam, as an example.

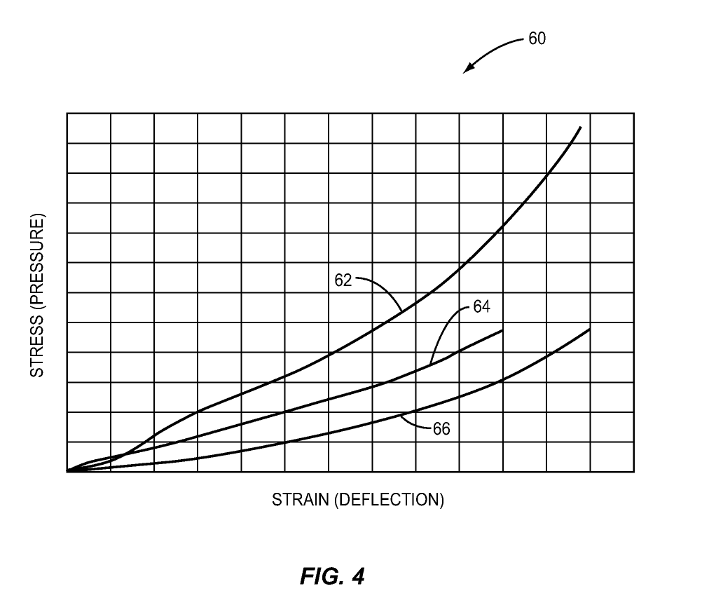

In this regard, FIG. 4 provides an exemplary chart 60 of performance curves showing strain (deflection) under a given stress (pressure) for different types of thermoplastic foam cushioning structures to show the ability to engineer a cellular thermoplastic foam profile to provide the desired firmness and support characteristics in the unitary composite cushioning structure 48. A performance curve 62 illustrates the result of testing of strain for a given stress of an exemplary solid block of low density polyethylene foam before being engineered into a particular profile. Performance curves 64, 66 represent the result of testing of strain for a given stress of two exemplary polyethylene foam extrusion profiles formed from the low density polyethylene foam represented by the performance curve 62. As illustrated in FIG. 4, the low density polyethylene foam represented by the performance curve 62 supports a higher load or stress than the two polyethylene foam extrusion profiles represented by the performance curves 64, 66 of the same or similar density. Further, as illustrated in FIG. 4, the polyethylene foam extrusion profile represented by the performance curve 64 illustrates strain for a given stress that has a greater propensity to support a higher loading than the exemplary polyethylene foam extrusion profile represented by the performance curve 66. Thus, a thermoplastic foam profile can be engineered to be less supportive in the unitary composite cushioning structure 48 depending on the support characteristics for the unitary composite cushioning structure 48 desired.

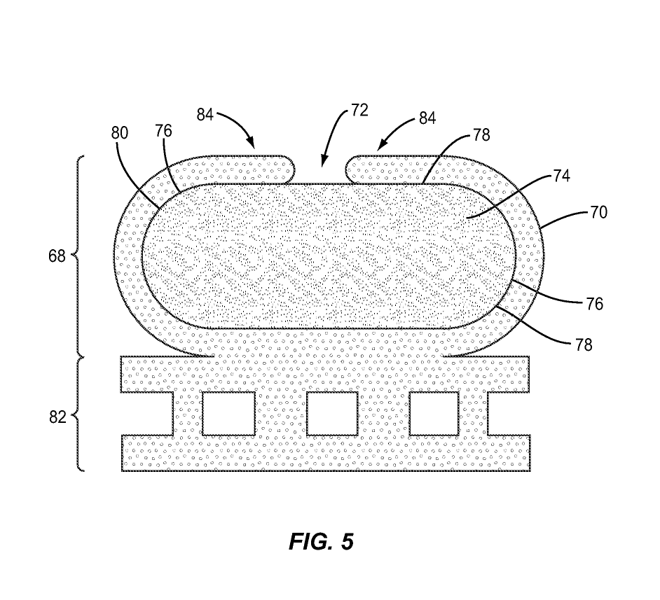

In this regard, embodiments disclosed herein allow a unitary composite cushioning structure to be provided in a customized engineered profile by providing a customized engineered thermoplastic foam profile. A thermoset material is provided in the engineered thermoplastic foam profile to provide the unitary composite cushioning structure. In this manner, the shape and resulting characteristics of the unitary composite cushioning structure can be designed and customized to provide the desired combination of resiliency and cushioning, and support characteristics for any application desired. In this regard, FIG. 5 is a side view of a cross-section of another exemplary unitary composite cushioning structure 68 to further illustrate, by example, providing an engineered cellular thermoplastic foam profile to provide the desired support characteristics and so that the geometry of the unitary composite cushioning structure 48 can be provided, as desired. As illustrated in FIG. 5, the unitary composite cushioning structure 68 includes a cellular thermoplastic foam profile 70 profiled in the form of a C-shaped structure having an open chamber 72 disposed therein formed as a result of extruding a solid block of cellular thermoplastic foam. A base 82 is also extruded with the C-shaped structure as part of the cellular thermoplastic foam profile 70 in this embodiment. The base 82 may provide a firm lower support layer for the unitary composite cushioning structure 68, although such as is not required. Note, however, there is not a requirement to provide the base 82 as part of the cellular thermoplastic foam profile 70.

A thermoset material 74 is disposed in the open chamber 72 to provide the unitary composite cushioning structure 68. The thermoset material 74 may be disposed in the open chamber 72 when in a non-solid phase, as previously discussed. The thermoset material 74 will eventually transform into a solid phase and cohesively or adhesively bond with the cellular thermoplastic foam profile 70 to form the unitary composite cushioning structure 68. A stratum 76 is formed where an outer surface 78 of the thermoset material 74 contacts or rests against an inner surface 80 of the cellular thermoplastic foam profile 70 to cohesively or adhesively bond the thermoset material 74 to the cellular thermoplastic foam profile 70.

The cellular thermoplastic foam profile 70 may be a closed-cell foam, open-cell foam, or partially open or closed-cell foam. The material selected for providing the cellular thermoplastic foam profile 70 may be from any thermoplastic material desired, including those previously described. The thermoset material 74 may also be a cellular foam, and may be closed-cell foam, open-cell foam, or partially open or closed-cell foam. The material selected for providing the cellular thermoset foam may be from any thermoset material desired, including those previously described above.

The cellular thermoplastic foam profile 70, the thermoset material 74, and the unitary composite cushioning structure 68 may have the responses represented by the performance curves 42, 44, and 46 in FIG. 2, respectively, as an example. For example, the response shown by the performance curve 42 in Section I of FIG. 2 may be the response curve of the cellular thermoplastic foam profile 70 illustrating an initial soft segment generated from the lack of resistance exhibited by C-shaped legs 84 of the cellular thermoplastic foam profile 70. The supportive segments of the C-shaped legs 84 begin to engage with the bottom of the cellular thermoplastic foam profile 70 and therefore are able to tolerate a large load or pressure factor, as illustrated by the performance curve 42 in Sections II and III in FIG. 2. The thermoset material 74 in the unitary composite cushioning structure 68 shows an extremely soft segment in the performance curve 44 in Section I of FIG. 2, with a lower loading factor, until it becomes fully compressed or collapsed onto itself in Section III in FIG. 2. As illustrated by performance curve 44 in FIG. 2, the unitary composite cushioning structure 68 shows an overall smooth transition between a smaller pressure or load, as illustrated in Section I of FIG. 2, progressing into a harder, more supportive structure, as illustrated in Sections II and III of FIG. 2.

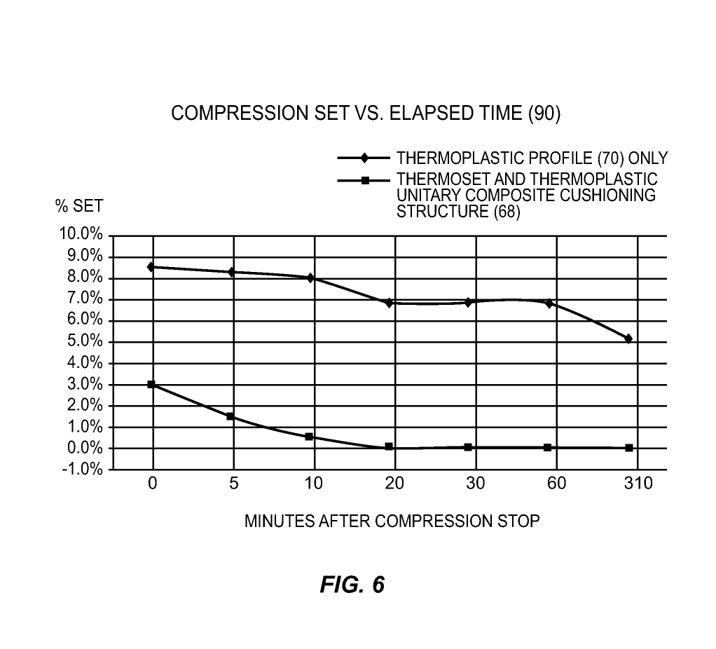

FIG. 6 is an exemplary chart 90 illustrating the recovery characteristics of the unitary composite cushioning structure 68 of FIG. 5 versus the recovery characteristics of the cellular thermoplastic foam profile 70 of FIG. 5 individually over elapsed time to illustrate the improved compression set characteristics of the unitary composite cushioning structure 68. The test protocol was to approximate the load exerted by a person lying prone on a cushion structure, then apply this constant strain for up to eight (8) hours, then measure the height recovery of the unitary composite cushioning structure 68 over time. While the cellular thermoplastic foam profile 70 does not recover within the same time frame as the unitary composite cushioning structure 68 in this example, it is important to note when the cellular thermoplastic foam profile 70 is used in combination with the thermoset material 74, not only is there less initial set, but the rate of recovery is more rapid. The rate of recovery feature of the unitary composite cushioning structure 68 is important from the standpoint of assuring that the unitary composite cushioning structure 68 returned or substantially returned to its original positioning, and that sag of the unitary composite cushioning structure 68 was not evident.

The unitary composite cushioning structure disclosed herein can be disposed in any number of applications for providing support to a load. Examples include seat assemblies, cushions, helmets, mats, grips, packagings, and bolsters. The remainder of this disclosure provides exemplary applications in which the unitary composite cushioning structure or structures can be disposed to provide the desired combined support and resiliency and cushioning characteristics.

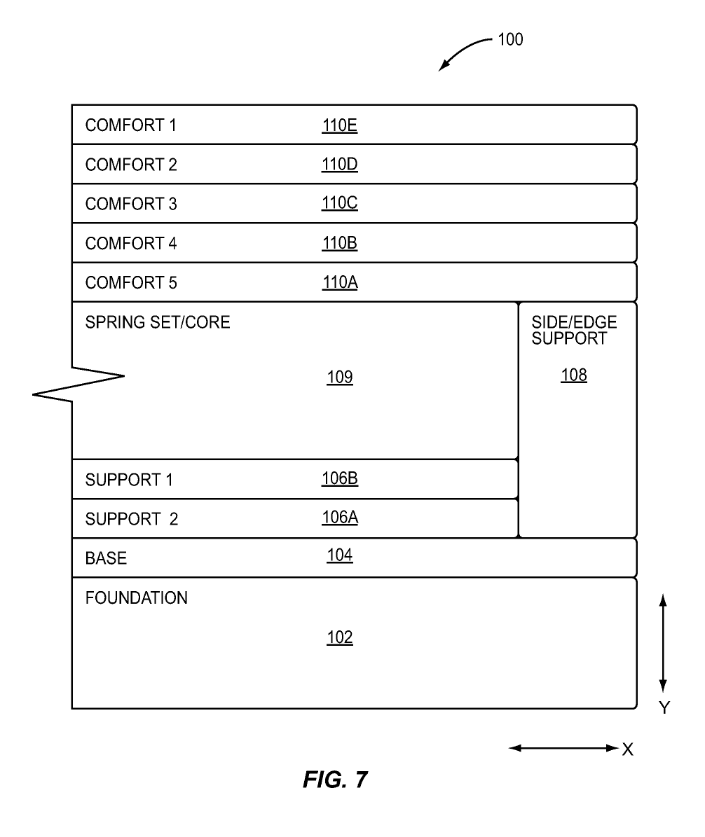

In this regard, FIG. 7 illustrates a block diagram of an exemplary mattress 100. The mattress 100 is a well known example of a loading bearing structure. The unitary composite cushioning structures disclosed herein may be incorporated as replacements into any of the components of the mattress 100 (also referred to as “mattress components”), which are described below. Further, the unitary composite cushioning structures disclosed herein may form a portion of any of the components of the mattress 100. In this regard, the mattress 100 may include a foundation 102. A base 104 may be disposed on top of the foundation 102. The base 104 in this embodiment is a horizontal mattress component, meaning it extends in the horizontal or X direction extending generally parallel to an expected load displaced in the mattress 100. The foundation 102 and the base 104 may be selected to provide a firm support for a load disposed on the mattress 100. Additional support layers 106A, 106B, which may also be horizontal mattress components, may be disposed on top of the base 104 to provide an internal support area. In order to provide a firmer outer edge of the mattress 100, side or edge supports 108 may be disposed around the perimeter of the base 104 and foundation 102 and located adjacent to the support layers 106A, 106B and a spring set or core 109. The side or edge supports 108 may be characterized as vertical mattress components in this embodiment, since the side or edge supports 108 extend upward in a Y direction towards an expected load disposed on the mattress 100 and do not extend substantially in the horizontal or X direction of the mattress. The spring set or core 109, which may also be characterized as vertical mattress components, may be provided as an innerspring comprised of coils, which may be secured by a border wire (not shown), or may be pocketed coils, as examples. Alternatively, a core, such as comprised of latex or memory foam, may be disposed on the support layers 106A, 106B. One or more comfort layers 110A-110E may be disposed on top of the spring set or core 109 to complete the mattress 100.

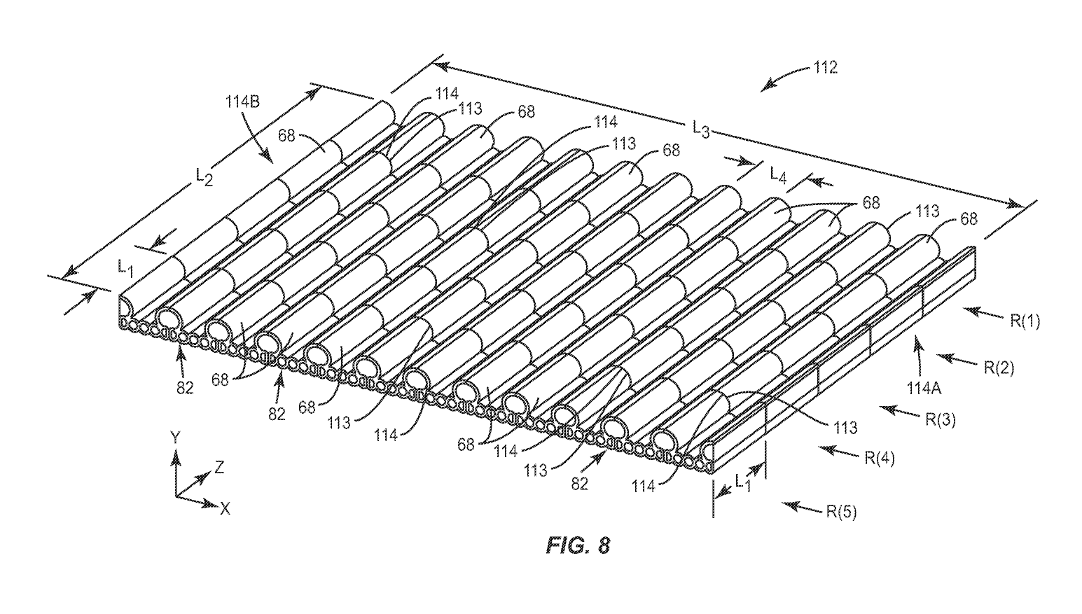

As another example, FIG. 8 is a perspective view of an exemplary composite cushioning structure 112 provided in a comfort layer that can be disposed in a mattress or mattress assembly. In this embodiment, the composite cushioning structure 112 is comprised of a plurality of the unitary composite cushioning structures 68 in FIG. 5. As illustrated in FIG. 8, each of the unitary composite cushioning structures 68 is provided of length L₁. Length L₁ could be any length. The length L₁ could be the entire length L₂ of the composite cushioning structure 112 such that only one unitary composite cushioning structure 68 is provided in the depth direction Z (or the first direction), if desired, as illustrated in FIG. 8. In this embodiment, five (5) unitary composite cushioning structures 68 are provided in the depth direction Z (or the first direction) in the composite cushioning structure 112 to form, for example, five rows R(1)-R(5). Rear sides 113 of the unitary composite cushioning structures 68 are abutted to front sides 114 of other unitary composite cushioning structures 68 to provide a contiguous cushioning structure in the depth direction Z and across different rows R(1)-R(5). In this manner, the unitary composite cushioning structures 68 can be provided in any number to build the composite cushioning structure 112 of infinite depth and of infinite rows. The rows R(1)-R(5) of unitary composite cushioning structures 68 are also aligned in the X direction (or the second direction) as illustrated in FIG. 8 to expand the sleep or seat surface in the X direction to any length L₃ desired.

With continuing reference to FIG. 8, the unitary composite cushioning structures 68 are spaced apart in length L₄ in the X direction about their centerlines, as illustrated in FIG. 8, to provide the desired cushioning characteristics. The farther each of the unitary composite cushioning structures 68 are spaced apart, the less cushioning support is provided overall in the composite cushioning structure 112. The length L₄ can be varied in this manner to provide the desired cushioning characteristics in the composite cushioning structure 112 desired.

Also in this embodiment, the bases 82 is produced integral with the unitary composite cushioning structures 68 as illustrated in FIG. 5, but the bases 82 could be provided separately. End sides 114A, 114B of the composite cushioning structure 112 could be provided by cutting the unitary composite cushioning structures 68 disposed on ends, as illustrated in FIG. 8. Further, the composite cushioning structure 112 in FIG. 8 could be produced of continuous length in the X or Z direction and spiral wound for storage. The wound composite cushioning structure 112 could be unwound and cut to the desired length represented by L₂ or L₃ in FIG. 8.

The material choices and support characteristics of the unitary composite cushioning structures 68 can be varied, if desired, to provide different support characteristics in the composite cushioning structure 112 to provide different zones or regions of support characteristics. For example, the composite cushioning structure 112 may be designed to support different loads in different portions of the composite cushioning structure 112 such that it may be desired to provide firmer or greater support in certain unitary composite cushioning structures 68 than others. For example, certain unitary composite cushioning structures 68 may be located where head, torso, and foot loads will likely be displaced.

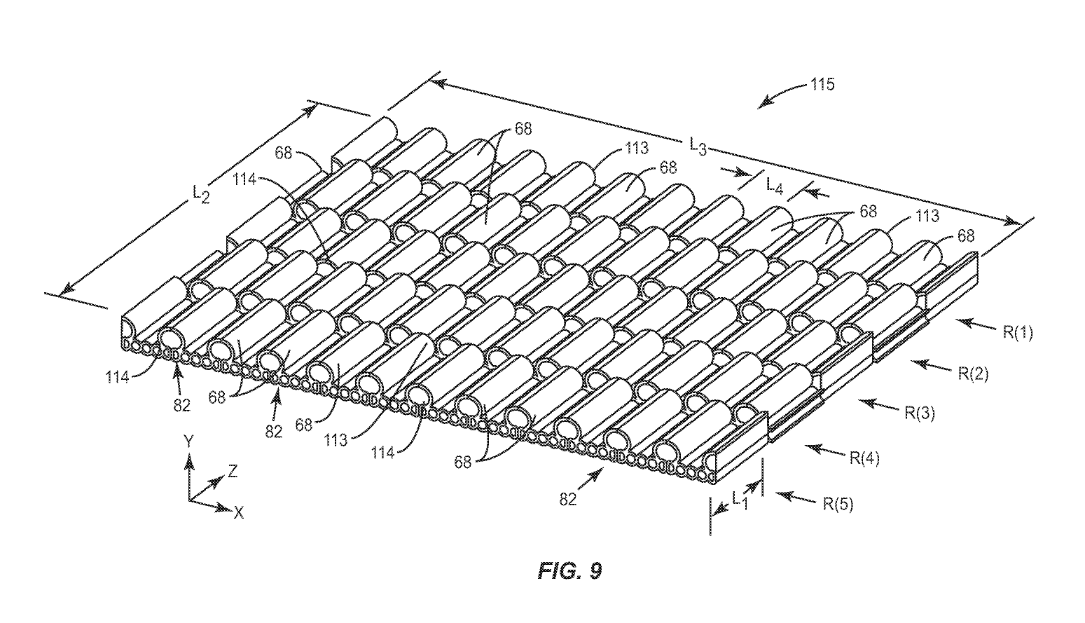

As another example, FIG. 9 is a perspective view of another exemplary composite cushioning structure 115 that is also comprised of a plurality of unitary composite cushioning structure 68 in FIG. 5. However in this embodiment, the unitary composite cushioning structures 68 are offset from each other in both the X and Z directions. The unitary composite cushioning structures 68 are offset from each other as provided in FIG. 8. However, the rear sides 113 and the front sides 114 of adjacent unitary composite cushioning structures 68 disposed in the Z direction are offset from each other as illustrated in FIG. 9, so that even rows R(2), R(4) are staggered with respect to odd rows R(1), R(3), R(5). In this manner the amount of surface area in contact between the rear sides 113 and the front sides 114 of adjacent unitary composite cushioning structures 68 is less so that motion in one unitary composite cushioning structure 68 does not impart or less significantly imparts force onto an adjacent unitary composite cushioning structure 68 in the Z direction. A gap may be provided between adjacent unitary composite cushioning structures 68 disposed in the Z direction so that there is no contact between any of unitary composite cushioning structures 68, if desired. Alternatively, a gap may be provided between adjacent unitary composite cushioning structures 68 disposed in the Z direction even if adjacent unitary composite cushioning structures 68 are not offset from each other in the Z direction, as illustrated in FIG. 8, to provide motion isolation. The characteristics discussed above for composite cushioning structures 112 in FIG. 8 can also be provided in the composite cushioning structures 115 in FIG. 9.

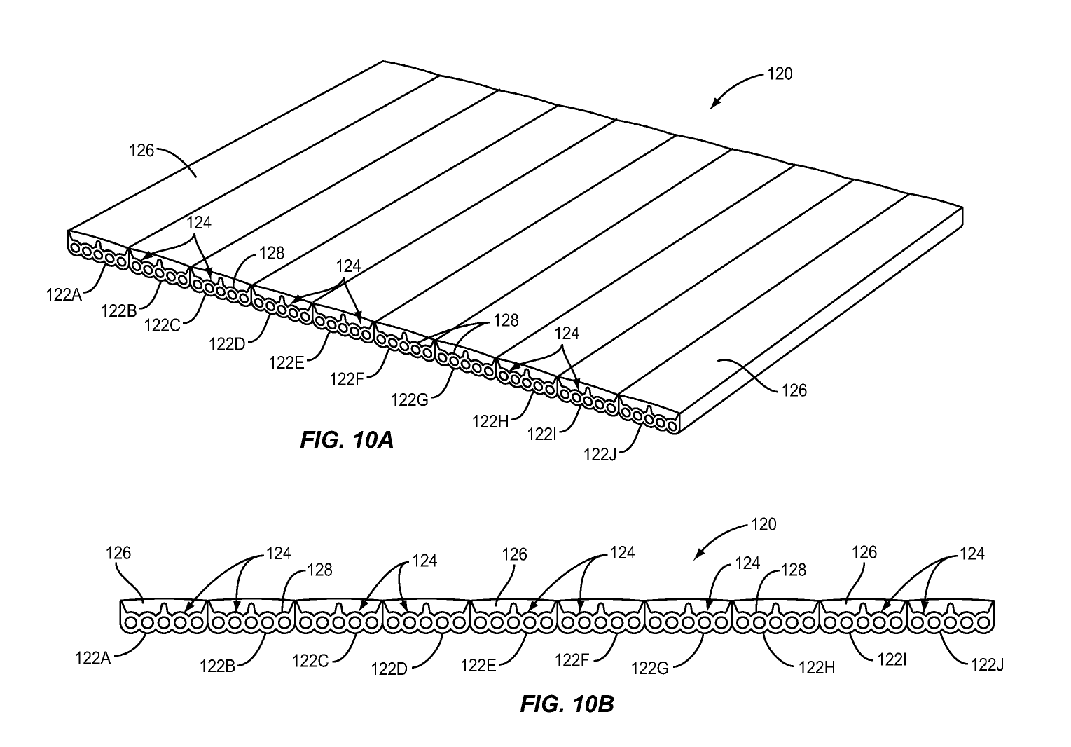

As another example, FIGS. 10A and 10B are perspective and side views, respectively, of an exemplary unitary composite cushioning structure 120 provided in a comfort layer that can be disposed in a mattress or mattress assembly. In this embodiment, the unitary composite cushioning structure 120 is comprised of a plurality of extruded cellular thermoplastic foam profiles 122A-122J. The material choices and support characteristics of the cellular thermoplastic foam profiles 122A-122J can be varied, if desired, to provide different support characteristics in the unitary composite cushioning structure 120 to provide different zones or regions of support characteristics. For example, the unitary composite cushioning structure 120 may be designed to support different loads in different portions of the unitary composite cushioning structure 120 such that it may be desired to provide firmer or greater support in certain cellular thermoplastic foam profiles 122A-122J than others. For example, certain cellular thermoplastic foam profiles 122A-122J may be located where head, torso, and foot loads will likely be displaced.

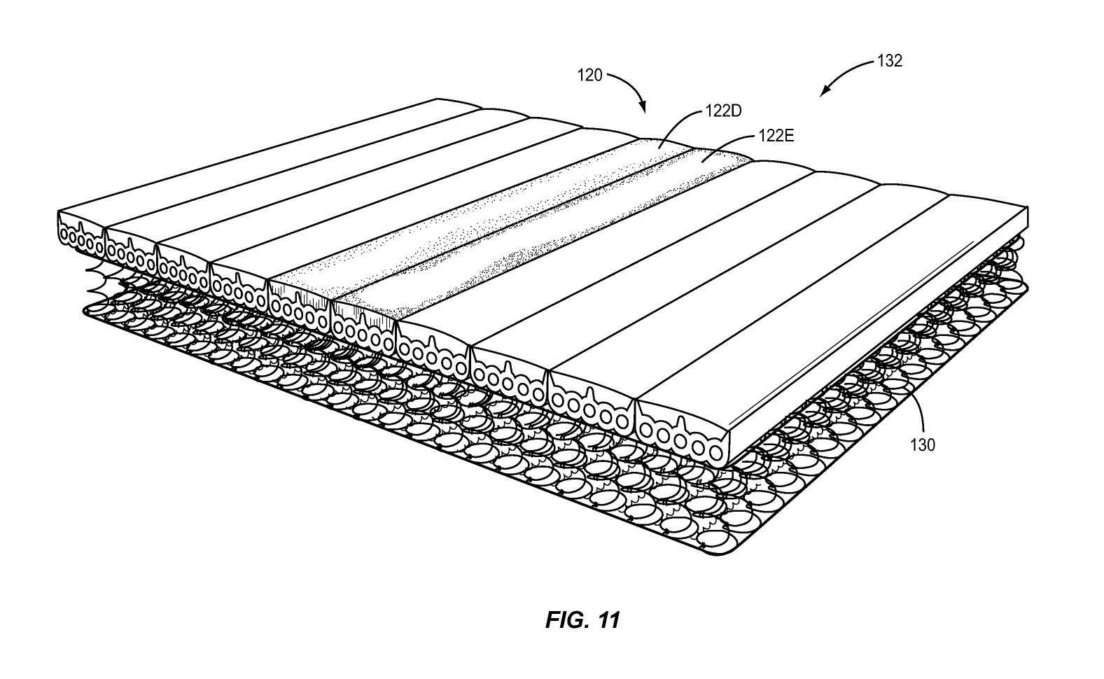

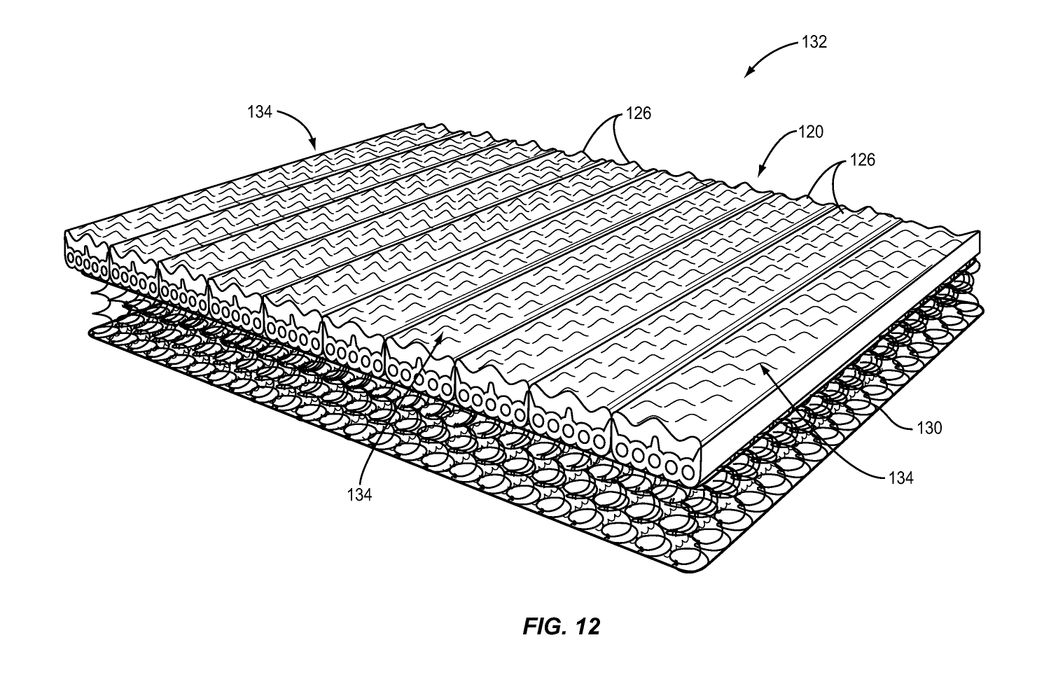

The cellular thermoplastic foam profiles 122A-122J in this embodiment each include open chambers 124 that are configured to receive a thermoset material 126 to provide the unitary composite cushioning structure 120, as illustrated in FIG. 10A and 10B. Stratums 128 are disposed therebetween where the thermoset material 126 is cohesively or adhesively bonded to the cellular thermoplastic foam profiles 122A-122J. The cushioning properties of the thermoset material 126 can be selected and be different for the cellular thermoplastic foam profiles 122A-122J, if desired, to provide variations in cushioning characteristics of the unitary composite cushioning structure 120. FIG. 11 illustrates the unitary composite cushioning structure 120 provided as a support layer disposed on top of an innerspring 130 as part of a mattress assembly 132. In this example, certain of the cellular thermoplastic foam profiles 122D, 122E are designed to provide lumbar support for the mattress assembly 132. Other variations can be provided. For example, as illustrated in FIG. 12, convolutions 134 can be disposed in the thermoset material 126 to provide designed resiliency and support characteristics. The convolutions 134 are not disposed at the stratum 128 in this embodiment.

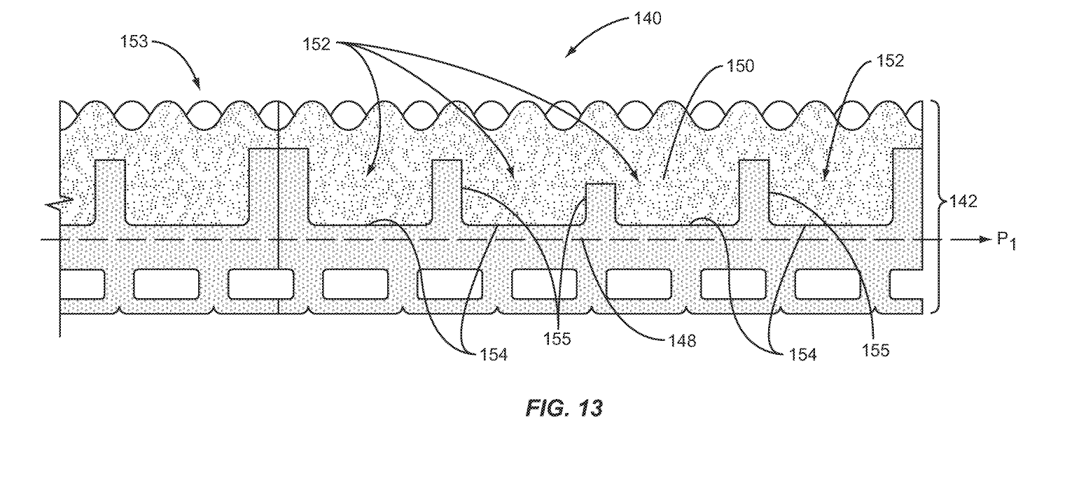

FIG. 13 is another exemplary cross-section profile of a mattress 140 employing a unitary composite cushioning structure 142 for a bedding or seating cushioning application. In this embodiment, a base 144 is extruded as part of a cellular thermoplastic foam profile 148 provided in the unitary composite cushioning structure 142 for the mattress 140. The unitary composite cushioning structure 142 is provided from a composite of the cellular thermoplastic foam profile 148 and a thermoset material 150 disposed in open channels 152 of the cellular thermoplastic foam profile 148, with a stratum 154 disposed therebetween. The open channels 152 are provided as extensions 155 that extend generally orthogonally from a longitudinal plane P₁ of the cellular thermoplastic foam profile 148. Further, in this embodiment, convolutions 153 are provided in the thermoset material 150, similar to those provided in FIG. 12 (element 134). The cellular thermoplastic foam profile 148 and the thermoset material 150 may be provided according to any of the previously described examples and materials. The unitary composite cushioning structure 142 may be provided according to any of the examples and processes described above.

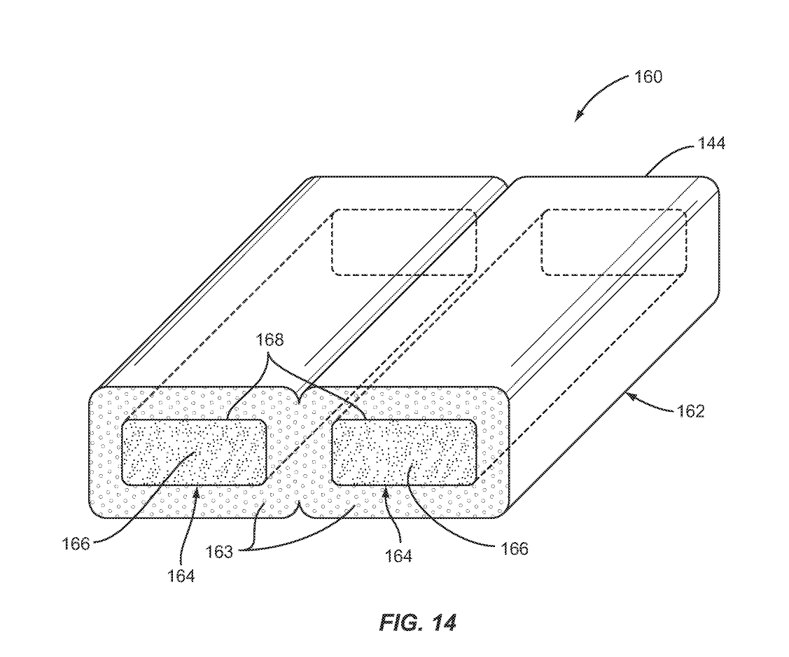

As previously discussed above, other components of a mattress may also be provided with a unitary composite cushioning structure according to embodiments disclosed herein. For example, FIG. 14 illustrates a portion of the base 144 in FIG. 13, but provided as a unitary composite cushioning structure 160 comprised of a cellular thermoplastic foam profile 162 comprised of a thermoplastic material 163 having closed channels 164 disposed therein. A thermoset material 166 is disposed in the closed channels 164 and cohesively or adhesively bonded to the cellular thermoplastic foam profile 162 at a stratum 168 disposed therebetween. The unitary composite cushioning structure 160 and the cellular thermoplastic foam profile 162 and thermoset material 166 may be provided according to any of the previously described examples and materials. The unitary composite cushioning structure 160 could be provided as other supports in the mattress 100, including but not limited to side, edge, or corner supports. The embodiments of unitary composite cushioning structures described thus far have provided an outer thermoplastic material with a thermoset material disposed therein. However, the embodiments disclosed herein are not limited to this configuration. The unitary composite cushioning structure could be formed such that a thermoset material is disposed on the outside, partially or fully, of a thermoplastic material. For example, the thermoset material could partially or fully encapsulate the thermoplastic material.

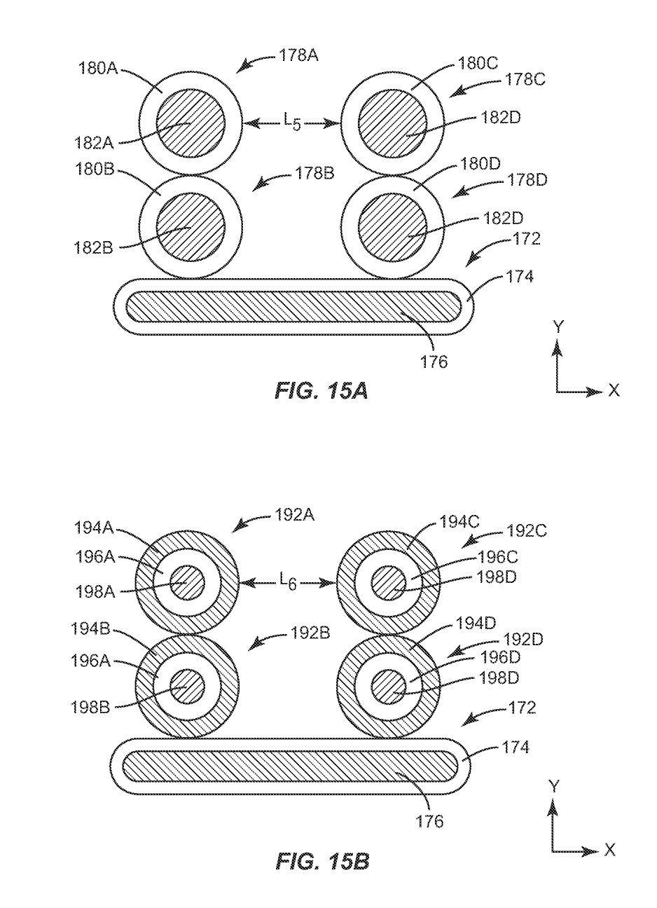

In this regard, FIGS. 15A-39 illustrate side profiles of alternative exemplary embodiments of unitary composite cushioning structures that involve different geometric configuration and different thermoplastic foam and thermoset material profiles. The thermoplastic could be a foamed polymer from including, but not limited to polyethylene, an EVA, a TPO, a TPV, a PVC, a chlorinated polyethylene, a styrene block copolymer, an EMA, an ethylene butyl acrylate (EBA), and the like, as examples. These thermoplastic materials may also be inherently resistant to microbes and bacteria, making them desirable for use in the application of cushioning structures. These materials can be also made biodegradable and fire retardant through the use of additive master batches. The thermoplastic could be foamed to an approximate cell size of 0.25 to 2.0 mm, although such is not required or limiting to the scope of the embodiments disclosed herein.

The thermoset foam in these examples could be foamed latex rubber, which is hypo-allergenic, and breathes to keep you warm in the winter and cool in the summer. Further, bacteria, mildew, and mold cannot live in the foamed latex rubber. The thermoset foam can be obtained in emulsified form and is frothed to introduce air into the emulsion to reduce density, and is then cured (vulcanized) to remove additional waters and volatiles as well as to set the material to its final configuration. The foamed latex rubber could also be further cost reduced through the addition of fillers such as ground foam reclaim materials, nano clays, carbon nano tubes, calcium carbonate, flyash and the like, but also corc dust as this material can provide for increased stability to the thermoset material to while reducing the overall density, weight, and/or cost of the thermoset material. A stratum may be disposed between interfaces of different materials of thermoplastic and thermoset materials.

For example, FIG. 15A illustrates a side profile of another exemplary composite cushioning structure 170. The composite cushioning structure 170 is comprised of five separate members, each of which can be unitary composite cushioning structures in their own right. A base member 172 is provided that may be a unitary composite cushioning structure. For example, a surrounding material 174 may be disposed completely around a core material 176 to provide the base member 172. Core material is material that can disposed partially or wholly internal within a structure. The surrounding material 174 may be a cellular thermoplastic material and the core material 176 a thermoset material, or vice versa. To provide cushioning support in the Y direction, additional unitary composite cushioning structures 178A-178D are disposed above the base member 172 in the Y direction. Each unitary composite cushioning structure 178A-178D may comprise a surrounding material 180A-180D disposed around a core material 182A-182D to provide the unitary composite cushioning structures 178A-178D. The surrounding materials 180A-180D may be a cellular thermoplastic material and the core materials 182A-182D a thermoset material, or vice versa. The unitary composite cushioning structures 178A-178D can each be provided of different material composites or arrangements.

Two unitary composite cushioning structures 178A, 178B are stacked on top of each other. The unitary composite cushioning structure 178B may be secured to the base member 172 adhesively or cohesively. The unitary composite cushioning structure 178A may be secured to the unitary composite cushioning member 178B adhesively or cohesively. The arrangement is provided for the unitary cushioning structures 178C and 178D, as illustrated in FIG. 15A. The unitary composite cushioning structures 178A, 178B and 178C, 178D are arranged such that a minimum gap of length L5 is provide therebetween. The number of stacked unitary cushioning structures 178, their stacked height, their material composition, and the length L5 all determine the overall cushioning and support characteristics provided by the composite cushioning structure 170.

As another example, FIG. 15B illustrates a side profile of another exemplary composite cushioning structure 190. The composite cushioning structure 190 is comprised of five separate members like the composite cushioning structure 170 in FIG. 5, each of which can be unitary composite cushioning structures in their own right. The base member 172 in FIG. 15A is provided. To provide cushioning support in the Y direction, additional unitary composite cushioning structures 192A-192D are disposed above the base member 172 in the Y direction. Each unitary composite cushioning structure 192A-192D may comprise a surrounding material 194A-194D disposed completely around intermediate material 196A-196D, which is disposed completely around a core material 198A-198D to provide the unitary composite cushioning structures 192A-192D. The surrounding materials 194A-194D may be comprised of a cellular thermoplastic material or a thermoset material. The intermediate materials 196A-196D may be comprised of a cellular thermoplastic material or a thermoset material, The core materials 198A-198D cellular thermoplastic material or a thermoset material. The materials provided in the surrounding material 194, the intermediate material 196, and the core material 198 may be such that adjacent materials alternate between thermoplastic material and thermoset material to provide the desired cushioning and support characteristics. Note that intermediate material 196 may not be included inside the surrounding material 194 to provide a hollow portion where the intermediate material 196 is disposed in FIG. 15B. Also note that core material 198 may not be included inside the intermediate material 196 to provide a hollow portion where the core material 198 is disposed in FIG. 15B.

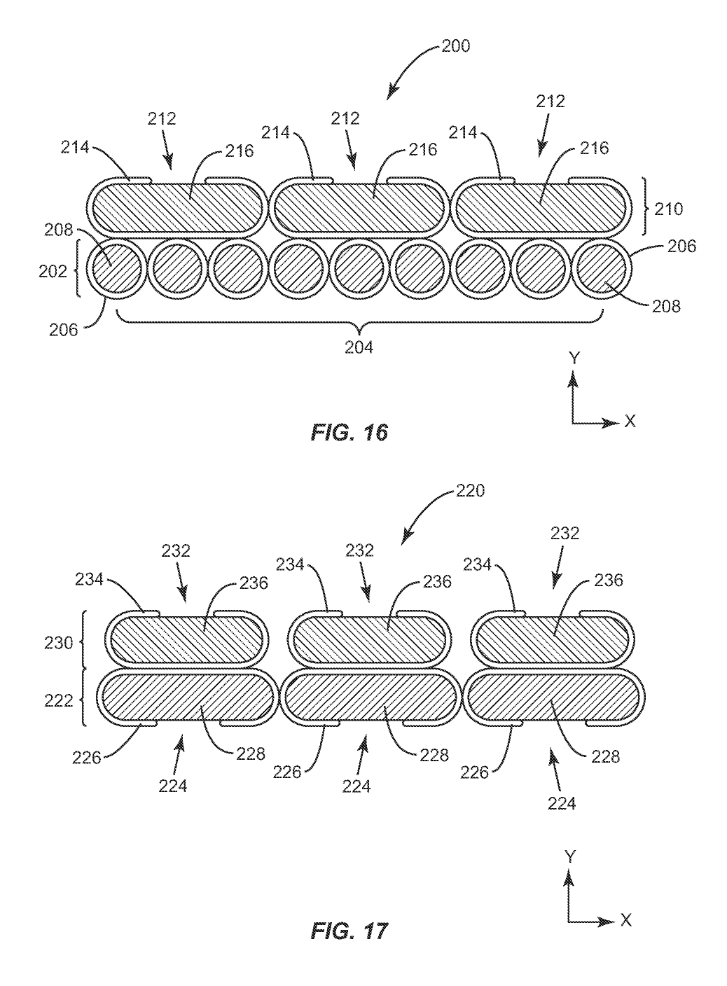

As another example, FIG. 16 illustrates a side profile of another exemplary composite cushioning structure 200. The composite cushioning structure 200 is comprised of a first layer 202 of cylindrical unitary composite cushioning structures 204 aligned side-by-side in the X direction to provide a base cushioning and support structure. The unitary composite cushioning structures 204 may be secured to each other adhesively or cohesively. Each unitary composite cushioning structure 204 may comprise a surrounding material 206 disposed completely around a core material 208 to provide the unitary composite cushioning structures 204. The surrounding materials 206 may be comprised of a cellular thermoplastic material and the core materials 208 comprised of thermoset material, or vice versa. Alternatively, the core material 208 may not be provided to provide a hollow portion disposed within the surrounding material 206.

With continuing reference to FIG. 16, a second layer 210 of unitary composite cushioning structures 212 are disposed side-by-side and collectively on top of the unitary composite cushioning structures 204 in the Y direction. The second layer 210 of unitary composite cushioning structures 212 may be adhesively or cohesively secured to the first layer 202 of unitary composite cushioning structures 204. The unitary composite cushioning structures 212 may be secured to each other adhesively or cohesively. The unitary composite cushioning structures 212 may comprised of open profiles of surrounding materials 214 disposed in a U-shape or C-shape and not closed with a core material 216 disposed therein as illustrated in FIG. 16 to provide more influence of the core material 216 in the cushioning and support characteristics of the unitary cushioning structure 200. Note that core materials 208 and/or 216 may not be included inside the surrounding materials 206, 214, respectively, to provide hollow portions where the core materials 208 and/or 216 are disposed in FIG. 16.

As another example, FIG. 17 illustrates a side profile of another exemplary composite cushioning structure 220. The composite cushioning structure 220 is comprised of a first layer 222 of open unitary composite cushioning structures 224 aligned side-by-side in the X direction to provide a base cushioning and support structure. The unitary composite cushioning structures 224 may be secured to each other adhesively or cohesively. Each unitary composite cushioning structure 224 may comprise a surrounding material 226 in an open profile disposed partially around a core material 228 to provide the unitary composite cushioning structures 224 and to provide more influence of the core material 228. The surrounding materials 226 may be comprised of a cellular thermoplastic material and the core materials 228 comprised of thermoset material, or vice versa. Alternatively, the core material 228 may not be provided to provide a hollow portion disposed within the surrounding material 226.

With continuing reference to FIG. 17, a second layer 230 of unitary composite cushioning structures 232 are disposed side-by-side and collectively on top of the unitary composite cushioning structures 224 in the Y direction. The second layer 230 of unitary composite cushioning structures 232 may be adhesively or cohesively secured to the first layer 222 of unitary composite cushioning structures 224. The unitary composite cushioning structures 232 may be secured to each other adhesively or cohesively. The unitary composite cushioning structures 232 may comprised of open profiles of surrounding materials 234 with a core material 236 disposed therein as illustrated in FIG. 17 to provide more influence of the core material 236 in the cushioning and support characteristics of the composite cushioning structure 220. Note that core materials 228 and/or 236 may not be included inside the surrounding materials 226, 234, respectively, to provide hollow portions where the core materials 228 and/or 236 are disposed in FIG. 17.

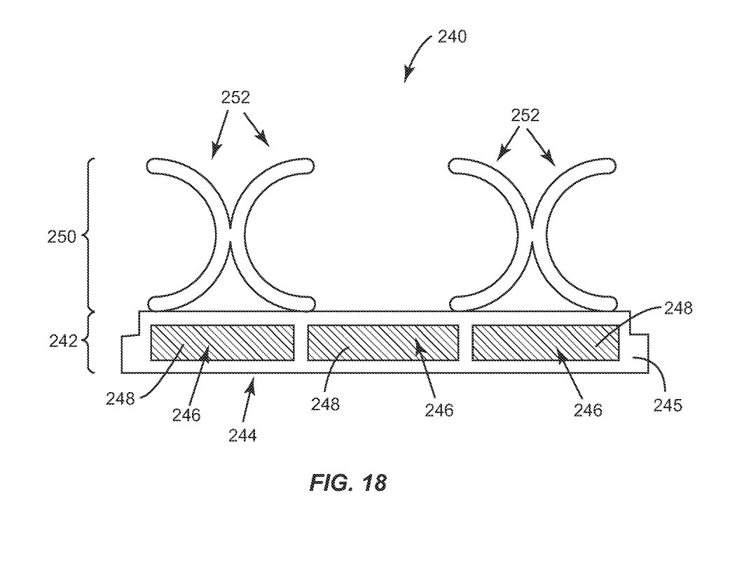

As another example, FIG. 18 illustrates a side profile of another unitary exemplary composite cushioning structure 240. The unitary composite cushioning structure 240 is comprised of a first layer 242 of a closed unitary composite cushioning structure 244 to provide a base cushioning and support structure. The unitary composite cushioning structure 244 comprises an outer material 245 with openings 246 disposed therein with a core material 248 disposed in the openings 246 to provide the unitary composite cushioning structures 244. The outer material 245 may be extruded with the openings 246 present, or the openings 246 may be portions of the outer material 245 cut from internal portions. The outer material 245 may be comprised of a cellular thermoplastic material and the core materials 248 comprised of thermoset material, or vice versa. Alternatively, the core material 248 may not be provided to provide a hollow portion disposed within the outer material 245.

With continuing reference to FIG. 18, a second layer 250 of cushioning structures 252 provided in the form of C-shaped members are disposed in pairs, side-by-side and cohesively or adhesively attached to each other, or provided as a single member. on top of the first layer 242 in the Y direction. The second layer 250 of cushioning structures 252 may be adhesively or cohesively secured to the first layer 242 of the unitary composite cushioning structures 244.

As another example, FIG. 19A illustrates the same first layer 242 of a closed unitary composite cushioning structure 244 in FIG. 18 to provide a base cushioning and support structure. A second layer 262 of cushioning structures 264 provided in the form of closed cylindrical-shaped members cohesively or adhesively attached on top of the unitary composite cushioning structure 244 in the first layer 242 in the Y direction. Each unitary composite cushioning structure 264 may comprise a surrounding material 266 disposed completely around a core material 268 to provide the unitary composite cushioning structures 264. The surrounding materials 266 may be comprised of a cellular thermoplastic material and the core materials 268 comprised of thermoset material, or vice versa. Alternatively, the core material 268 may not be provided to provide a hollow portion disposed within the surrounding material 266. FIG. 19B illustrates a similar unitary composite cushioning structure 280 similar to the unitary composite cushioning structure 260 in FIG. 19B. The second layer 282 is comprised of the unitary composite cushioning structures 266 stacked on top of each other above the unitary composite cushioning structure 244 in pairs to provide additional height in the unitary composite cushioning structure 280 and to provide more influences from the unitary composite cushioning structure 280.

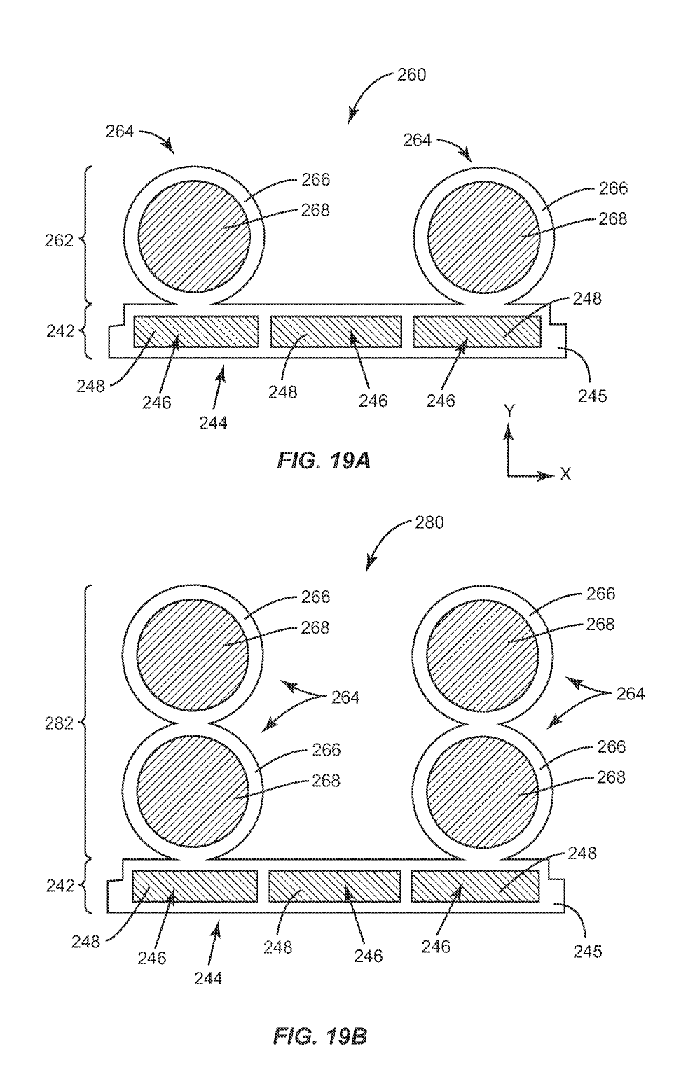

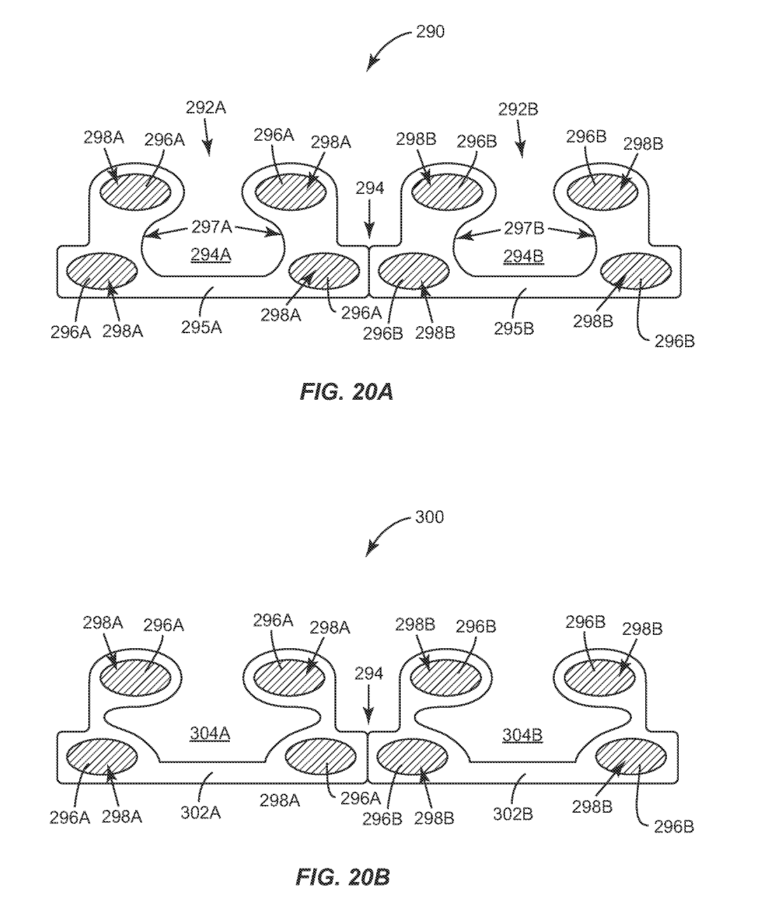

As another example, FIG. 20A illustrates a side profile of another unitary composite cushioning structure 290. The unitary composite cushioning structure 290 comprises unitary composite cushioning members 292A, 292B provided as separate members and arranged side-by-side and adhesively or cohesively attached at interface 294. Unitary composite cushioning members 292A, 292B each provide an open profile with openings 294A, 294B disposed in an outer material 295A, 295B. The profile of the neck portions 297A, 297B define the size and shape of the openings 294A, 294B. Instead of core material being disposed inside the openings 294A, 294B, core material 296A, 296B is disposed in interior openings 298A, 298B. The outer materials 295A, 295B may be comprised of a cellular thermoplastic material and the core materials 296A, 296B comprised of thermoset material, or vice versa. Alternatively, the core materials 296A, 296B may not be provided to provide a hollow portion disposed within the outer materials 295A, 295B. FIG. 20B illustrates a unitary composite cushioning structure 300 similar to the unitary composite cushioning structure 290 in FIG. 20B. However, the profile of openings 304A, 304B are defined by the profile of different shaped neck portions 306A, 306B disposed in the outer materials 302A, 302B.

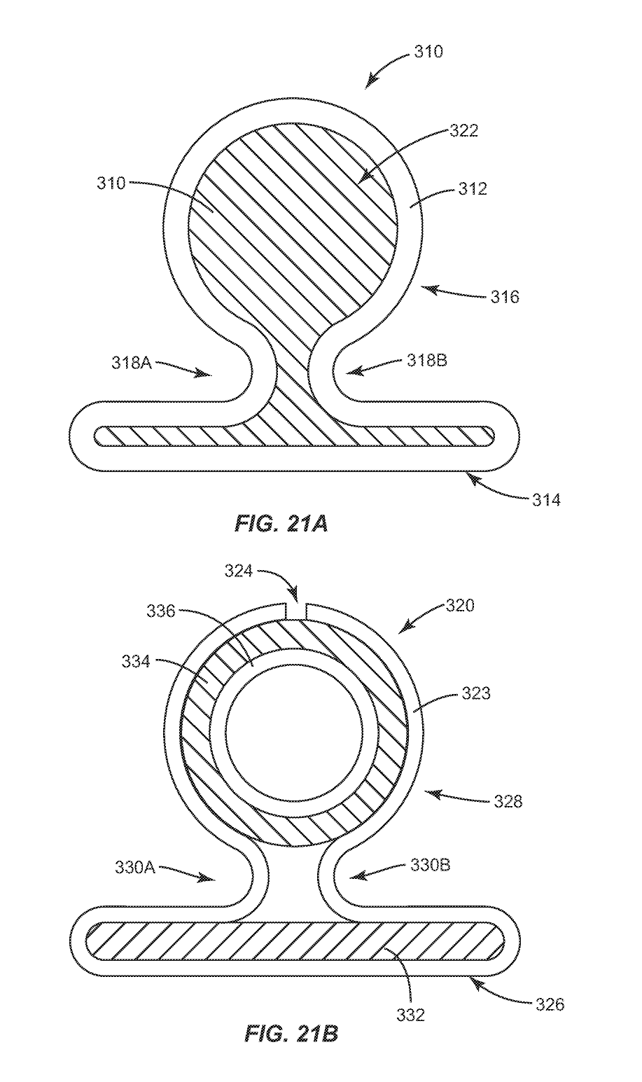

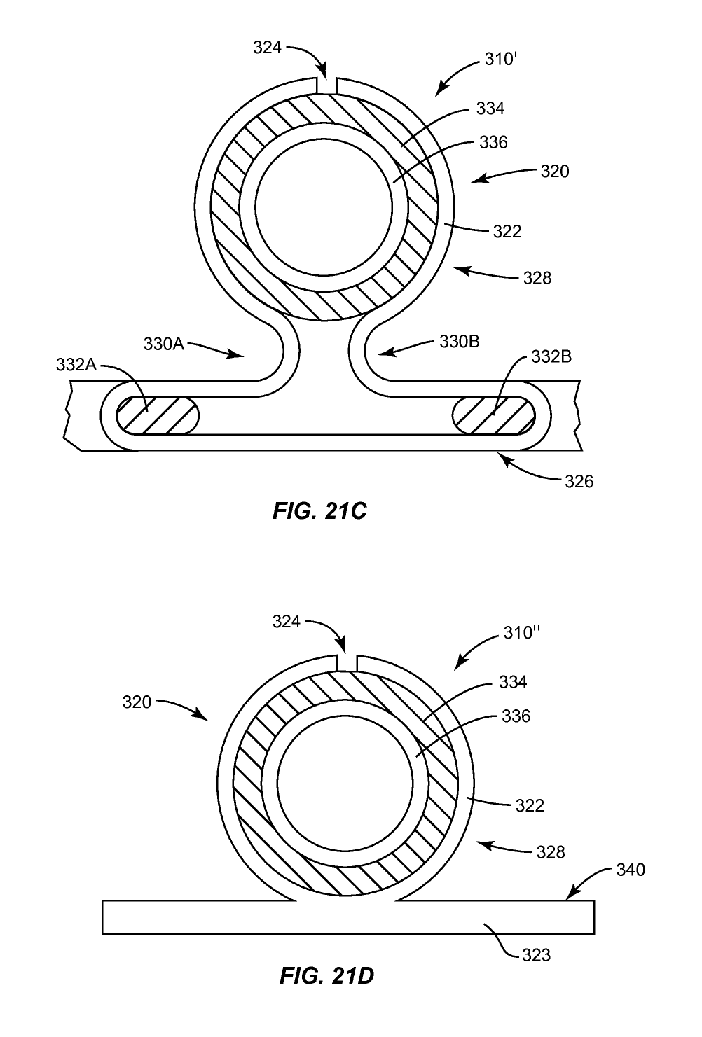

As another example, FIG. 21A illustrates a side profile of another unitary composite cushioning structure 310. The unitary composite cushioning structure 310 includes an outer material 312 having the closed profile illustrated in FIG. 21A. The profile of the unitary composite cushioning structure 310 is comprised of a base portion 314 and a head portion 316 having neck portions 318A, 318B disposed therebetween. The profile of the neck portions 318A, 318B define the size and shape of the head portion 316. A core material 320 may be disposed inside an opening 322 disposed in the outer material 312 to provide the unitary composite cushioning structure 310. The outer material 312 may be comprised of a cellular thermoplastic material and the core material 320 comprised of thermoset material, or vice versa. Alternatively, the core material 320 may not be provided to provide a hollow portion disposed within the outer material 312.

As another example, FIG. 21B illustrates a side profile of another unitary composite cushioning structure 310. The unitary composite cushioning structure 320 includes an outer material 323 having an open profile with opening 324 as illustrated in FIG. 21B. The profile of the unitary composite cushioning structure 310 is comprised of a base portion 326 and a head portion 328 having neck portions 330A, 330B disposed therebetween. The profile of the neck portions 330A, 330B define the size and shape of the head portion 328. A core material 332 may be disposed inside the base portion 326. The base portion 326 may be comprised of a cellular thermoplastic material and the core material 332 comprised of thermoset material, or vice versa. An intermediate material 334 may be disposed inside the head portion 328, which is disposed around a core material 336, as illustrated in FIG. 21B. The outer material 322, the intermediate material 334, and the core material 336 may be comprised of a cellular thermoplastic material or thermoset materials, in any combination of each.

FIGS. 21C and 21D illustrate the same head portion 328 in FIG. 21B, but with different base portion arrangements. In FIG. 21C, a unitary composite cushioning structure 310′ is provided that provides core material 332A, 332B only in smaller, separate designated portions of the base portion 326. In the unitary composite cushioning structure 310″ in FIG. 21D, the base portion 340 is provided of a different profile with a base material 323 that does not include openings for disposition of a core material.

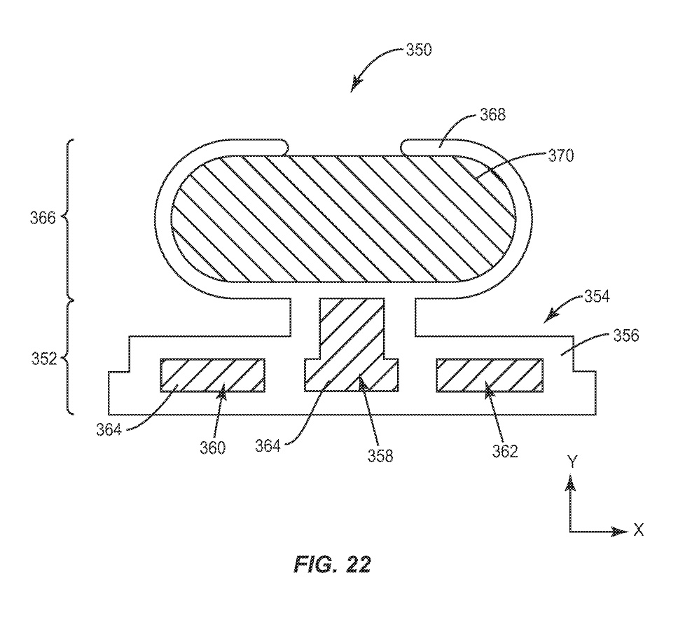

As another example, FIG. 22 illustrates a side profile of another exemplary unitary composite cushioning structure 350. The unitary composite cushioning structure 350 is comprised of a first layer 352 of a closed unitary composite cushioning structure 354 to provide a base cushioning and support structure. The unitary composite cushioning structure 354 comprises an outer material 356 with openings 358, 360, 362 disposed therein with a core material 364 disposed in the openings 358, 360, 362 to provide the unitary composite cushioning structure 354. The outer material 356 may be extruded with the openings 358, 360, 362 present, or the openings 358, 360, 362 may be portions of the outer material 356 cut from internal portions. The outer material 356 may be comprised of a cellular thermoplastic material and the core materials 364 comprised of thermoset material, or vice versa. Alternatively, the core material 364 may not be provided to provide a hollow portion disposed within the outer material 356.

With continuing reference to FIG. 22, a second layer 366 of a cushioning structure 368 provided in the form of C-shaped member with an open profile is disposed on top of the first layer 352 in the Y direction either cohesively or adhesively. A core material 370 may be disposed within the cushioning structure 368 if desired. The cushioning structure may be comprised of a cellular thermoplastic material and the core materials 370 comprised of thermoset material, or vice versa. Alternatively, the core material 370 may not be provided to provide a hollow portion disposed within the cushioning structure 368.

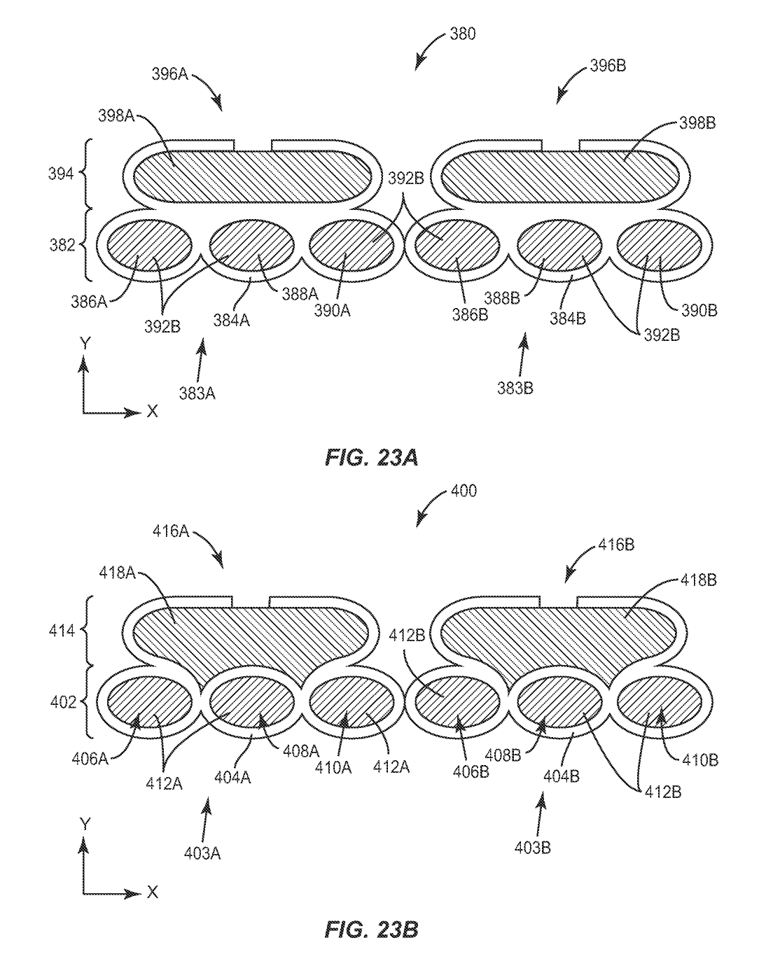

As another example, FIG. 23A illustrates a side profile of another exemplary unitary composite cushioning structure 380. The unitary composite cushioning structure 380 is comprised of a first layer 382 of a closed unitary composite cushioning structures 383A, 383B arranged side-by-side and cohesively or adhesively attached to each other to provide a base cushioning and support structure. Each unitary composite cushioning structure 383A, 383B comprises an outer material 384A, 384B with openings 386A, 386B, 388A, 388B, 390A, 390B disposed therein with a core material 392A, 392B disposed in the openings 386A-390B to provide the unitary composite cushioning structures 383A, 383B. The outer materials 384A, 384B may be extruded with the openings 386A-390B present, or the openings 386A-390B may be portions of the outer materials 384A, 384B cut from internal portions. The outer materials 384A, 384B may be comprised of a cellular thermoplastic material and the core materials 392A, 392B comprised of thermoset material, or vice versa. Alternatively, the core materials 392A, 392B may not be provided to provide a hollow portion disposed within the outer materials 384A, 384B.

With continuing reference to FIG. 23A, a second layer 394 of cushioning structures 396A, 396B arranged side-by-side and each provided in the form of C-shaped member with an open profile is disposed on top of the first layer 382 in the Y direction either cohesively or adhesively. Core materials 398A, 398B may be disposed within the cushioning structures 396A, 396B if desired. The cushioning structures 396A, 396B may be comprised of a cellular thermoplastic material and the core materials 398A, 398B comprised of thermoset material, or vice versa. Alternatively, the core materials 398A, 398B may not be provided to provide a hollow portion disposed within the cushioning structures 396A, 396B.

As another example, FIG. 23B illustrates a side profile of another exemplary unitary composite cushioning structure 400. The unitary composite cushioning structure 400 is similar to the unitary composite cushioning structure 380 in FIG. 23B, except that the first layer provides a modified profile. In this regard, the unitary composite cushioning structure 400 is comprised of a first layer 402 of closed unitary composite cushioning structures 403A, 403B arranged side-by-side and cohesively or adhesively attached to each other to provide a base cushioning and support structure. Each unitary composite cushioning structure 403A, 403B comprises an outer material 404A, 404B with openings 406A, 406B, 408A, 408B, 410A, 410B disposed therein with a core material 412A, 412B disposed in the openings 406A-410B to provide the unitary composite cushioning structures 403A, 403B. The outer materials 404A, 404B may be extruded with the openings 406A-410B present, or the openings 406A-410B may be portions of the outer materials 404A, 404B cut from internal portions. The outer materials 404A, 404B may be comprised of a cellular thermoplastic material and the core materials 412A, 412B comprised of thermoset material, or vice versa. Alternatively, the core materials 412A, 412B may not be provided to provide a hollow portion disposed within the outer materials 404A, 404B.

With continuing reference to FIG. 23B, a second layer 414 of cushioning structures 416A, 416B arranged side-by-side and each provided in the form of C-shaped member with an open profile is disposed on top of the first layer 402 in the Y direction either cohesively or adhesively. Core materials 418A, 418B may be disposed within the cushioning structures 416A, 416B if desired. The cushioning structures 416A, 416B may be comprised of a cellular thermoplastic material and the core materials 418A, 418B comprised of thermoset material, or vice versa. Alternatively, the core materials 418A, 418B may not be provided to provide a hollow portion disposed within the cushioning structures 416A, 416B.

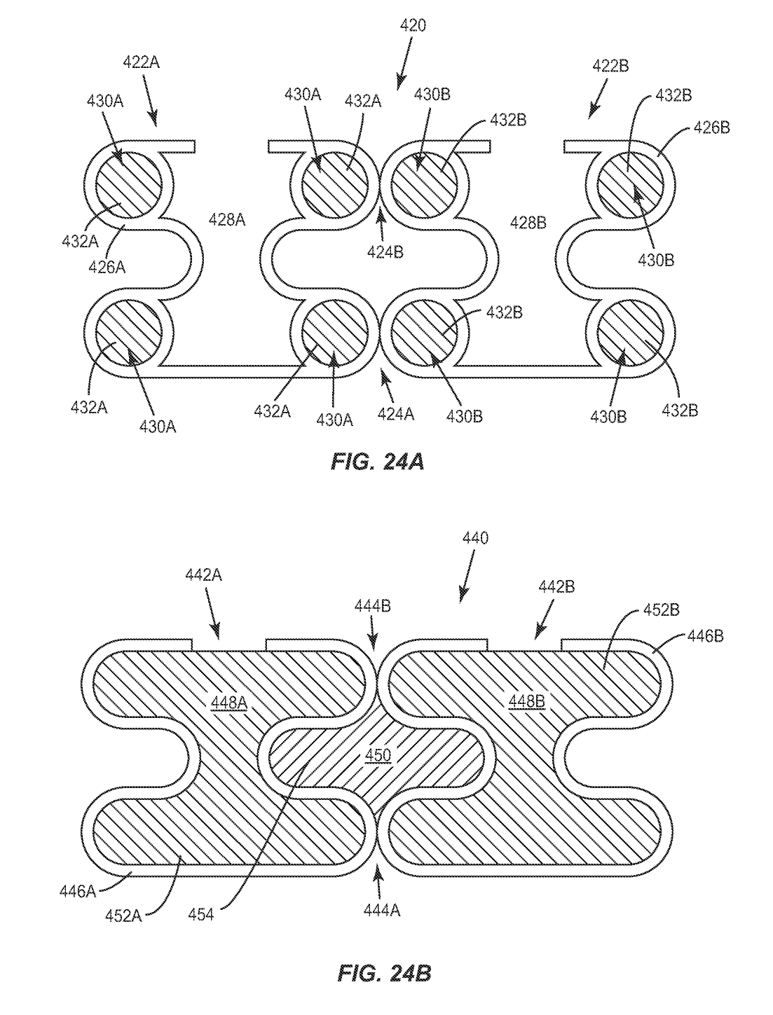

As another example, FIG. 24A illustrates a side profile of another exemplary unitary composite cushioning structure 420. The unitary composite cushioning structure 420 is comprised of two cushioning structures 422A, 422B arranged side-by-side and cohesively or adhesively attached to each other at interfaces 424A, 424B. Each unitary composite cushioning structure 422A, 422B comprises an outer material 426A, 426B having open profiles with openings 428A, 428B disposed therein. The cushioning structures 422A, 422B each provide closed openings 430A, 430B in corners of the outer material 426A, 426B, as illustrated in FIG. 24A. A core material 432A, 432B can be disposed in the openings 430A, 430B to provide the unitary composite cushioning structures 422A, 422B. The outer materials 426A, 426B may be extruded with the openings 430A-430B present, or the openings 430A-430B may be portions of the outer materials 426A, 426B cut from internal portions. The outer materials 426A, 426B may be comprised of a cellular thermoplastic material and the core materials 432A, 432B comprised of thermoset material, or vice versa. Alternatively, the core materials 432A, 432B may not be provided to provide a hollow portion disposed within the outer materials 426A, 426B.

As another example, FIG. 24B illustrates a side profile of another exemplary unitary composite cushioning structure 440. The unitary composite cushioning structure 440 is comprised of two cushioning structures 442A, 442B arranged side-by-side and cohesively or adhesively attached to each other at interfaces 444A, 444B. Each unitary composite cushioning structure 442A, 442B comprises an outer material 446A, 446B having open profiles with openings 448A, 448B disposed therein. The cushioning structures 442A, 442B provide a closed opening 450 as a result of the cushioning structures 442A, 442B being secured side-by-side to each other as illustrated in FIG. 24B. A core material 452A, 452B can be disposed in the openings 448A, 448B to provide the unitary composite cushioning structures 442A, 442B. A core material 454 may also be disposed in the opening 450. The outer materials 446A, 446B may be comprised of a cellular thermoplastic material and the core materials 452A, 452B, and/or 454 comprised of thermoset material, or vice versa. Alternatively, the core materials 452A, 452B, 454 may not be provided to provide a hollow portion disposed within the outer materials 446A, 446B.

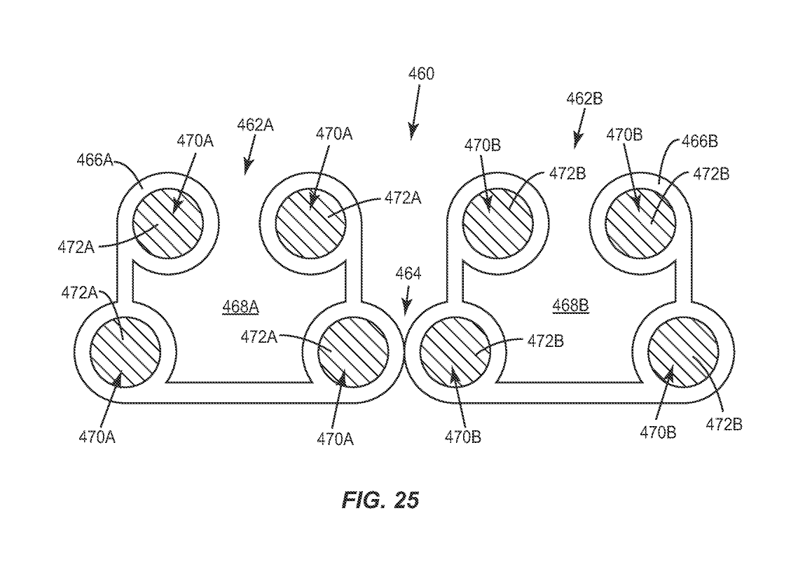

As another example, FIG. 25 illustrates a side profile of another exemplary unitary composite cushioning structure 460. The unitary composite cushioning structure 460 is comprised of two cushioning structures 462A, 462B arranged side-by-side and cohesively or adhesively attached to each other at interface 464. Each unitary composite cushioning structure 462A, 462B comprises an outer material 466A, 466B having open profiles with openings 468A, 468B disposed therein. The cushioning structures 462A, 462B each provide round-shaped closed openings 470A, 470B in corners of the outer material 466A, 466B, as illustrated in FIG. 25. A core material 472A, 472B can be disposed in the openings 470A, 470B to provide the unitary composite cushioning structures 462A, 462B. The outer materials 466A, 466B may be extruded with the openings 470A, 470B present, or the openings 470A, 470B may be portions of the outer materials 466A, 466B cut from internal portions. The outer materials 466A, 466B may be comprised of a cellular thermoplastic material and the core materials 472A, 472B comprised of thermoset material, or vice versa. Alternatively, the core materials 472A, 472B may not be provided to provide a hollow portion disposed within the outer materials 466A, 466B.

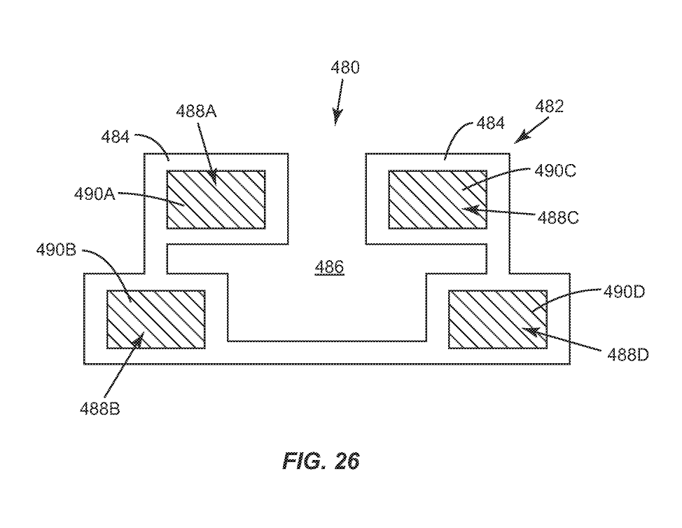

As another example, FIG. 26 illustrates a side profile of another exemplary unitary composite cushioning structure 480. The unitary composite cushioning structure 480 is comprised of a cushioning structure 482. The unitary composite cushioning structure 482 comprises an outer material 484 having an open profile with an opening 486 disposed therein. The cushioning structure 482 provides rectangular-shaped closed openings 488A, 488B, 488C, 488D in corners of the outer material 484, as illustrated in FIG. 26. A core material 490A-490D can be disposed in the openings 488A-488D to provide the unitary composite cushioning structure 480. The outer material 484 may be extruded with the openings 486, 488A-488D present, or the openings 486, 488A-488D may be portions of the outer material 484 cut from internal portions. The outer material 484 may be comprised of a cellular thermoplastic material and the core materials 490A-490D comprised of thermoset material, or vice versa. Alternatively, the core materials 490A-490D may not be provided to provide a hollow portion disposed within the outer material 484.

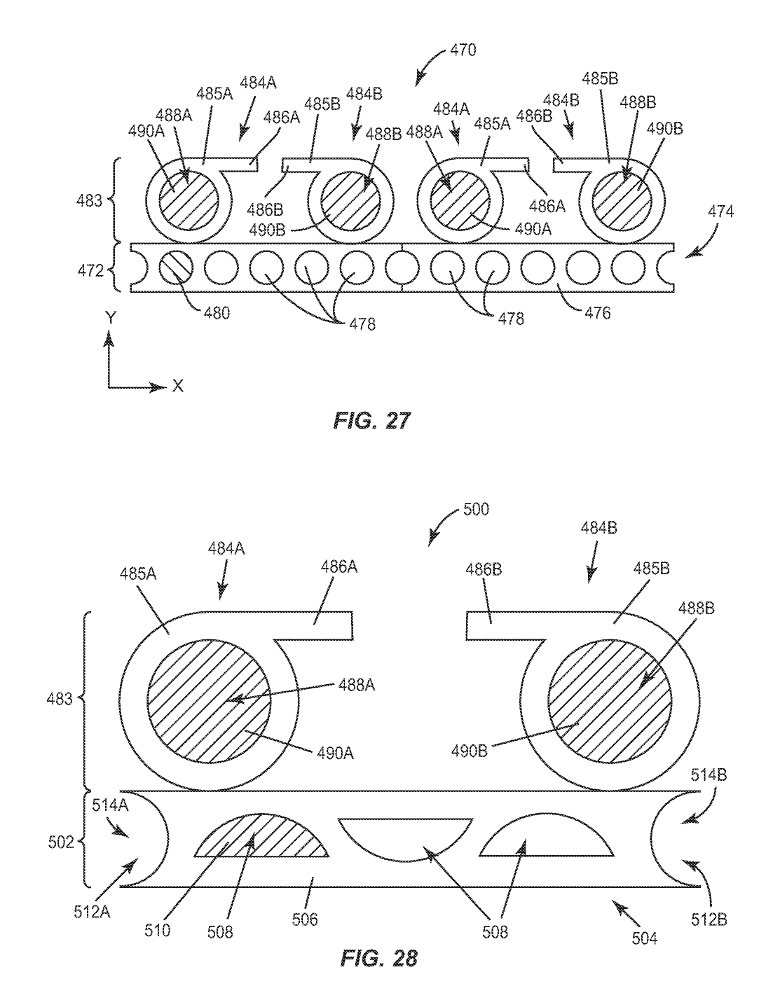

As another example, FIG. 27 illustrates a side profile of another exemplary unitary composite cushioning structure 470. The unitary composite cushioning structure 470 is comprised of a first layer 472 of a closed unitary composite cushioning structure 474 to provide a base cushioning and support structure. The unitary composite cushioning structure 474 comprises an outer material 476 with openings 478 disposed therein. A core material 480 may be disposed in the openings 478 if desired. The outer material 476 may be extruded with the openings 478 present. The outer material 476 may be comprised of a cellular thermoplastic material and the core material 480 comprised of thermoset material, or vice versa. Alternatively, the core material 480 may not be provided to provide a hollow portion disposed within the outer material 476.

With continuing reference to FIG. 27, a second layer 483 of closed cushioning structures 484A, 484B comprised of an outer materials 485A, 485B having openings 488A, 488B disposed therein with extension members 486A, 486B disposed on top of the first layer 472 in the Y direction either cohesively or adhesively. A core material 490A, 490B may be disposed within the openings 488A, 488B of the cushioning structures 484A, 484B if desired. The cushioning structures 484A, 484B may be comprised of a cellular thermoplastic material and the core materials 490A, 490B comprised of thermoset material, or vice versa. Alternatively, the core material 490A, 490B may not be provided to provide a hollow portion disposed within the cushioning structures 484A, 484B.

As another example, FIG. 28 illustrates a side profile of another exemplary unitary composite cushioning structure 500 that contains the same second layer 483 as in FIG. 27. However, a first layer 502 of the unitary composite cushioning structure 500 is comprised of an alternative closed unitary composite cushioning structure 504 to provide a base cushioning and support structure. The unitary composite cushioning structure 504 comprises an outer material 506 with openings 508 disposed therein. The openings 508 are semi-circular shaped in this embodiment. A core material 510 may be disposed in the openings 408 if desired. The outer material 506 may be extruded with the openings 508 present. The outer material 506 may be comprised of a cellular thermoplastic material and the core material 510 comprised of thermoset material, or vice versa. Alternatively, the core material 510 may not be provided to provide a hollow portion disposed within the outer material 506. Circular voids 512A, 512B are disposed on ends 514A, 514B of the first layer 502.

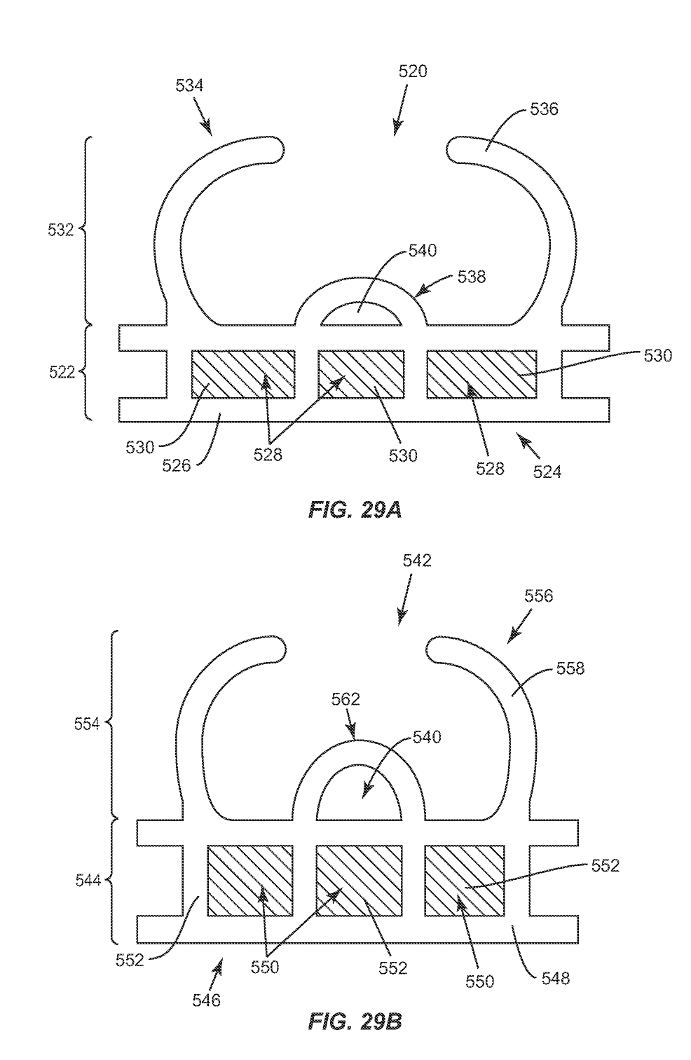

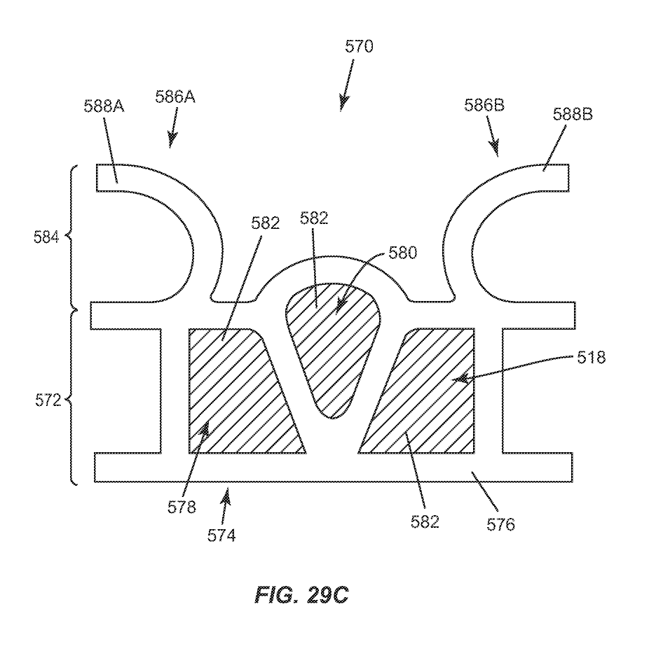

As another example, FIG. 29A illustrates a side profile of another exemplary unitary composite cushioning structure 520. The unitary composite cushioning structure 520 is comprised of a first layer 522 of a closed unitary composite cushioning structure 524 to provide a base cushioning and support structure. The unitary composite cushioning structure 524 comprises an outer material 526 with openings 528 disposed therein. A core material 530 may be disposed in the openings 528 if desired. The outer material 526 may be extruded with the openings 528 present. The outer material 526 may be comprised of a cellular thermoplastic material and the core material 530 comprised of thermoset material, or vice versa. Alternatively, the core material 530 may not be provided to provide a hollow portion disposed within the outer material 526. With continuing reference to FIG. 29A, a second layer 532 of an open cushioning structure 534 comprised of an outer material 536 having a structure 538 with an opening 540 disposed therein.

As another example, FIG. 29B illustrates a side profile of another exemplary unitary composite cushioning structure 542. The unitary composite cushioning structure 542 is comprised of a first layer 544 of a closed unitary composite cushioning structure 546 to provide a base cushioning and support structure. The unitary composite cushioning structure 546 comprises an outer material 548 with openings 550 disposed therein. A core material 552 may be disposed in the openings 550 if desired. The outer material 548 may be extruded with the openings 550 present. The outer material 548 may be comprised of a cellular thermoplastic material and the core material 552 comprised of thermoset material, or vice versa. Alternatively, the core material 552 may not be provided to provide a hollow portion disposed within the outer material 548. With continuing reference to FIG. 29B, a second layer 554 of an open cushioning structure 556 comprised of an outer material 558 having a structure 562 with an opening 540 disposed therein.

As another example, FIG. 29C illustrates a side profile of another exemplary unitary composite cushioning structure 570. The unitary composite cushioning structure 570 is comprised of a first layer 572 of a closed unitary composite cushioning structure 574 to provide a base cushioning and support structure. The unitary composite cushioning structure 574 comprises an outer material 576 with openings 578, 580 disposed therein. Openings 578 are of complementary geometry different from the geometry of opening 580. A core material 582 may be disposed in the openings 578, 580 if desired. The outer material 574 may be extruded with the openings 578, 580 present. The outer material 576 may be comprised of a cellular thermoplastic material and the core material 582 comprised of thermoset material, or vice versa. Alternatively, the core material 582 may not be provided to provide a hollow portion disposed within the outer material 576. With continuing reference to FIG. 29C, a second layer 584 comprised of open cushioning structures 586A, 586B are provided each comprised of an outer material 588A, 588B, wherein the opening cushioning structures 586A, 586B are C-shaped and disposed opposed from each other in the unitary composite cushioning structure 570.

As another example, FIG. 30 illustrates a side profile of another exemplary unitary composite cushioning structure 590. The unitary composite cushioning structure 590 is comprised of a first layer 592 of a closed composite cushioning structure 594A to provide a base cushioning and support structure. The unitary composite cushioning structure 594A comprises an outer material 596 arranged to provide three (3) side-by-side circular structures 598A-598C each having openings 600A-600C disposed therein. A core material 602A-602C may be disposed in the openings 598A-598C if desired. The outer material 596 may be extruded with the openings 600A-600C present as one piece. The outer material 596 may be comprised of a cellular thermoplastic material and the core material 602A-602C comprised of thermoset material, or vice versa. Alternatively, the core material 602A-602C may not be provided to provide a hollow portion disposed within the openings 600A-600C. With continuing reference to FIG. 30, a second layer 604 comprised of a composite cushioning structure 594B that is the same as provided in the first layer 592 is provided and disposed on top of the first layer 592 and secured either cohesively or adhesively.

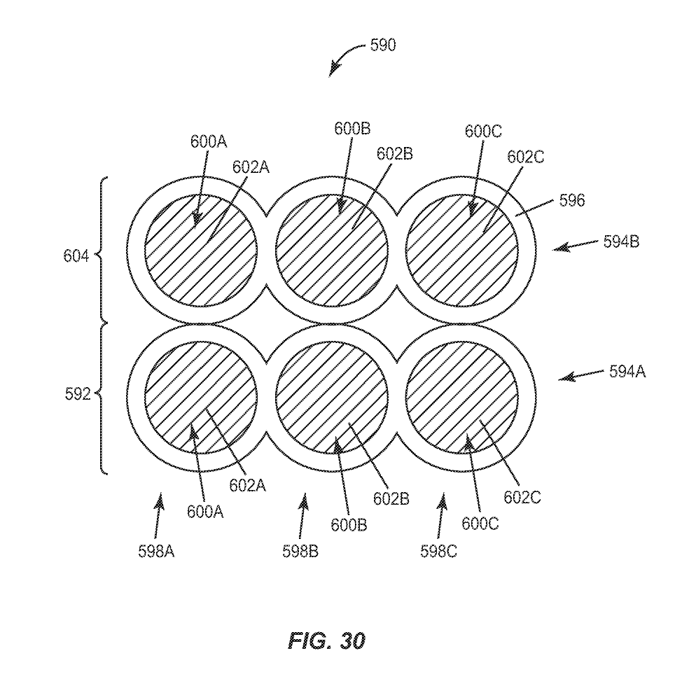

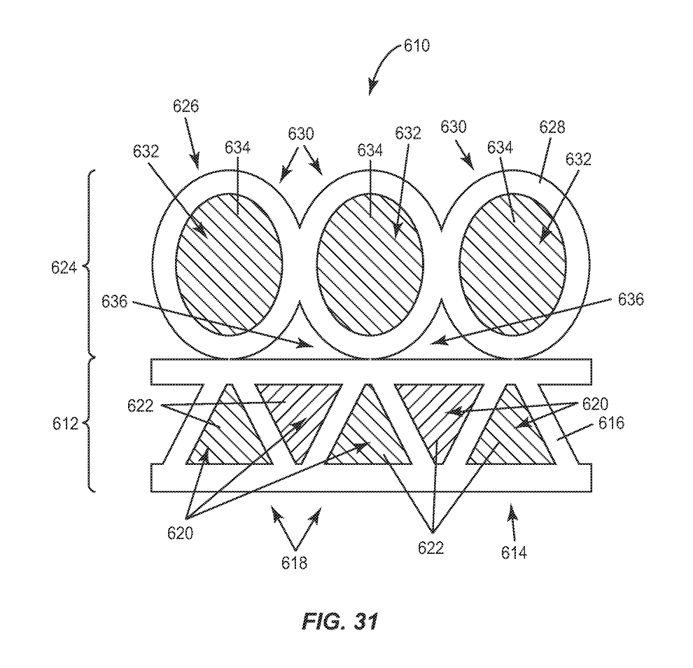

As another example, FIG. 31 illustrates a side profile of another exemplary unitary composite cushioning structure 610. The unitary composite cushioning structure 610 is comprised of a first layer 612 of a closed composite cushioning structure 614 to provide a base cushioning and support structure. The unitary composite cushioning structure 614 comprises an outer material 616 arranged to provide side-by-side triangular structures 618 each having openings 620 disposed therein. A core material 622 may be disposed in the openings 620 if desired. The outer material 616 may be extruded with the openings 620 present as one piece. The outer material 616 may be comprised of a cellular thermoplastic material and the core material 622 comprised of thermoset material, or vice versa. Alternatively, the core material 622 may not be provided to provide a hollow portion disposed within the openings 620.

With continuing reference to FIG. 31, a closed unitary composite cushioning structure 626 is provided and comprised of a second layer 624 to provide an additional cushioning and support structure. The unitary composite cushioning structure 626 comprises an outer material 628 arranged to provide side-by-side elliptical structures 630 each having openings 632 disposed therein. A core material 634 may be disposed in the openings 632 if desired. The outer material 628 may be extruded with the openings 632 present as one piece. The outer material 628 may be comprised of a cellular thermoplastic material and the core material 634 comprised of thermoset material, or vice versa. Alternatively, the core material 634 may not be provided to provide a hollow portion disposed within the openings 632. By providing the side-by-side elliptical structures 630, additional openings 636 are provided when the unitary composite cushioning structure 626 is disposed on top of the unitary composite cushioning structure 614 and attached thereto either adhesively or cohesively.

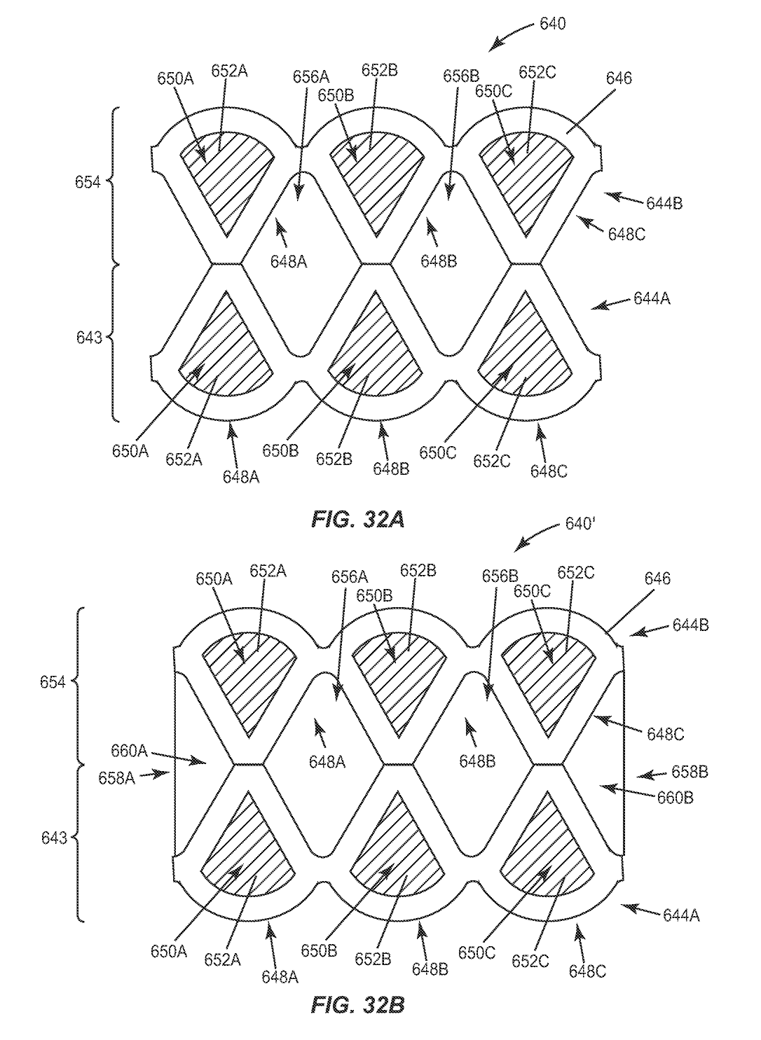

As another example, FIG. 32A illustrates a side profile of another exemplary unitary composite cushioning structure 640. The unitary composite cushioning structure 640 is comprised of a first layer 643 of a closed composite cushioning structure 644A to provide a base cushioning and support structure. The unitary composite cushioning structure 640 comprises an outer material 646 arranged to provide side-by-side triangular structures 648A-648C each having openings 650A-650C disposed therein. A core material 652A-652C may be disposed in the openings 650A-650C if desired. The outer material 646 may be extruded with the openings 650A-650C present as one piece. The outer material 646 may be comprised of a cellular thermoplastic material and the core material 652A-652C comprised of thermoset material, or vice versa. Alternatively, the core material 652A-652C may not be provided to provide a hollow portion disposed within the openings 650A-650C. With continuing reference to FIG. 32A, a second layer 654 comprised of a composite cushioning structure 644B that is the same as the structure 644A provided in the first layer 642, but flipped 180 degrees and disposed on top of the first layer 643 and secured either cohesively or adhesively. In this manner, additional openings 656A, 656B are disposed in the unitary composite cushioning structure 640. FIG. 32B illustrates a unitary composite cushioning structure 640′ that is the same as the unitary composite cushioning structure 640, except that ends 658A, 658B are closed off to form additional openings 660A, 660B

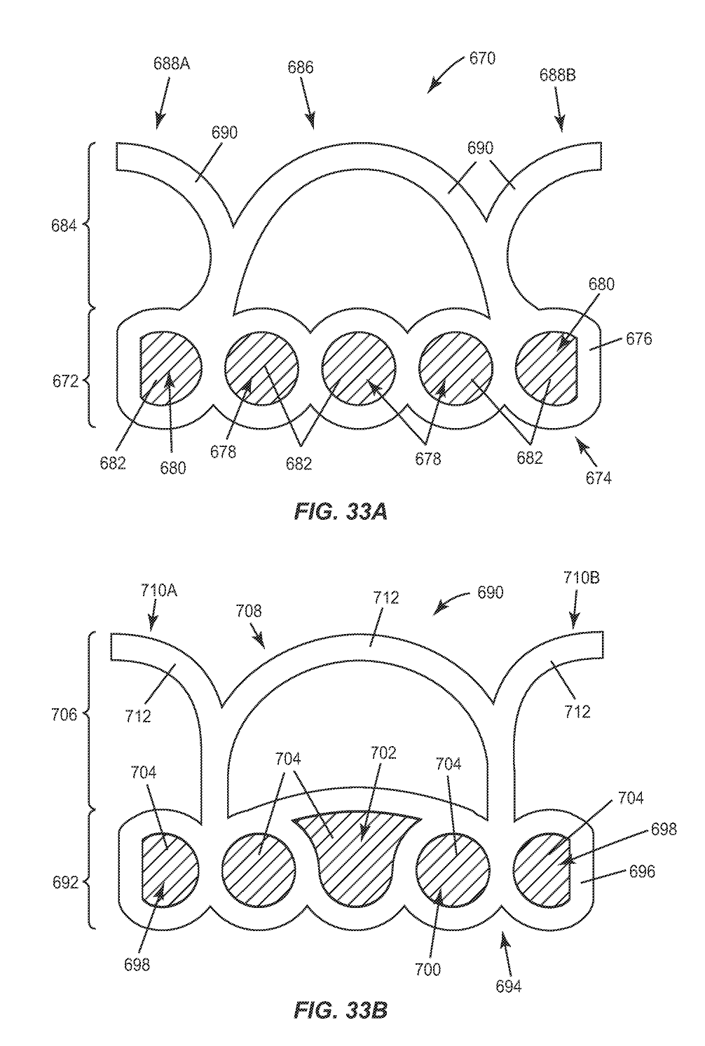

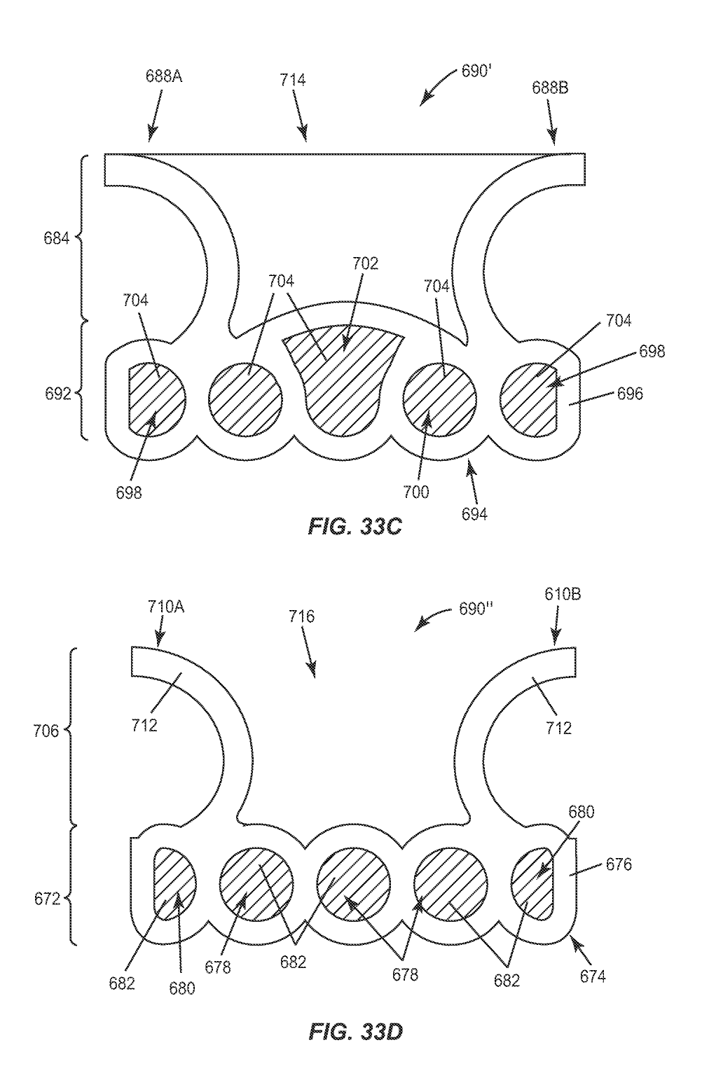

As another example, FIG. 33A illustrates a side profile of another exemplary unitary composite cushioning structure 670. The unitary composite cushioning structure 670 is comprised of a first layer 672 of a closed unitary composite cushioning structure 674 to provide a base cushioning and support structure. The unitary composite cushioning structure 674 comprises an outer material 676 with openings 678, 680 disposed therein. A core material 682 may be disposed in the openings 678, 680 if desired. The outer material 676 may be extruded with the openings 678, 680 present as one piece. The outer material 676 may be comprised of a cellular thermoplastic material and the core material 682 comprised of thermoset material, or vice versa. Alternatively, the core material 682 may not be provided to provide a hollow portion disposed within the outer material 676. With continuing reference to FIG. 33C, a second layer 684 comprised of cushioning structures 686, 688A, 688B are provided each comprised of the same outer material 676, wherein the opening cushioning structures 688A, 688B are C-shaped and disposed opposed from each other in the unitary composite cushioning structure 670 on each side of the closed cushioning structure 686.

As another example, FIG. 33B illustrates a side profile of another exemplary unitary composite cushioning structure 690. The unitary composite cushioning structure 690 is comprised of a first layer 692 of a closed unitary composite cushioning structure 694 to provide a base cushioning and support structure. The unitary composite cushioning structure 694 comprises an outer material 696 with openings 698, 700, 702 disposed therein. A core material 704 may be disposed in the openings 698, 700, 702 if desired. The outer material 696 may be extruded with the openings 698, 700, 702 present as one piece. The outer material 696 may be comprised of a cellular thermoplastic material and the core material 704 comprised of thermoset material, or vice versa. Alternatively, the core material 704 may not be provided to provide a hollow portion disposed within the outer material 696. With continuing reference to FIG. 33B, a second layer 706 comprised of cushioning structures 708, 710A, 710B are provided each comprised of the same outer material 712, wherein the opening cushioning structures 710A, 710B are C-shaped and disposed opposed from each other in the unitary composite cushioning structure 690 on each side of the closed cushioning structure 708. FIG. 33C illustrates a unitary composite cushioning structure 690′ that is the same as unitary composite cushioning structure 690 in FIG. 33B, except the cushioning structure 708 is not provided and instead an alternative cushioning structure 714 is provided. FIG. 33D illustrates a unitary composite cushioning structure 690″ that is the same as unitary composite cushioning structure 690 in FIG. 33A, except the cushioning structure 708 is not provided leaving an opening 716.

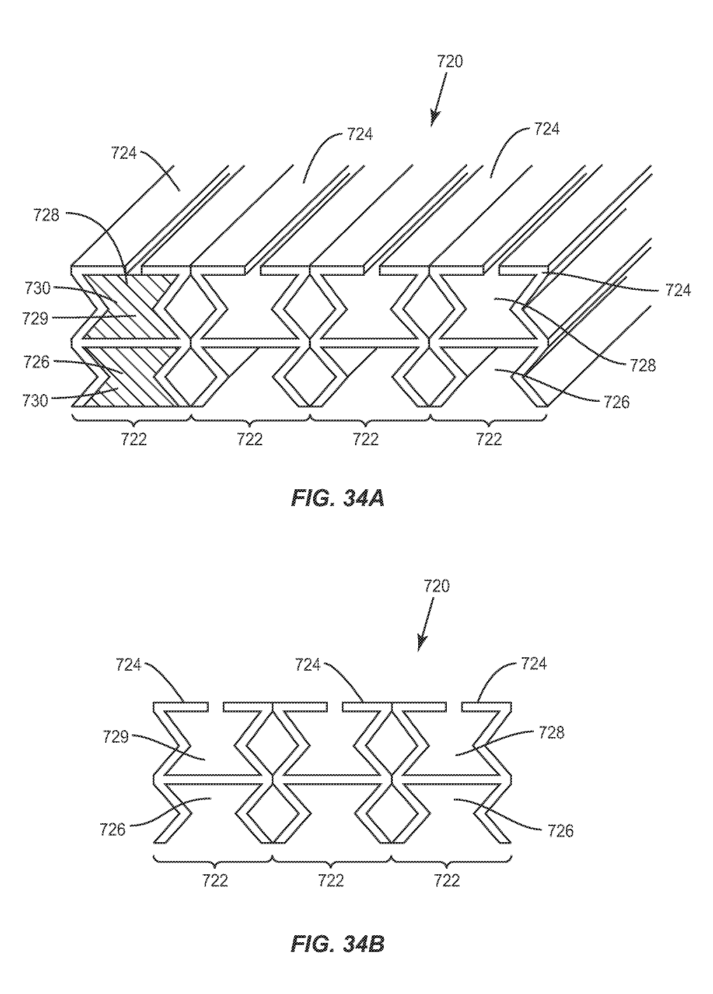

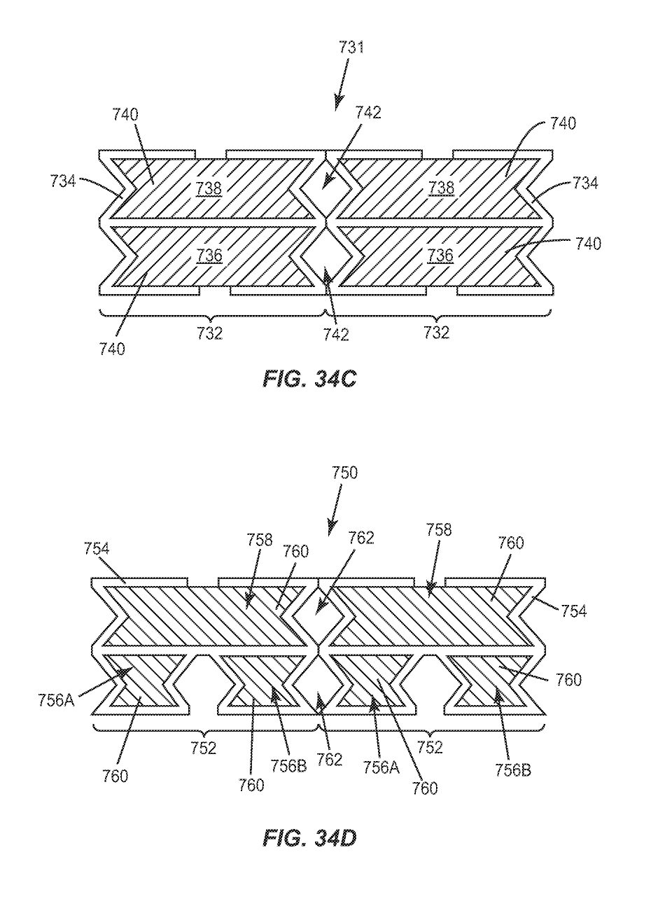

As another example, FIGS. 34A and 34B illustrates a perspective, and side profile of another exemplary unitary composite cushioning structure 720. The unitary composite cushioning structure 720 is comprised of a plurality of unitary cushioning structures 722. The unitary cushioning structures 722 are attached to each other either cohesively or adhesively in a side-by-side arrangement or extruded as one piece, wherein each comprises an outer material 724 with openings 726, 728 disposed therein. A core material 730 may be disposed in either or both of the openings 726, 729 if desired, as shown in one unitary cushioning structure 722 in FIG. 34A. Each unitary cushioning structure 722 may be extruded with the openings 726, 728 present as one piece. The outer material 724 may be comprised of a cellular thermoplastic material and the core material 730 comprised of thermoset material, or vice versa. Alternatively, the core material 730 may not be provided to provide hollow portions disposed within the openings 726, 728.

As another example, FIG. 34C illustrates a side profile of another exemplary unitary composite cushioning structure 731. The unitary composite cushioning structure 731 is comprised of a plurality of unitary cushioning structures 732. The unitary cushioning structures 732 are attached to each other either cohesively or adhesively in a side-by-side arrangement or extruded as one piece, wherein each comprises an outer material 734 with openings 736, 738 disposed therein. A core material 740 may be disposed in either or both of the openings 736, 738 if desired, as shown in FIG. 34C. Each unitary cushioning structure 732 may be extruded with the openings 736, 738 present as one piece. The outer material 734 may be comprised of a cellular thermoplastic material and the core material 740 comprised of thermoset material, or vice versa. Alternatively, the core material 740 may not be provided to provide a hollow portion disposed within the openings 736, 738. Additional 742 openings are formed by the arrangement of the unitary cushioning structures 732 being disposed side-by-side.

As another example, FIG. 34D illustrates a side profile of another exemplary unitary composite cushioning structure 750. The unitary composite cushioning structure 750 is comprised of a plurality of unitary cushioning structures 752. The unitary cushioning structures 752 are attached to each other either cohesively or adhesively in a side-by-side arrangement or extruded as one piece, wherein each comprises an outer material 754 with openings 756A, 756B, 758 disposed therein. A core material 760 may be disposed in either or both of the openings 756A, 756B, 758 if desired, as shown in FIG. 34D. Each unitary cushioning structure 752 may be extruded with the openings 756A, 756B, 758 present as one piece. The outer material 754 may be comprised of a cellular thermoplastic material and the core material 760 comprised of thermoset material, or vice versa. Alternatively, the core material 760 may not be provided to provide a hollow portion disposed within the openings 756A, 756B, 758. Additional 762 openings are formed by the arrangement of the unitary cushioning structures 732 being disposed side-by-side.

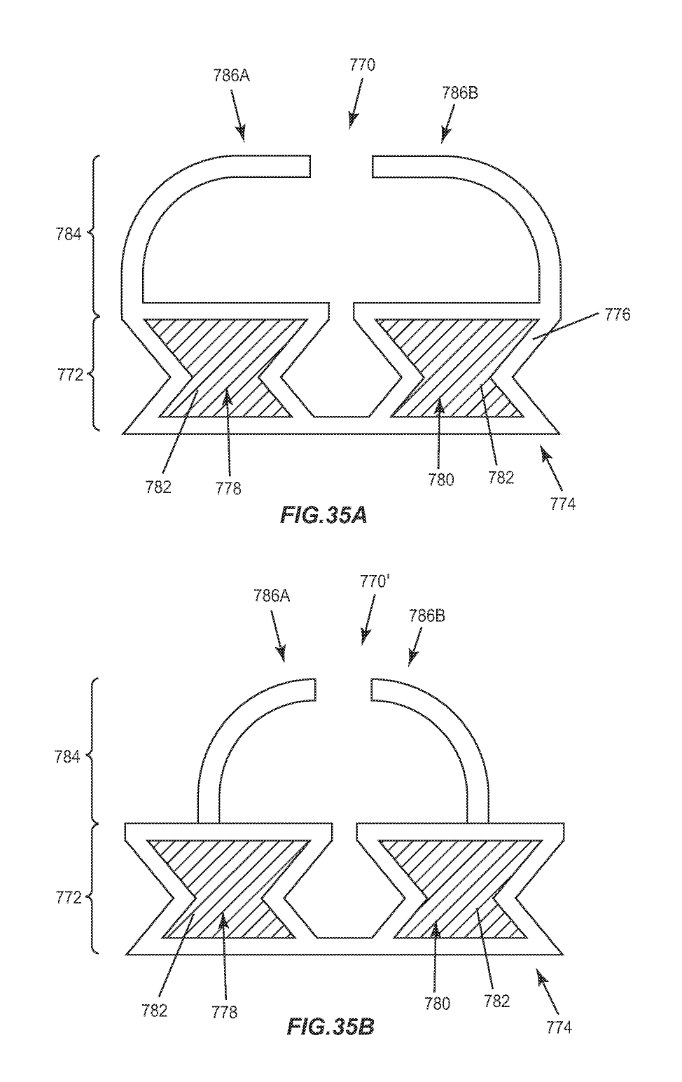

As another example, FIG. 35A illustrates a side profile of another exemplary unitary composite cushioning structure 770. The unitary composite cushioning structure 770 is comprised of a first layer 772 of a closed unitary composite cushioning structure 774 to provide a base cushioning and support structure. The unitary composite cushioning structure 774 comprises an outer material 776 with openings 778, 780 disposed therein. A core material 782 may be disposed in the openings 778, 780 if desired. The outer material 776 may be extruded with the openings 778, 780 present as one piece. The outer material 776 may be comprised of a cellular thermoplastic material and the core material 782 comprised of thermoset material, or vice versa. Alternatively, the core material 782 may not be provided to provide a hollow portion disposed within the outer material 776. With continuing reference to FIG. 35A, a second layer 784 comprised of cushioning structure 786A, 786B are provided, each comprised of the same outer material 776, wherein the opening cushioning structures 786A, 786B are L-shaped and disposed opposed from each other in the unitary composite cushioning structure 770 on each side of the unitary composite cushioning structure 770 as one-piece with the first layer 772. FIG. 35C illustrates a unitary composite cushioning structure 690′ that is the same as unitary composite cushioning structure 690 in FIG. 35A, except the cushioning structures 786A, 786B are moved inward towards the center of the unitary composite cushioning structure 690′ from the unitary composite cushioning structure 690 in FIG. 35A.

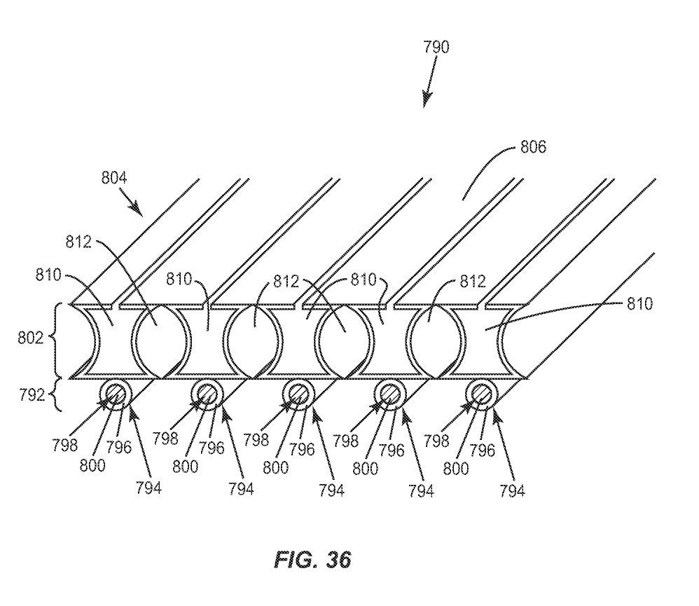

As another example, FIG. 36 illustrates a side profile of another exemplary unitary composite cushioning structure 790. The unitary composite cushioning structure 790 is comprised of a first layer 792 of a closed unitary composite cushioning structures 794 to provide a base cushioning and support structure. The unitary composite cushioning structures 794 comprises an outer material 796 with openings 798 disposed therein. A core material 800 may be disposed in the openings 798 if desired. The outer material 796 may be extruded with the openings 798 present as one piece. The outer material 796 may be comprised of a cellular thermoplastic material and the core material 800 comprised of thermoset material, or vice versa. Alternatively, the core material 800 may not be provided to provide a hollow portion disposed within the outer material 796. With continuing reference to FIG. 36, a second layer 802 comprised of cushioning structure 804 comprised of an outer material 806 and disposed on top of the cushioning structures 794 in the first layer 792. Openings 810, 812 are disposed in the cushioning structure 804. A core material may be disposed in the openings 810, 812, if desired.

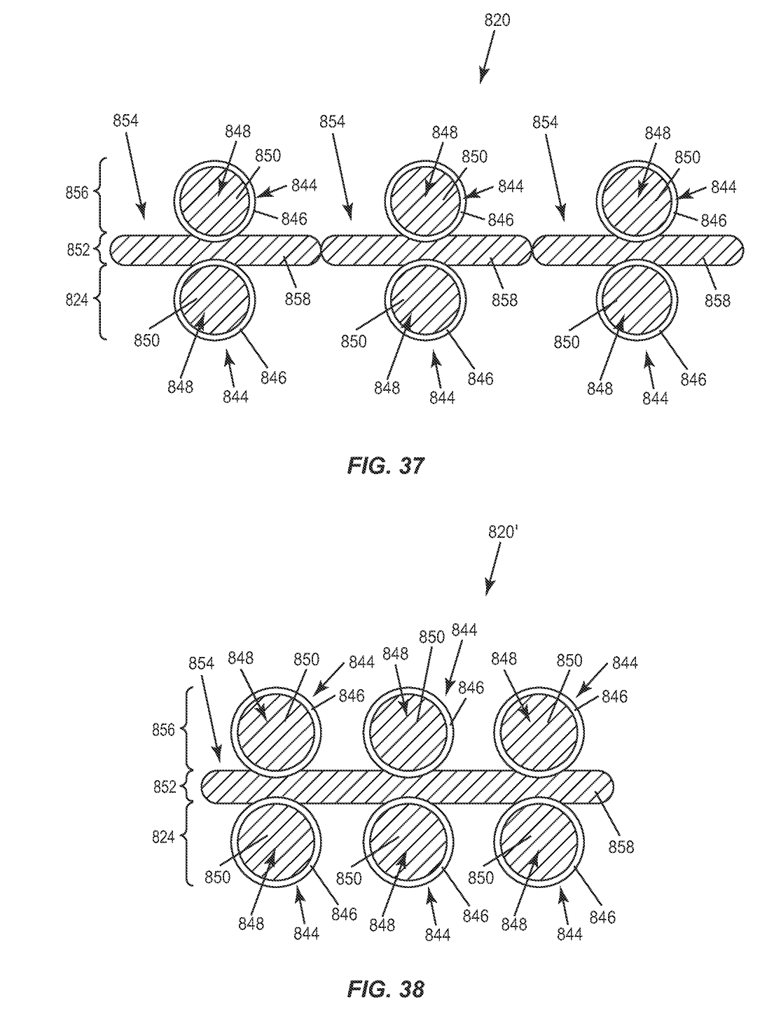

As another example, FIG. 37 illustrates a side profile of another exemplary unitary composite cushioning structure 820. The unitary composite cushioning structure 822 is comprised of a first layer 824 of a closed unitary composite cushioning structures 844 to provide a base cushioning and support structure. The unitary composite cushioning structures 844 comprise an outer material 846 with openings 848 disposed therein. A core material 850 may be disposed in the openings 848 if desired. The outer material 846 may be comprised of a cellular thermoplastic material and the core material 800 comprised of thermoset material, or vice versa. Alternatively, the core material 850 may not be provided to provide a hollow portion disposed within the outer material 846. With continuing reference to FIG. 37, a second layer 852 comprised of cushioning structures 854 disposed between a third layer 856 of the same closed unitary composite cushioning structures 844. The cushioning structures 854 are each comprised of a solid material 858, which may be either a cellular thermoplastic material or thermoset material. FIG. 38 illustrates a side profile of another exemplary unitary composite cushioning structure 820′ that is the same as the unitary composite cushioning structure 820 in FIG. 37, except that the cushioning structure 854 is provided as a single piece of material and not separately cushioning structures.

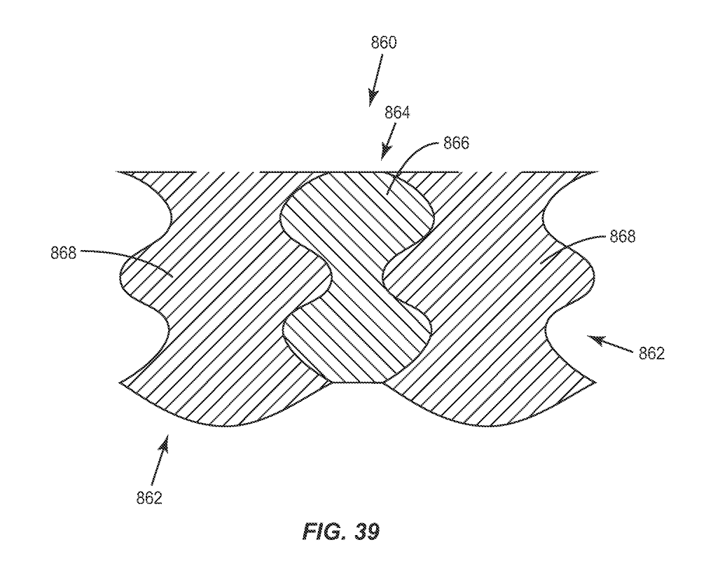

As another example, FIG. 39 illustrates a side profile of another exemplary unitary composite cushioning structure 860. The unitary composite cushioning structure 860 is comprised of a plurality of unitary cushioning structures 862. The unitary cushioning structures 862 are arranged in a side-by-side arrangement such that an opening 864 is created therebetween. A core material 866 may be disposed in opening 864. Each unitary cushioning structure 862 may be extruded. A material 868 used to form the plurality of unitary cushioning structures 862 may be comprised of a cellular thermoplastic material and the core material 866 comprised of thermoset material, or vice versa.

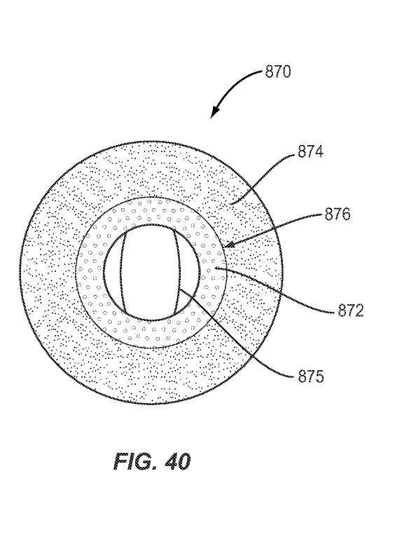

In another embodiment, FIG. 40 illustrates an exemplary embodiment of a unitary composite cushioning structure 870 comprised of one or more thermoplastic closed and/or open cell foam 872 embedded in and/or substantially surrounded by a closed and/or open cell thermoset foam 874. The unitary composite cushioning structure 870 may be used as a cushion structure. As illustrated therein, the thermoplastic foam 872 is provided as an engineered cylindrically-shaped cellular thermoplastic foam profile 876 geometrically designed in a vertical profile. The cellular thermoplastic foam profile 876 provides a controlled deformation support characteristic and stability to the unitary composite cushioning structure 870. To form the unitary composite cushioning structure 870, the cellular thermoplastic foam profile 876 is surrounded by the thermoset foam 874, which in this example is a foamed latex rubber. The thermoset foam 874 may be elastomeric. The foamed latex rubber as the thermoset foam 874 may be manufactured from an emulsion of latex rubber as one possible example. An inner cylindrical chamber 875 is left in the cellular thermoplastic foam profile 876, which can either be left void or a thermoset material (not shown), such as foamed latex rubber for example, poured inside the inner cylindrical chamber 875 to provide additional offset of compression.

A curing process can be performed on the unitary composite cushioning structure 870 to set and cohesively or adhesively bond the thermoplastic foam 872 and the thermoset foam 874 to each other. The thermoset foam 874 is not chemically bonded to the thermoplastic foam 872 in this embodiment, but chemical bonding can be provided. Further, a chemical bonding agent can be mixed in with a thermoplastic material before or during the foaming process to produce the thermoplastic foam 872, or when the thermoset foam 874 is poured into the inner cylindrical chamber 875 to provide a chemical bond with the thermoset foam 874 during the curing process.

The unitary composite cushioning structure 870 has a geometry that can be used in a vertical position relative to an overall structure providing individual spring qualities to an otherwise unitary or monolithic structure that is both stable due to the thermoplastic foam 872 and exhibits excellent offset of compression set due to the thermoset foam 874. For example, the unitary composite cushioning structure 870 may be used like a spring and in place of metal or other types of springs or coils. Further, a thermoplastic foam may be provided to encapsulate the thermoset foam 874 to provide additional support to the unitary composite cushioning structure 870.

For example, the unitary composite cushioning structure 870 may be used as a foam spring for use in a knock down or buildable mattress. Also, this unitary composite cushioning structure 870 can be used to add support into specific regions of a cushion structure to satisfy individual demands, such as lumbar and/or head and foot support as examples, depending on the type of cushion structure used while providing the tactile cushioning characteristic desired. The thermoset foam 874 has cushioning abilities and can be soft or firm depending on formulations and density, but without individualized resilient support zones as can be obtained from using the engineered geometrically supportive profiles of the thermoplastic foam 872. This engagement of the thermoplastic foam 872 and the thermoset foam 874 has the ability to recover over long periods of repeated deformations.

In this unitary composite cushioning structure 870, the thermoplastic foam 872 could be a foamed polymer from including, but not limited to polyethylene, an EVA, a TPO, a TPV, a PVC, a chlorinated polyethylene, a styrene block copolymer, an EMA, an ethylene butyl acrylate (EBA), and the like, as examples. These thermoplastic materials may also be inherently resistant to microbes and bacteria, making them desirable for use in the application of cushioning structures. These materials can be also made biodegradable and fire retardant through the use of additive master batches. The thermoplastic could be foamed to an approximate cell size of 0.25 to 2.0 mm, although such is not required or limiting to the scope of the embodiments disclosed herein.

The thermoset foam 874 in this example is foamed latex rubber and is hypo-allergenic, and breathes to keep you warm in the winter and cool in the summer. Further, bacteria, mildew, and mold cannot live in the foamed latex rubber. The thermoset foam 874 is generally obtained in emulsified form and is frothed to introduce air into the emulsion to reduce density, and is then cured (vulcanized) to remove additional waters and volatiles as well as to set the material to its final configuration. Latex, however, may only be possible to be foamed (density reduction) down to a 5 lb. or 80 kg/m³ range without sacrificing other desirable features, such as tear and tensile strength. However, when engineered with the inner foam, which can be foamed to densities down to 1 lb. and/or 16 kg/m³ effectively, the inner foam is used in combination with the foamed latex rubber and can displace the heavier weight of the foamed latex rubber. The foamed latex rubber can also be further cost reduced through the addition of fillers such as ground foam reclaim materials, nano clays, carbon nano tubes, calcium carbonate, flyash and the like, but also corc dust as this material can provide for increased stability to the thermoset material to while reducing the overall density, weight, and /or cost of the thermoset material.

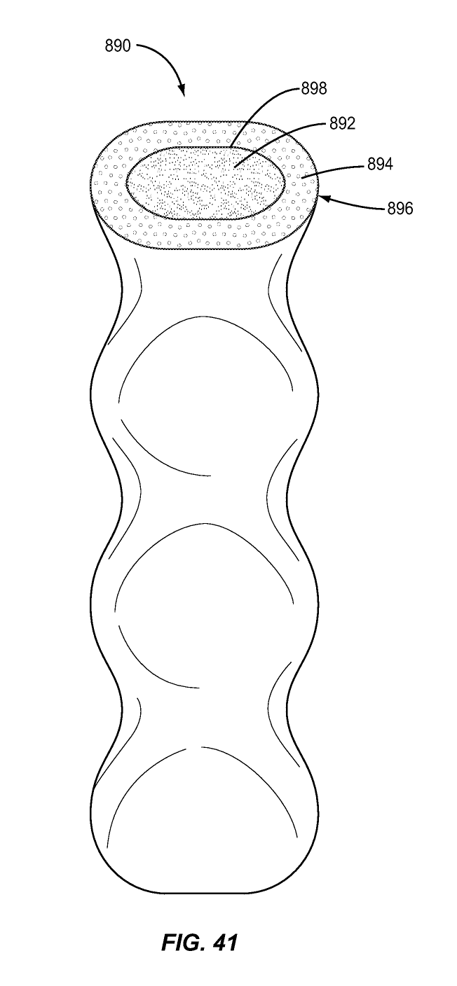

In another embodiment, as illustrated in FIG. 41, another unitary composite cushioning structure 890 may be manufactured. In this embodiment, the unitary composite cushioning structure 890 also has a vertical geometric profile similar to the unitary composite cushioning structure 870 of FIG. 40. This allows for controlled deformation relative to the unitary composite cushioning structure 890 providing individual spring qualities to an otherwise monolithic structure. However, in this embodiment, an inner thermoset foam 892 is provided and geometrically designed in a vertical profile surrounded by an outer thermoplastic foam 894 provided in a cellular thermoplastic foam profile 896. A stratum 898 is disposed therebetween wherein the outer thermoplastic foam 894 is cohesively or adhesively bonded to the inner thermoset foam 892.

The inner thermoset foam 892 may be manufactured from an emulsion of latex rubber as an example. The unitary composite cushioning structure 890 has a geometry that can be used in a vertical position relative to an overall structure providing individual spring qualities to an otherwise monolithic structure. For example, the unitary composite cushioning structure 890 may be used like a spring and in place of metal or other types of springs. For example, one aspect would be the use of the unitary composite cushioning structure 890 as a pocketed coil assembly for a mattress or other application in a similar fashion to the current metal coil spring variety and covered with the appropriate cloth structure in similar fashion to the metal coil spring design. The materials and application possibilities discussed for the unitary composite cushioning structure 870 of FIG. 40 are also possible for the unitary composite cushioning structure 890 of FIG. 41 and thus will not be repeated here.

In the unitary composite cushioning structure 890 of FIG. 41, the outer thermoplastic foam 894 can be hypo-allergenic, and breathes to retain heat in the winter and to release heat in the summer. The inner thermoset foam 892 can be obtained in emulsified form and is frothed to introduce air into the emulsion to reduce density, and is then cured (vulcanized) to remove additional waters and volatiles as well as to set the material to its final configuration. The other possibilities discussed for the thermoset foams discussed above are also possible for the inner thermoset foam 892 of FIG. 41 and thus will not be repeated here.

The inner thermoset foam 892 could be a foamed polymer from a polyethylene, an EVA, a TPO, a TPV, a PVC, a chlorinated polyethylene, a styrene block copolymer, an EMA, an ethylene butyl acrylate (EBA), and the like, as examples, or any of the other recited thermoplastics previously discussed. These thermoplastic materials may also be inherently resistant to microbes and bacteria, making them desirable for use in the application of cushioning structures. These materials can be also made biodegradable and fire retardant through the use of additive master batches. The thermoplastic could be foamed to an approximate cell size of 0.25 to 2.0 mm, although such is not required or limiting to the scope of the embodiments disclosed herein. These foam springs of thermoplastic open or closed cell foam can be interspersed at some frequency throughout the cushion structure. The foam springs may be formed as an array. Further, a thermoset material, including but not limited to latex rubber, may also be provided to encapsulate the cellular thermoplastic foam profile 896 of the unitary composite cushioning structure 890 to provide additional offset of compression.

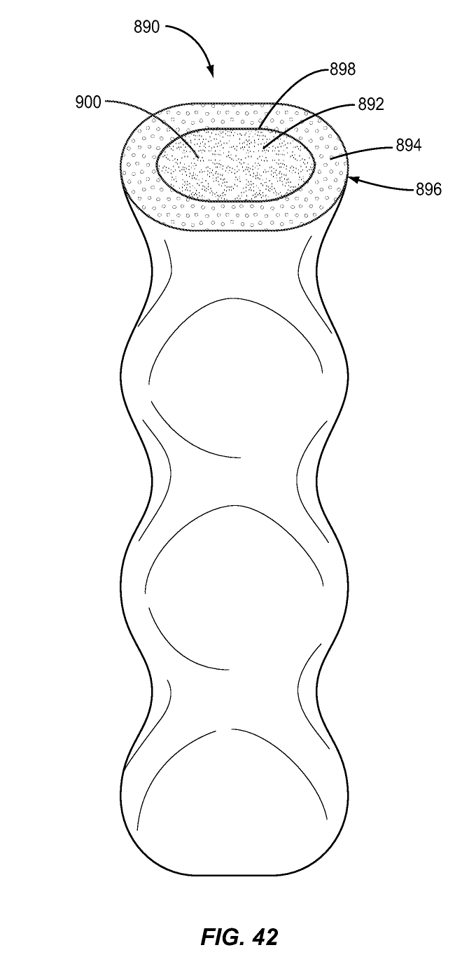

FIG. 42 illustrates the unitary composite cushioning structure 890 of FIG. 41, but the inner thermoset foam 892 additionally includes a filler material, which in this example is corc dust 900. The corc dust 900 adds stability to the inner thermoset foam 892 without changing the cushioning characteristics and benefits of the thermoplastic material and reduces weight of the unitary composite cushioning structure 890. For example, the amount of corc dust 900 added per unit of latex rubber may be 25% to 75%, although this range is only exemplary and is not limiting to the scope of the embodiments disclosed herein.

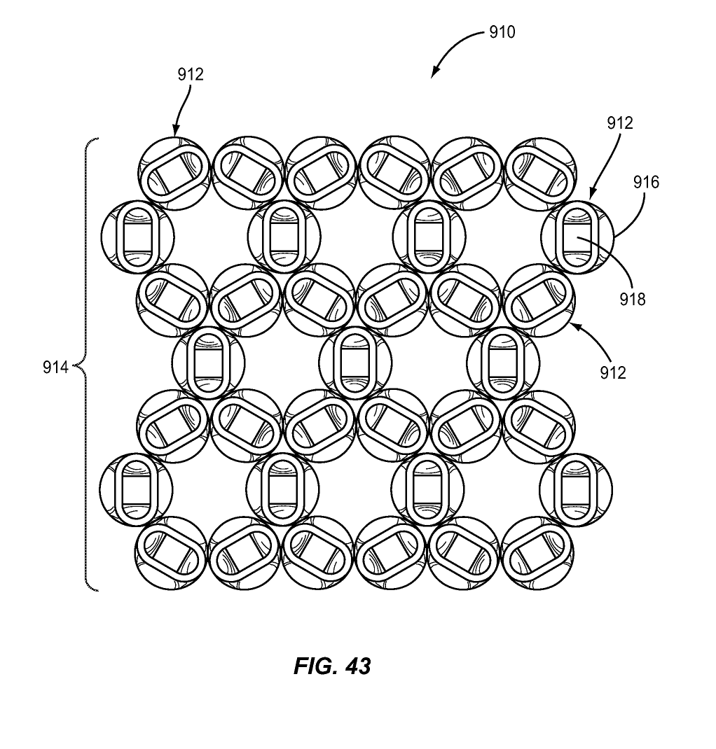

FIG. 43 illustrates yet another embodiment of a structure 910 that can be used to form one or more unitary composite cushioning structures 912, including according to any of the embodiments disclosed herein. In this embodiment, a plurality of unitary composite cushioning structures 912 is provided in an array 914. Each unitary composite cushioning structure 912 is comprised of an outer foam piece 916 comprised of a foamed thermoplastic material. The outer foam pieces 916 have internal chambers 918 that can be filled with a thermoset material. Further, corc dust or other filler may be added to the thermoset material poured inside the internal chambers 918 of the outer foam pieces 916 to provide the unitary composite cushioning structure 912. The outer foam pieces 916 can also be encapsulated either internally, externally, or both with a cellular thermoset foam or other thermoset material.

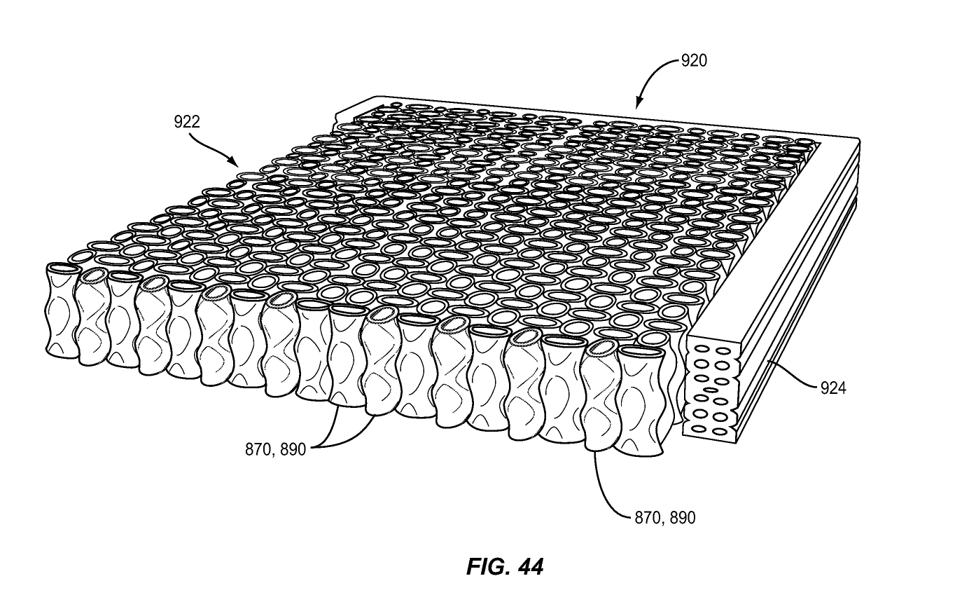

FIG. 44 illustrates yet another embodiment of a mattress assembly 920 that can incorporate the unitary composite cushioning structures like the unitary composite cushioning structures 870 or 890 previously described above. In this embodiment, the unitary composite cushioning structures 870 or 890 are used to replace traditional coils or springs in an innerspring 922 as part of the mattress assembly 920. The unitary composite cushioning structures 870 or 890 are disposed inside and adjacent edge or side support profiles 924. The edge or side support profiles 924 may also be provided as a unitary composite cushioning structure according to any of the embodiments described herein and may also be encapsulated either internally, externally, or both with a thermoset material or foam. The edge or side support profiles 924 may provide an anti-roll off feature on a mattress or other bedding, as illustrated in the example in FIG. 44.

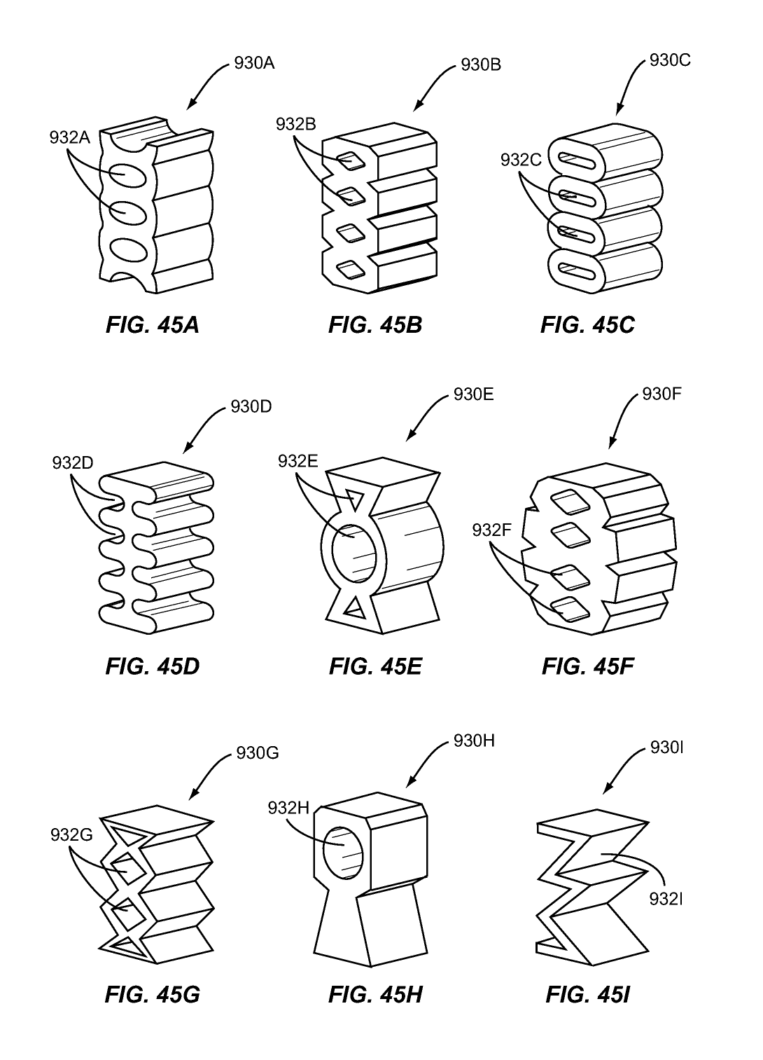

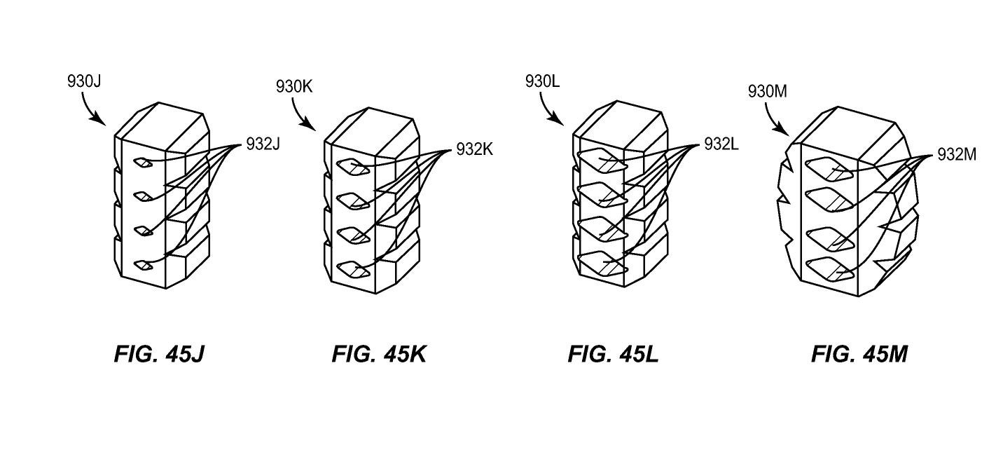

Other examples for the thermoplastic foam profiles that may be provided according to any of the embodiments disclosed herein for providing a unitary composite cushioning structure are illustrated in FIG. 45. As illustrated therein, thermoplastic foam profiles 930A-930M may be constructed out of a thermoplastic material including a foam. The thermoplastic foam profiles 930A-930M may have one or more chambers 932A-932M, which may be open or closed and which can either be left void or filled with a thermoset material to provide a unitary composite cushioning structure. The thermoplastic foam profiles 930A-930M can also be encapsulated with a thermoset material in addition to or in lieu of being filled with a thermoset material as part of a composite structure. All other possibilities for thermoplastic foam profiles, thermoset materials, and unitary composite cushioning structures discussed above are also possible for the thermoplastic foam profiles 930A-930M in FIG. 45.

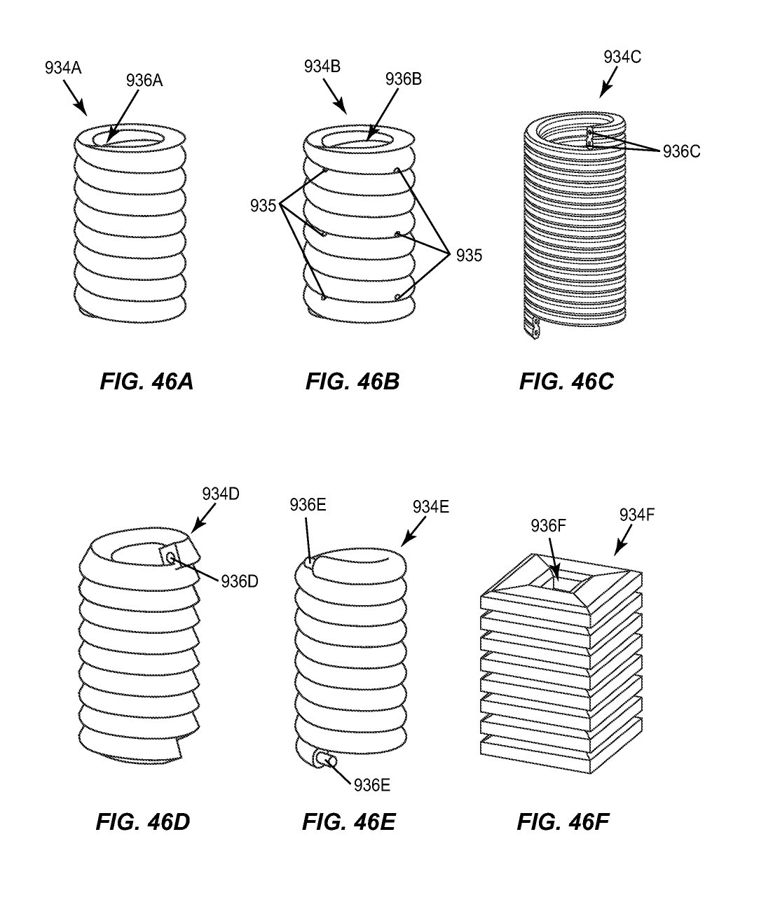

Other examples for the thermoplastic foam profiles that may be provided according to any of the embodiments disclosed herein for providing a unitary composite cushioning structure are illustrated in FIGS. 46A-46F. As illustrated therein, thermoplastic foam profiles 934A-934F may be constructed out of a thermoplastic material including a foam. The thermoplastic foam profiles 934A-934F may have one or more chambers 936A-936F, which may be open or closed and which can either be left void or filled with a thermoset material to provide a unitary composite cushioning structure. The thermoplastic foam profiles 934A-934F can also be encapsulated with a thermoset material in addition to or in lieu of being filled with a thermoset material as part of a composite structure. All other possibilities for thermoplastic foam profiles, thermoset materials, and unitary composite cushioning structures discussed above are also possible for the thermoplastic foam profiles 934A-934F in FIG. 45. In FIG. 46B, the thermoplastic foam profile 934B contains vent holes 935 that allow for a thermoset material to be disposed in the chamber 936B and air escape from inside the chamber 936B. In FIG. 46C, the thermoplastic foam profile 934C provides two internal chambers 936C for dispose a thermoset material. In FIG. 46E, The thermoplastic foam profile 934E contains a high density thermoset core 936C in one embodiment that may be co-extruded with a low density thermoset material exterior.

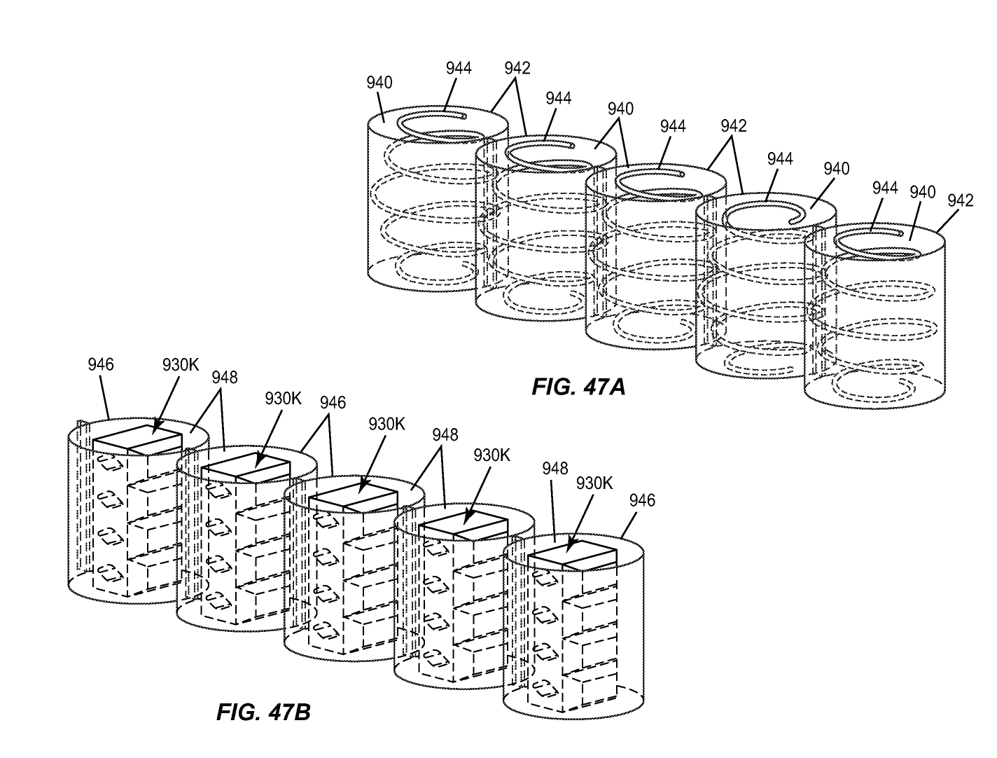

FIG. 47A illustrates examples of foam springs 940 that may be according to any of the embodiments disclosed herein for providing a unitary composite cushioning structure. In this example, an outer material 942 is disposed around a spring 944, which may for example be a metal spring. The outer material 942 may be a cellular thermoplastic material and the spring 944 made from a thermoset material, or vice versa. FIG. 47B illustrates other examples of foam springs 946 that may be according to any of the embodiments disclosed herein for providing a unitary composite cushioning structure. In this example, an outer material 948 is disposed around the foam spring 930K previously illustrated in FIG. 45K. The outer material 948 may be a cellular thermoplastic material and the foam spring 930K made from a thermoset material, or vice versa. Also, the outer material 948 may be disposed inside the openings 932K disposed in the foam spring 930K.

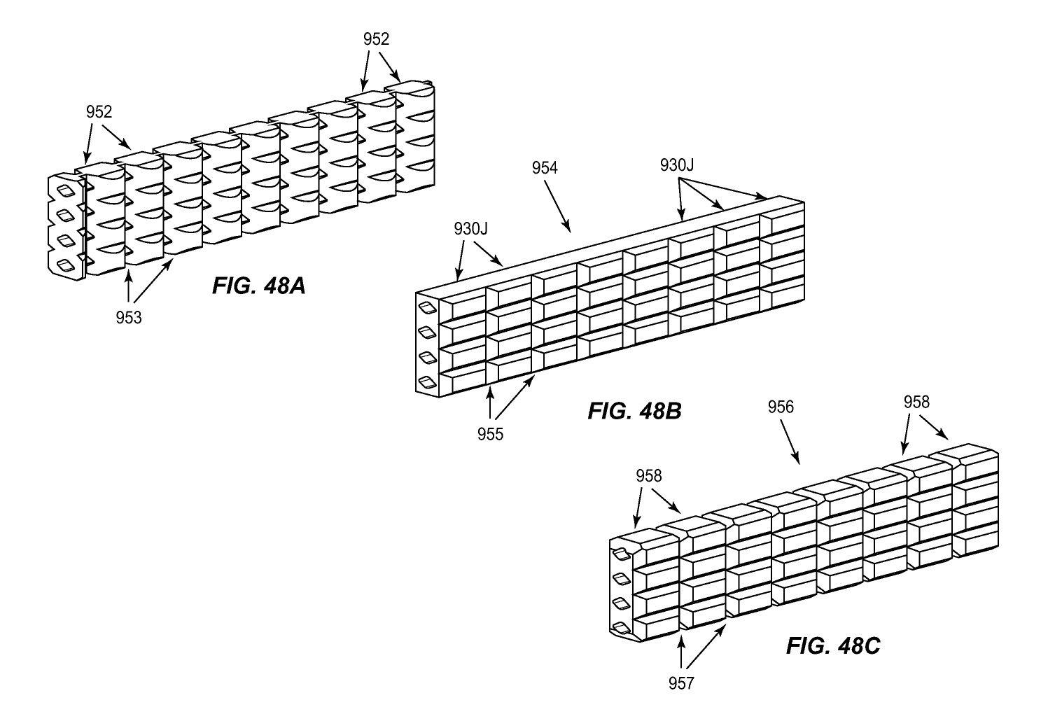

FIG. 48A illustrates an example of a foam spring arrangement 950 comprised of a plurality of foam springs 952 arranged in an array that may be according to any of the embodiments disclosed herein for providing a unitary composite cushioning structure. Side cuts 953 may be disposed between adjacent foam springs 952 to further control cushioning and support characteristics. FIG. 48B illustrates another example of a foam spring arrangement 954 comprised of a plurality of the foam springs 930J arranged in an array that may be according to any of the embodiments disclosed herein for providing a unitary composite cushioning structure. Side cuts 955 may be disposed between adjacent foam springs 952 to further control cushioning and support characteristics. FIG. 48C illustrates another example of a foam spring arrangement 956 comprised of a plurality of foam springs 958 arranged in an array that may be according to any of the embodiments disclosed herein for providing a unitary composite cushioning structure. Side cuts 957 may be disposed between adjacent foam springs 958 to further control cushioning and support characteristics.

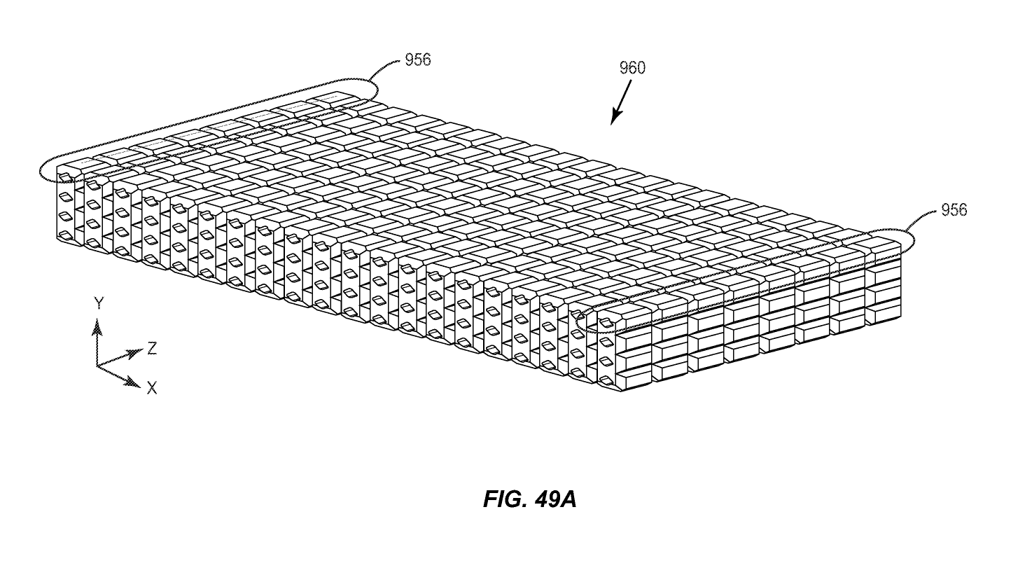

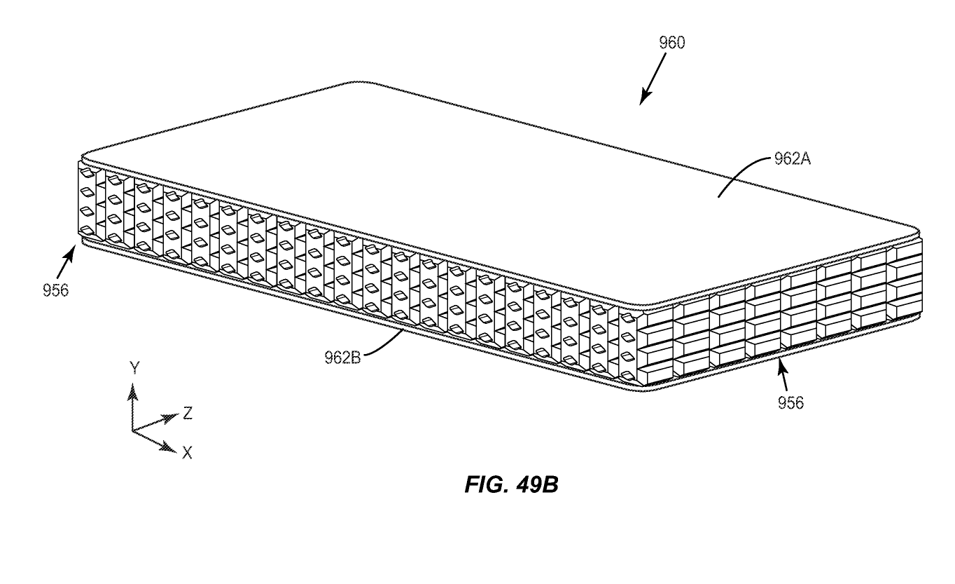

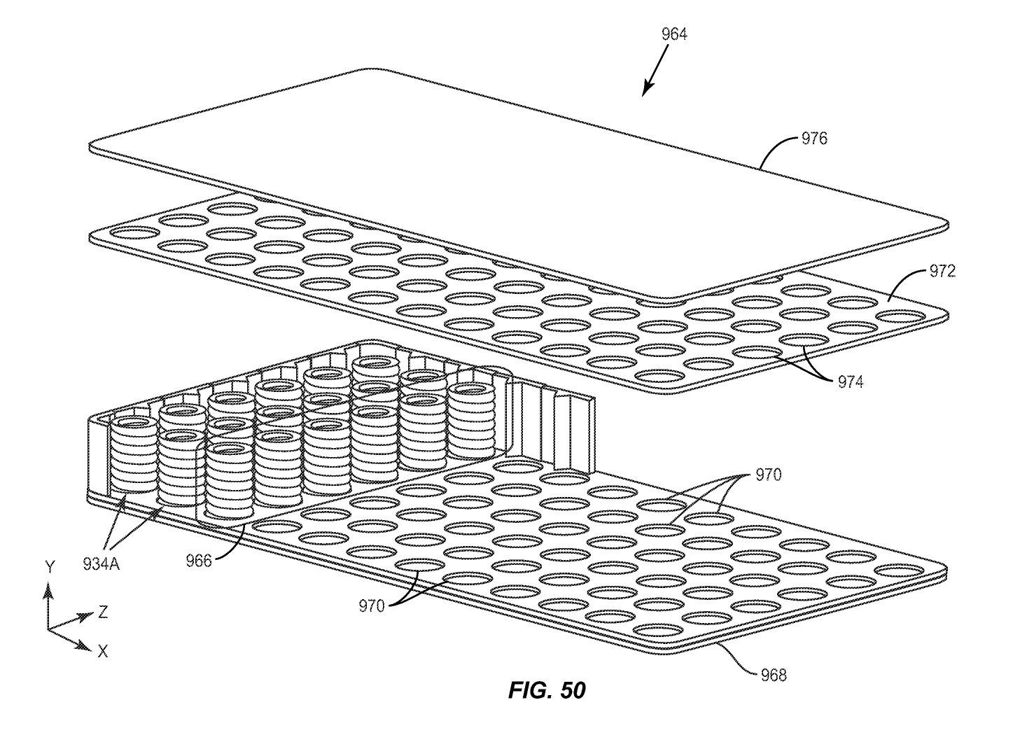

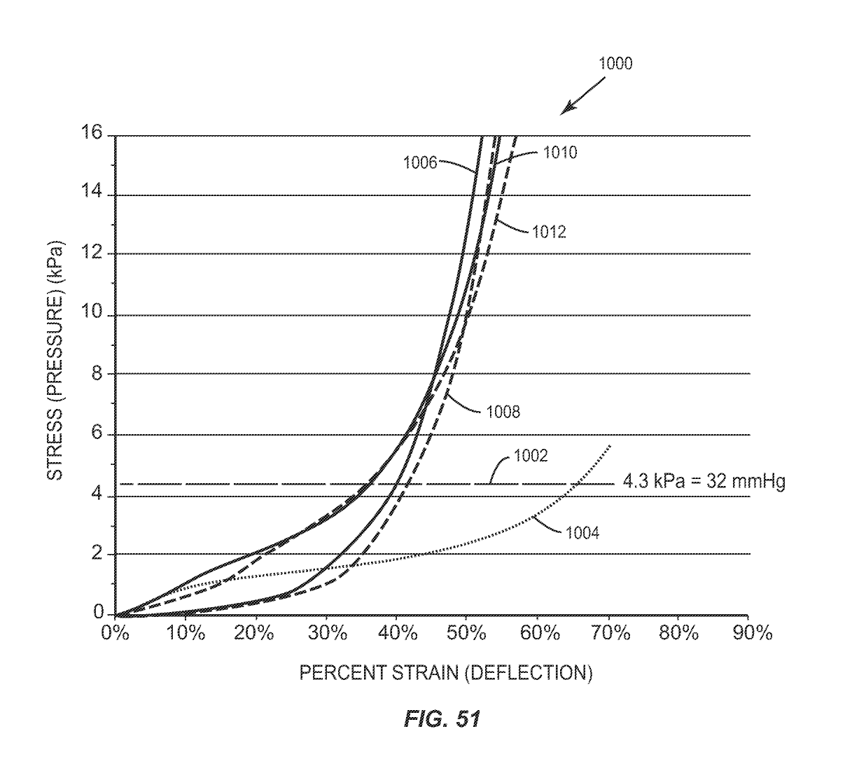

As previously discussed, the unitary composite cushioning structures can be employed to provide bedding or seating arrangements or assemblies. In this regard, FIG. 49A illustrates a plurality of the foam spring arrangements 956 that arranged side-by-side to provide a mattress assembly 960. FIG. 49B illustrates the mattress assembly 960 in FIG. 49A, but with mattress assembly covers 962A, 962B disposed on the top and bottom of the foam spring arrangements 956 to further complete the mattress assembly 960. FIG. 50 illustrates another embodiment of a mattress assembly 964 that may be provided using foam springs that are unitary composite cushioning structures according to any of the embodiments disclosed herein. In this example, the mattress assembly 964 is formed from foam spring arrangements 966 that are comprised of the foam springs 934A illustrated in FIG. 46. A base 968 is provided that contains a matrix of openings 970 configured to support the outer diameter of the foam springs 934A to retain the foam springs 934A in designated areas. A top 972 is also provided that contains a similar matrix of openings 974 to retain the top portions of the foam springs 934A in the mattress assembly 964. Lastly, a cover portion 976 can be disposed on top of the top 972 to close off access to the foam springs 934A and/or limit the movement of the foam springs 934A and/or to spread loads onto the foam springs 934A.

Each of the unitary composite cushioning structure profiles discussed above will have a certain strain (i.e., deflection) for a given stress (i.e., pressure) characteristic based on the composite composition and its geometry. One goal may be to determine if the strain vs. stress characteristic for a given unitary composite cushioning structure profiles is representative of a baseline or target strain vs. stress characteristic when determining the likability or feasibility of a given unitary composite cushioning structure profiles for cushioning applications, including but not limited to bedding and seating applications. For example, FIG. 51 illustrates a graph 1000 illustrating stress for a given strain for various unitary composite cushioning structure previously described above with regarding to a pressure limit 1002. In this example, the pressure limit 1002 is the theoretical pressure that should not be exceeded in order to provide comfort as perceived to an average person. In this example, the pressure limit is 4.3 kilo Pascals (kPa) of pressure or 32 mm Hg, which is theorized as the maximum pressure limit before blood vessels and capillaries in a human start to become restricted. Thus, it is desired to provide a cushioning structure that provides less pressure for a given stress that the pressure limit 1002. In this example, a characteristic curve 1004 is shown for pure polyurethane.

As can been seen in chart 1000 in FIG. 51, the pressure in the characteristic curve 1104 does not exceed the pressure limit 1002 until a percentage strain beyond approximately 65% is reached. Characteristic curves 1006, 1008 are for the unitary composite cushioning profiles exemplary unitary composite cushioning structure 68 with integrated base in FIG. 5 without the thermoset material 74 included. Characteristic curves 1010, 1012 are for the unitary composite cushioning profiles exemplary unitary composite cushioning structure 68 with integrated base 82 in FIG. 5 that includes the thermoset material 74. As can be seen, the unitary composite cushioning structure 68 with integrated base 82 exceeds the pressure limit 1002 at a much less strain percentage than the pure polyurethane (as shown by characteristic curve 1004). One goal may be to provide a unitary composite cushioning structure that has a stress vs. strain characteristic curve that is similar to polyurethane or viscoelastic, but in a less density form by use of a thermoplastic material, which may also result in less cost.

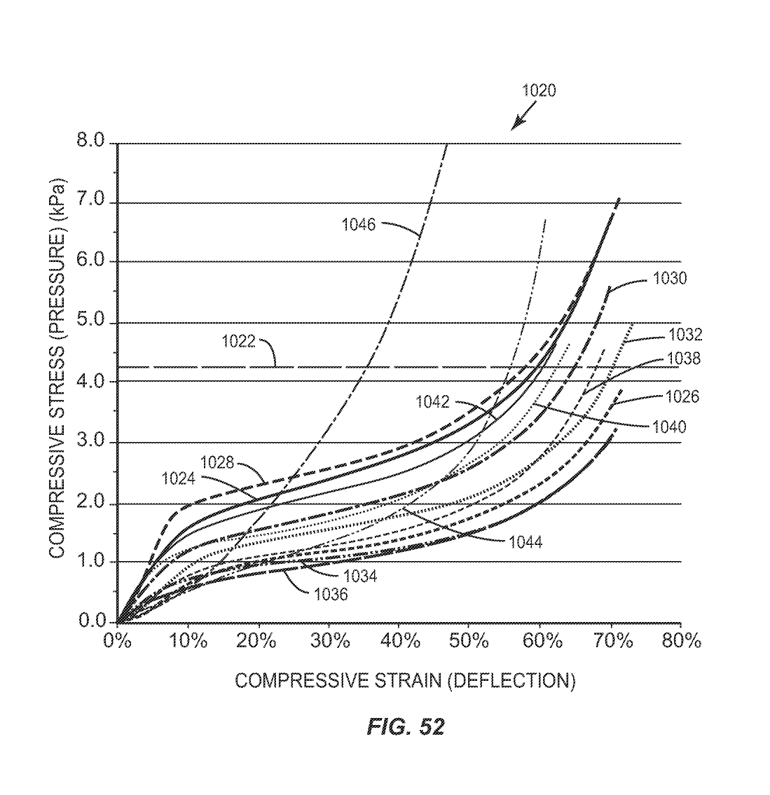

In this regard, FIG. 52 illustrates a graph 1020 illustrating stress for a given strain for various unitary composite cushioning structure previously described above with regarding to a baseline characteristic curve 1022. In this example, the pressure limit 1102 is the theoretical pressure that should not be exceeded in order to provide comfort as perceived to an average person. In this example, characteristic curves 1024, 1026, 1028, 1030, 1032, 1034, 1036 are for different variations of polyurethane foam. Characteristic curves 1038 and 1040 are for two density variations of viscoelastic material. Characteristic curve 1042 is for latex. Characteristic curves 1044, 1046 are for unitary composite cushioning structures. As can be seen, the characteristic curve 1044 is closer to the characteristic curves 1024-1040 in terms of not exceeding the pressure limit 1022 until a greater percentage of strain is reached.

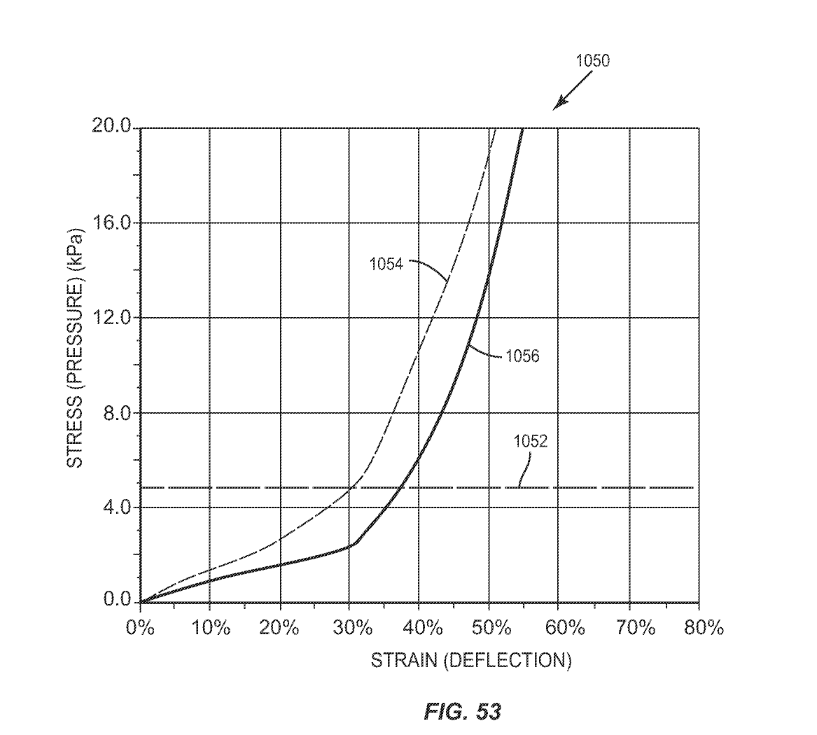

As another example, FIG. 53 illustrates a graph 1050 illustrating stress for a given strain for various unitary composite cushioning structure previously described above with regarding to a baseline characteristic curve 1052. In this example, the pressure limit 1052 is the theoretical pressure that should not be exceeded in order to provide comfort as perceived to an average person. In this example, characteristic curves 1054, 1056 are for unitary composite cushioning structures.

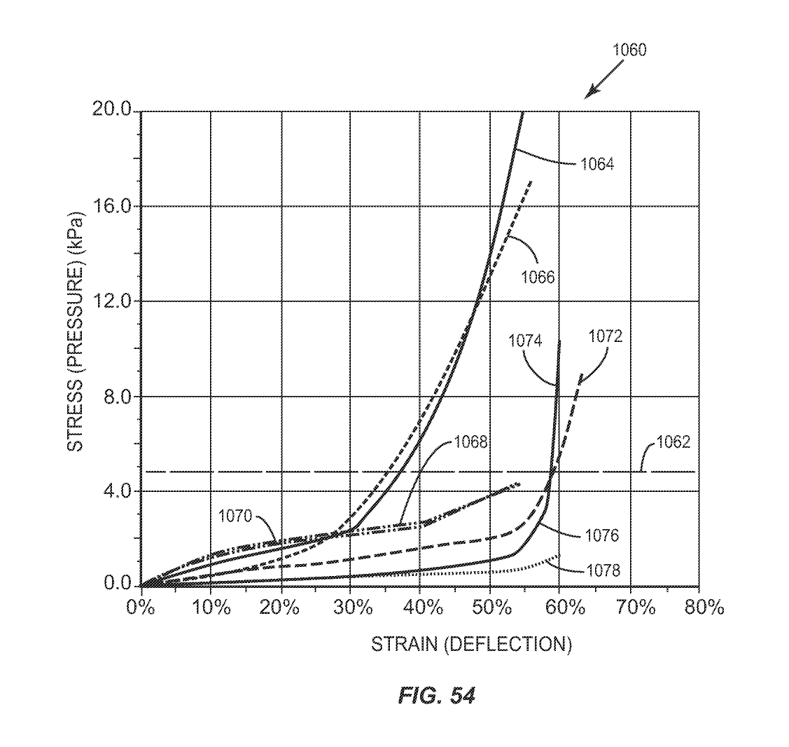

As another example, FIG. 54 illustrates a graph 1060 illustrating stress for a given strain for various unitary composite cushioning structure previously described above with regarding to a baseline characteristic curve 1062. In this example, the pressure limit 1062 is the theoretical pressure that should not be exceeded in order to provide comfort as perceived to an average person. In this example, characteristic curves 1064, 1066, 1068, 1070, 1072, 1074, 1076, 1078 are for unitary composite cushioning structures.

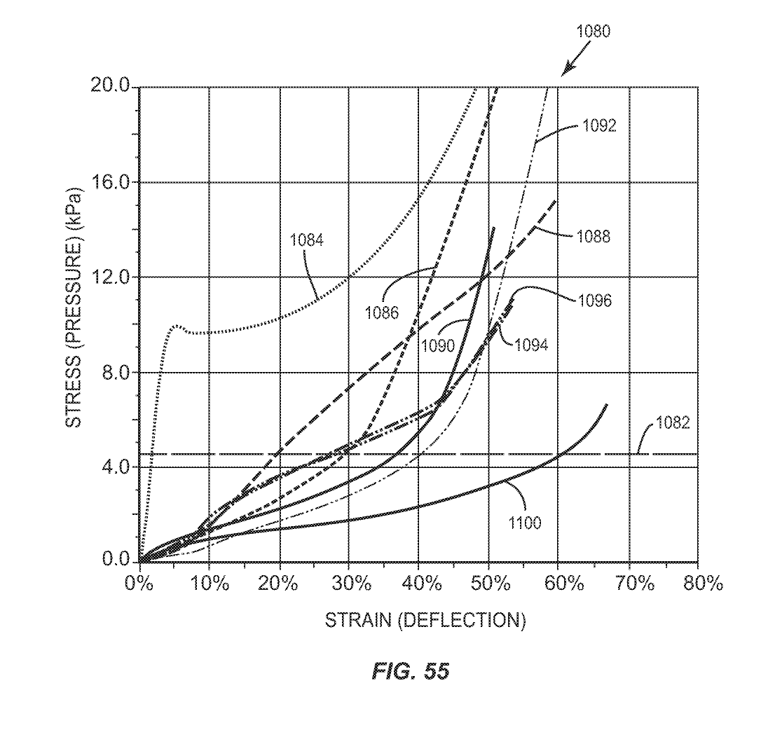

As another example, FIG. 55 illustrates a graph 1080 illustrating stress for a given strain for various unitary composite cushioning structure previously described above with regarding to a baseline characteristic curve 1082. In this example, the pressure limit 1082 is the theoretical pressure that should not be exceeded in order to provide comfort as perceived to an average person. In this example, characteristic curves 1084, 1086, 1088, 1090, 1092, 1094, 1096, 1100 are for unitary composite cushioning structures.

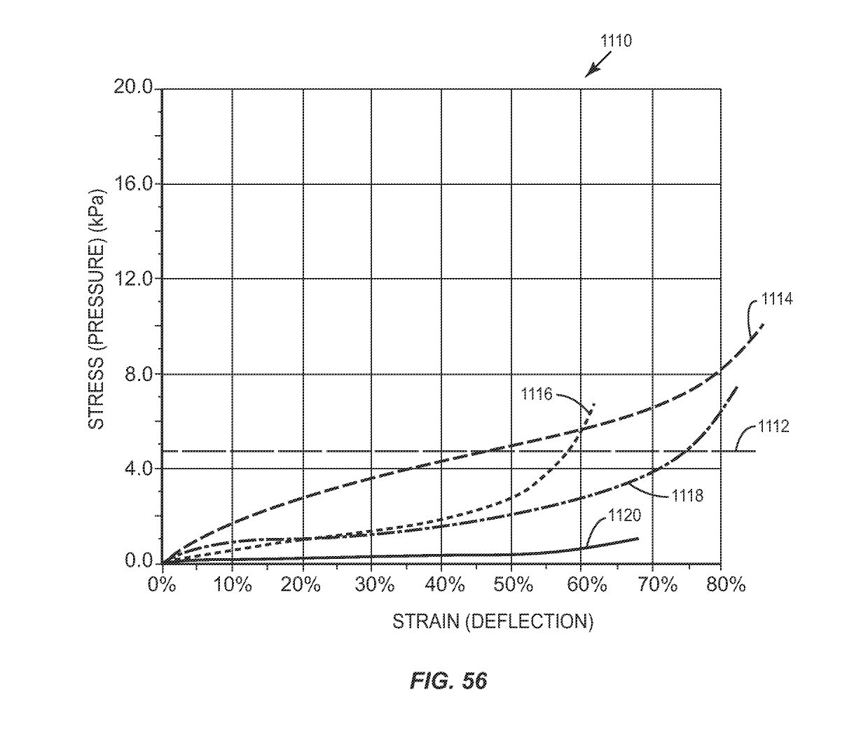

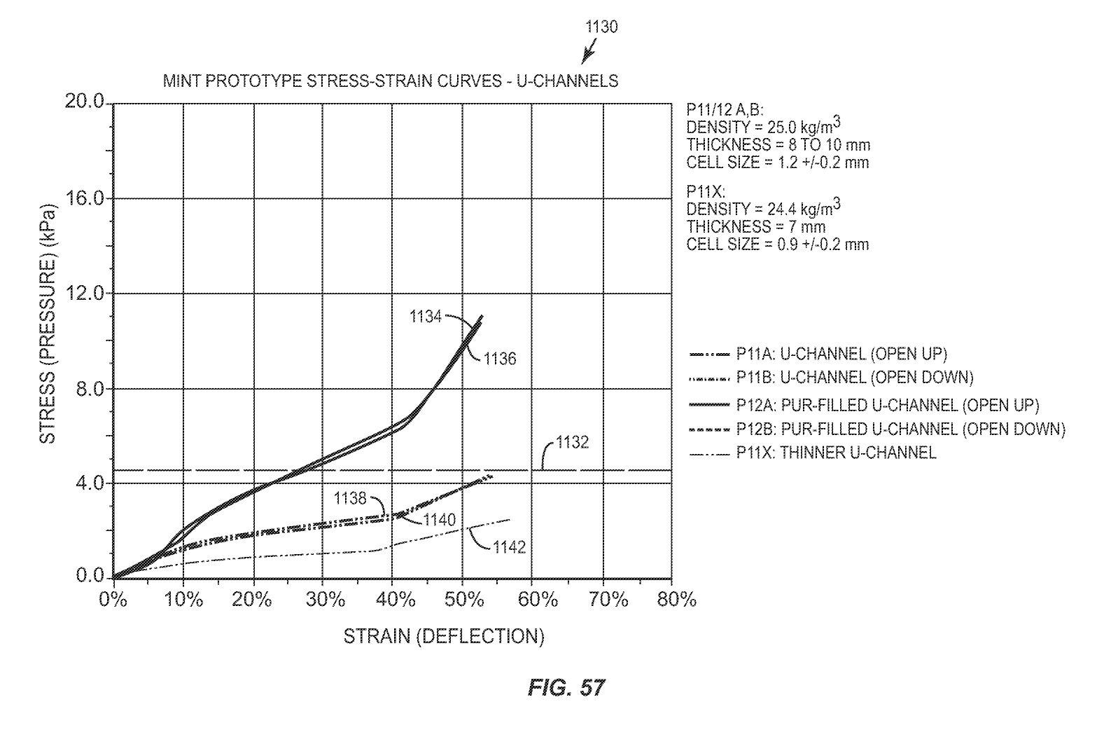

As another example, FIG. 56 illustrates a graph 1110 illustrating stress for a given strain for various unitary composite cushioning structure previously described above with regarding to a baseline characteristic curve 1112. In this example, the pressure limit 1112 is the theoretical pressure that should not be exceeded in order to provide comfort as perceived to an average person. In this example, characteristic curves 1114, 1116, 1118, 1120 are for unitary composite cushioning structures.

As another example, FIG. 57 illustrates a graph 1130 illustrating stress for a given strain for various unitary composite cushioning structure previously described above with regarding to a baseline characteristic curve 1132. In this example, the pressure limit 1132 is the theoretical pressure that should not be exceeded in order to provide comfort as perceived to an average person. In this example, characteristic curves 1134, 1136, 1138, 1140, 1142 are for unitary composite cushioning structures. The characteristic curves 1138, 1140, and 1142 represent a density of 25.0 kg/m3, thickness of 8 to 10 mm, and foam cell size of 1.2 mm, +−0.2 mm. The characteristic curves 1134, 1136 represent a density of 24.4 kg/m3, thickness of 7 mm, and foam cell size of 0.9 mm, +−0.2 mm.

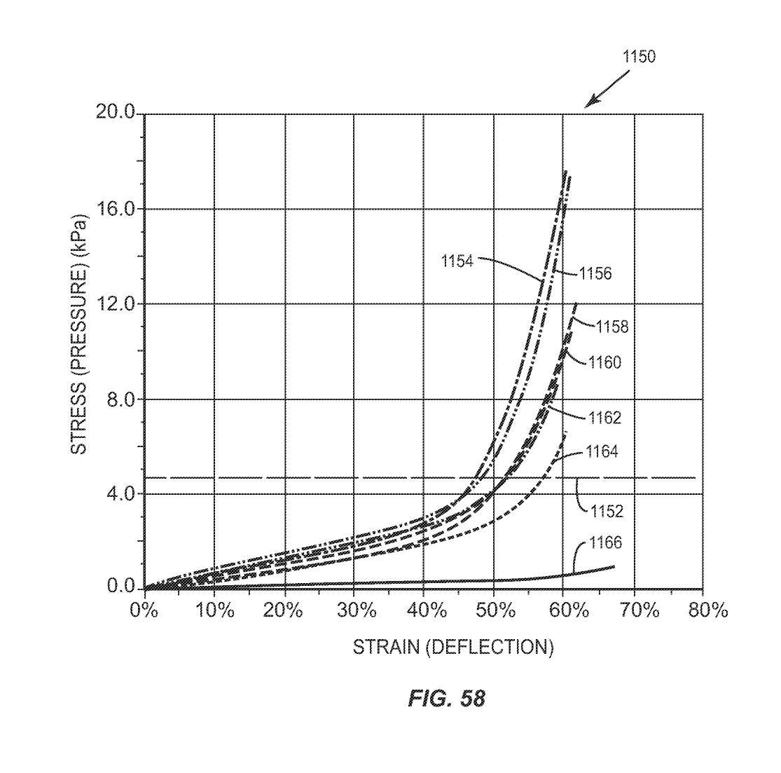

As another example, FIG. 58 illustrates a graph 1150 illustrating stress for a given strain for various unitary composite cushioning structure previously described above with regarding to a baseline characteristic curve 1152. In this example, the pressure limit 1152 is the theoretical pressure that should not be exceeded in order to provide comfort as perceived to an average person. In this example, characteristic curves 1154, 1156, 1158, 1160, 1162, 1164, 1166 are for unitary composite cushioning structures.

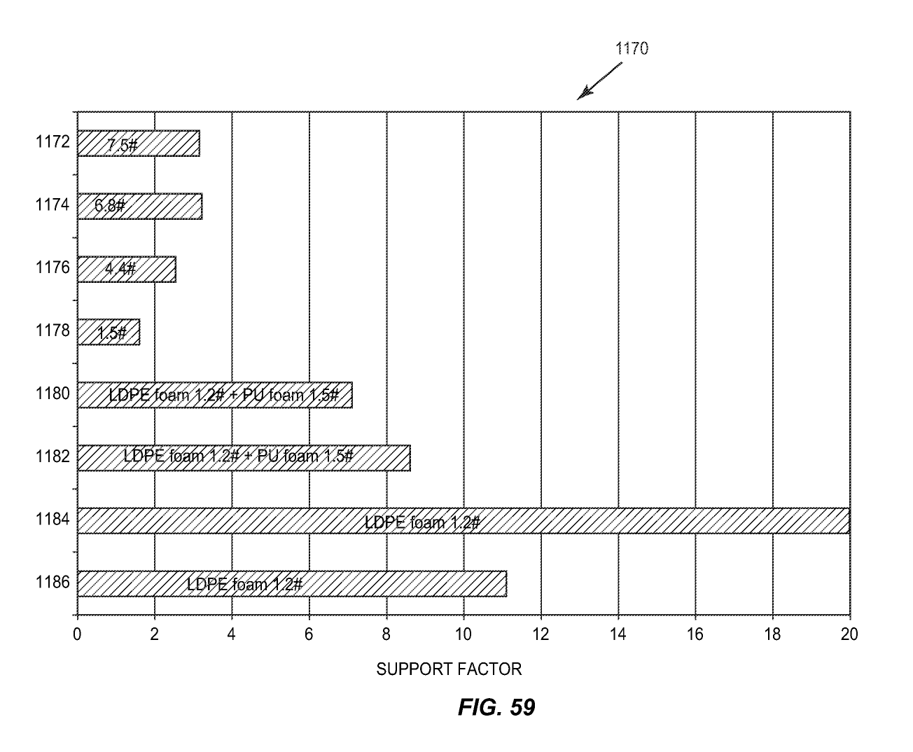

FIG. 59 illustrates a bar graph 1170 of exemplary support factors for various cushioning structures, including viscoelastic, latex, and unitary composite cushioning structures. The support factors were analyzed to determine the amount of support provided by different cushioning structures, including unitary composite cushioning structures, for comparison purposes. Support factor is the ration of compression force deflection (CFD), which is the force exerted by at 10,000 mm2 area on a sample after a sixty second hold while compresses to a given strain in this example. As illustrated in FIG. 59, the support factors for pink viscolelastic 1172, while viscoelastic 1174, latex 1176, polyurethane foam 1178, and the unitary composite cushioning structures 1180, 1182, 1184, 1186, which correspond to the unitary composite cushioning structure profiles.

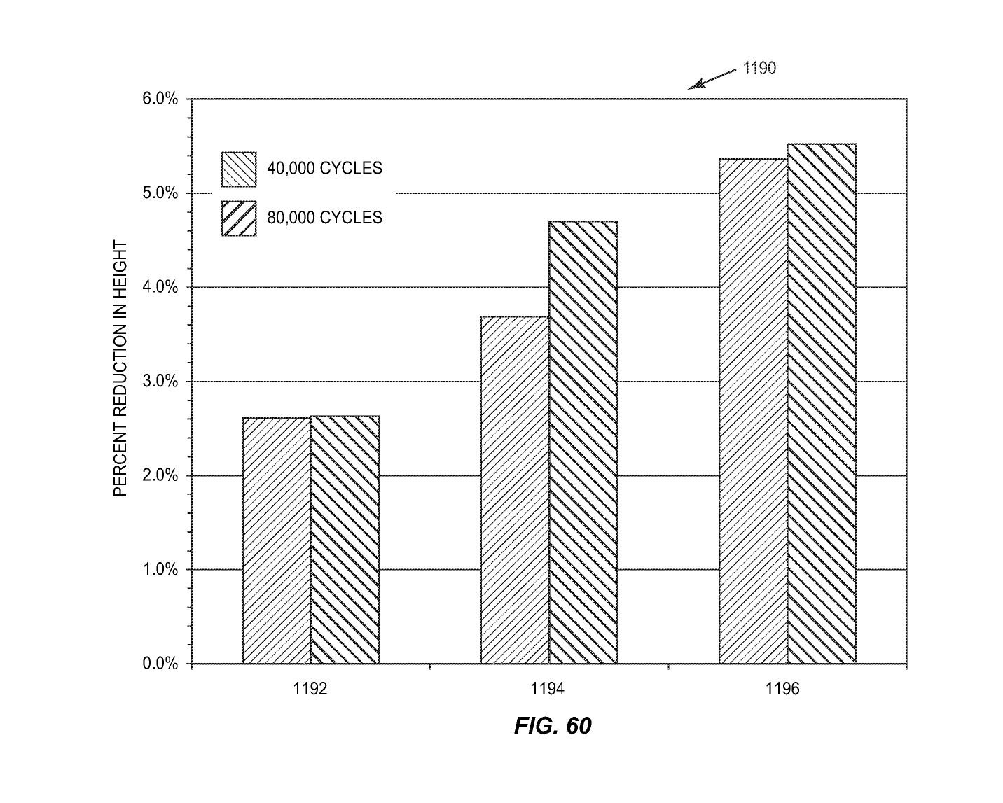

FIG. 60 illustrates a bar graph 1190 of exemplary percentage reduction in height vs. deflection cycles for various cushioning structures, including polyurethane and unitary composite cushioning structures. The percentage reduction in height was determined for two different cycles: 40,000 cycles, and 80,000 cycles. A cycle is a deflection of the cushioning structure. Reduction in height can be used to analyze and compare compression set. As illustrated in FIG. 60, a control polyurethane 1192 and two unitary composite cushioning structures 1194, 1196] were tested with the results provided in bar graph 1190.

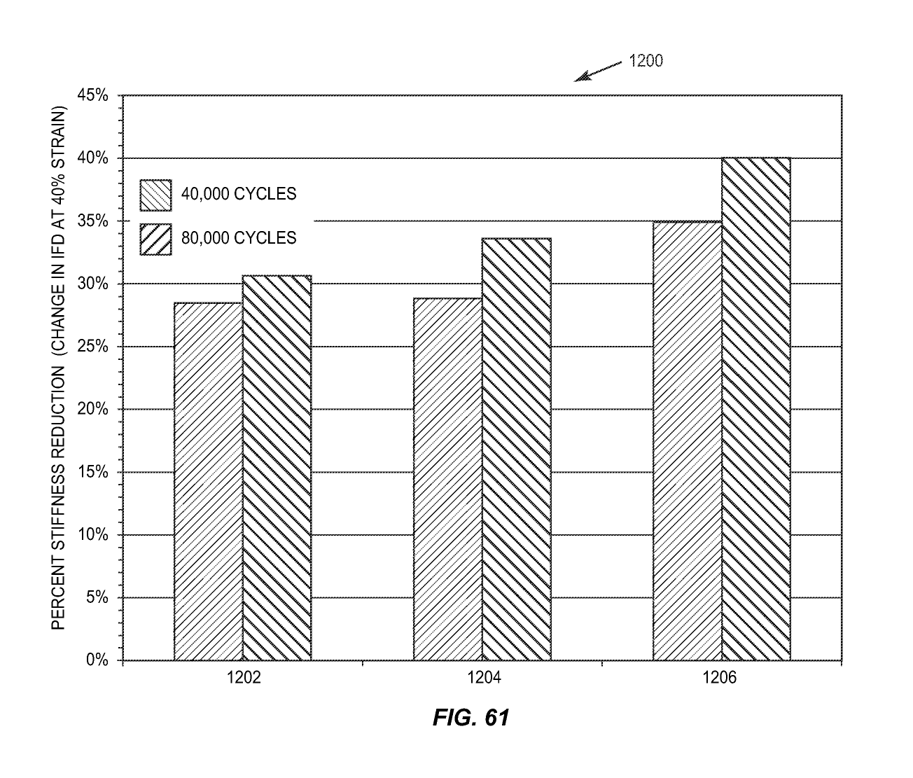

FIG. 61 illustrates a bar graph 1200 of exemplary percentage stiffness reduction in height vs. deflection cycles for various cushioning structures, including polyurethane and unitary composite cushioning structures. The percentage stiffness reduction was determined for two different cycles: 40,000 cycles, and 80,000 cycles. A cycle is a deflection of the cushioning structure. Stiffness reduction can be used to analyze and compare support characteristics. As illustrated in FIG. 61, a control polyurethane 1202 and two unitary composite cushioning structures 1204, 1206.were testing with the results provided in bar graph 1200.

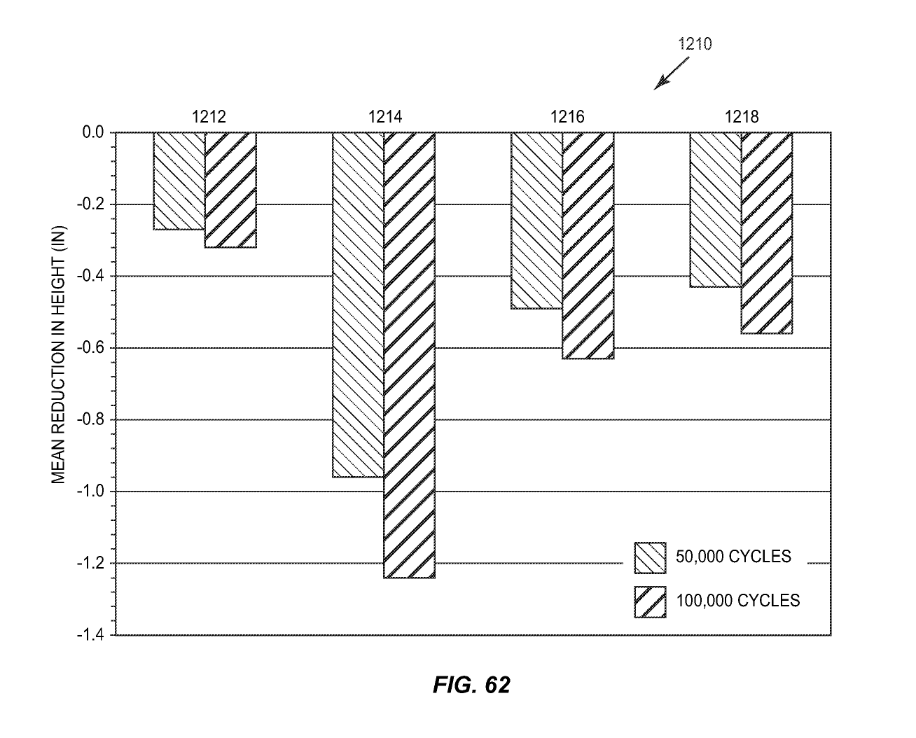

FIG. 62 illustrates a graph 1210 of exemplary mean reduction in height vs. deflection cycles for various cushioning structures, including polyurethane and unitary composite cushioning structures, using a stork twin cities rollator testing standard. The mean reduction in height was determined for two different cycles: 50,000 cycles, and 100,000 cycles. A cycle is a deflection of the cushioning structure. Stiffness reduction can be used to analyze and compare support characteristics. As illustrated in FIG. 62, a control polyurethane 1212 and three unitary composite cushioning structures 1214, 1216, 1218.were testing with the results provided in bar graph 1210.

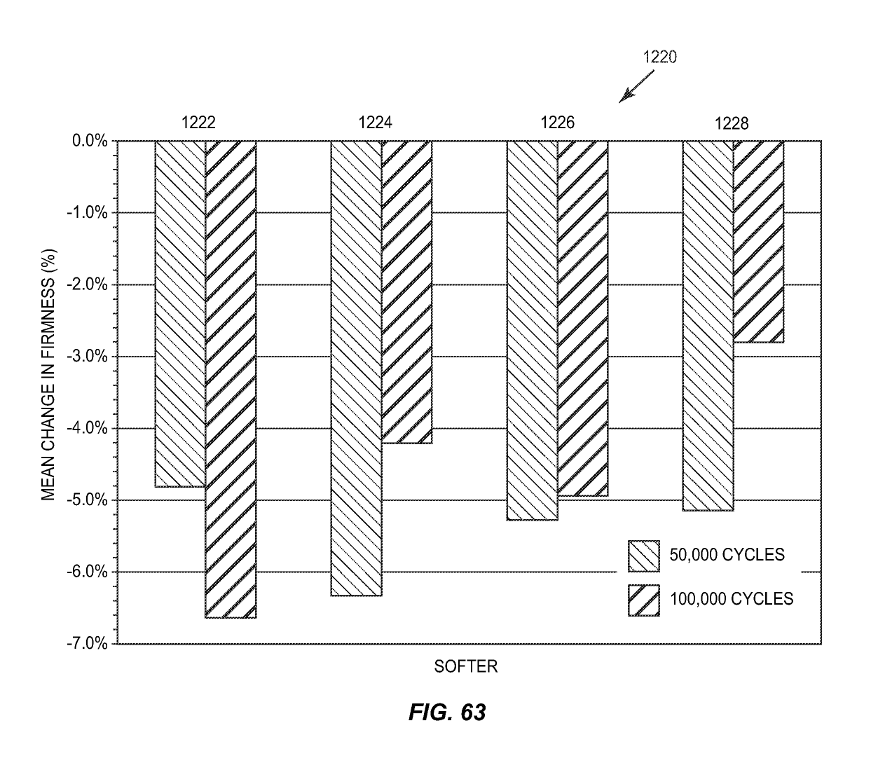

FIG. 63 illustrates a graph 1220 of exemplary mean change in firmness vs. deflection cycles for various cushioning structures, including polyurethane and unitary composite cushioning structures using a stork twin cities rollator testing standard. The mean percentage change in firmness was determined for two different cycles: 50,000 cycles, and 100,000 cycles. A cycle is a deflection of the cushioning structure. Firmness change can be used to analyze and compare support characteristics. As illustrated in FIG. 63, a control polyurethane 1222 and three unitary composite cushioning structures 1224, 1226, 1228.were testing with the results provided in bar graph 1220.

The present disclosure also involves the producing or manufacturing unitary composite cushioning profiles. In one embodiment as previously discussed and discussed in more detail below, the process involves the securing of the thermoset material to the cellular thermoplastic material in a continuous process. In this regard, the unitary composite cushioning structure formed from a cellular thermoplastic material and a cellular thermoset material can be formed by continuously extruding the cellular thermoplastic material providing support characteristics and cushioning characteristics. During the continuous extrusion of the cellular thermoplastic materials, a thermoset material providing a resilient structure with cushioning characteristics is dispensed in an initial non-solid phase on the cellular thermoplastic material provided in a profile by continuous extrusion.

The stratum may be continuously propagated between a portion of the cellular thermoplastic foam and a portion of the thermoset material during manufacture to secure the portion of the thermoset material to the portion of the cellular thermoplastic foam as the thermoset material is continuously dispensed into a continuously extruded cellular thermoplastic foam. Adhesive promoter(s) may be provided or mixed into the thermoset material and/or cellular thermoplastic material and dispensed in the cellular thermoplastic material to for a continuously propagated stratum disposed between at least a portion of the cellular thermoplastic material and at least a portion of the cellular thermoset material to secured to the cellular thermoplastic material profile to form a unitary composite cushioning structures.

By disposing a non-solid phase of the cellular thermoset material on a cellular thermoplastic foam profile, the cellular thermoset material undergoes a transition into a solid phase to secure the thermoset material with the cellular thermoplastic material. In this manner, at least a portion of the cellular thermoset material is secured to the at least a portion of the cellular thermoplastic material to form the unitary composite cushioning structure. The extruded profile of the cellular thermoplastic material and the amount and form of the thermoset material transforming into a solid phase in the cellular thermoplastic material is controlled according to the desired profiles and designs to exhibit the desired combination of the support characteristics and the resilient structure with cushioning characteristics when the unitary composite cushioning structure is placed under a load.

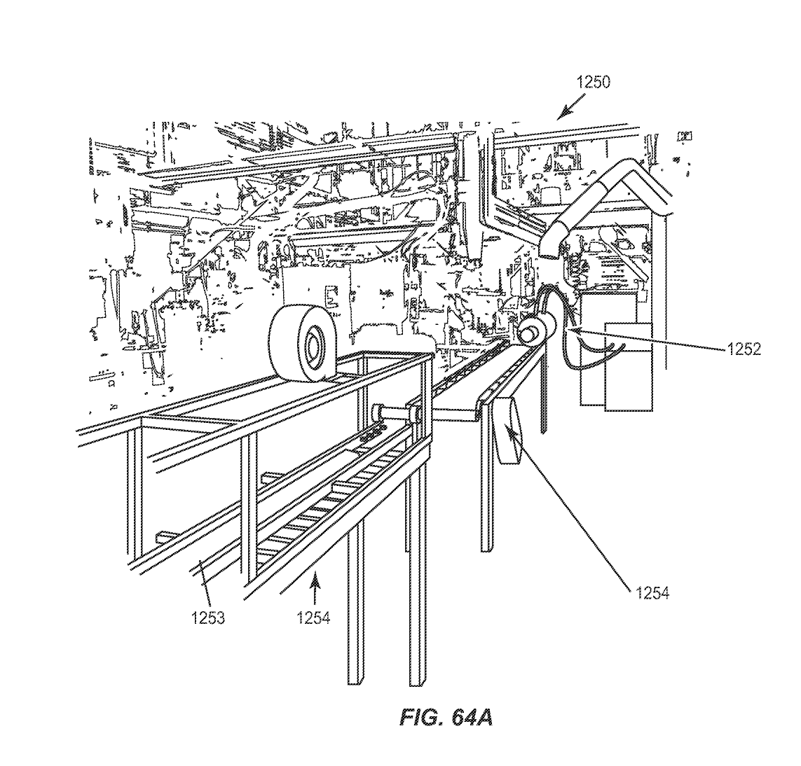

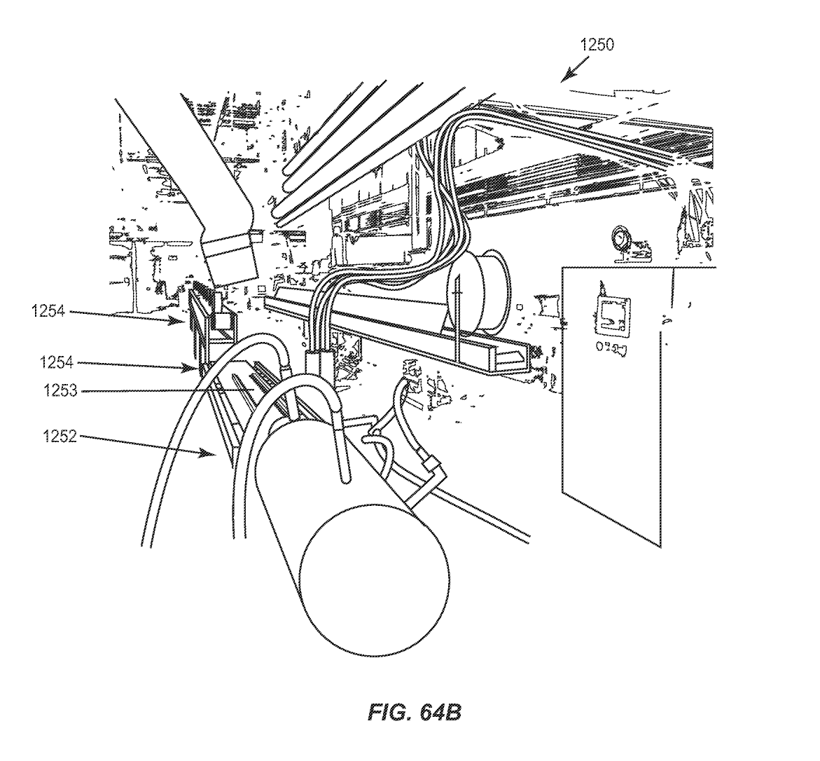

In this regard, FIGS. 64A and 64B illustrate one embodiment of a continuous extrusion system 1250 that may be employed to produce a unitary composite cushioning structure formed from a continuous extrusion of cellular thermoplastic material profile with a non-solid phase of thermoset material dispensed therein. The thermoset material will transform into a solid phase thereby forming a stratum to secure the thermoset material to the cellular thermoplastic material. FIG. 64A illustrates the continuous extrusion system 1250 in an upstream view when looking back towards an extruder 1252 that extrudes the cellular thermoplastic material into a desired cellular thermoplastic profile 1253 onto a conveyor 1254. FIG. 64B illustrates the continuous extrusion system 1250 in a downstream view when away from the extruder 1252 that extrudes the cellular thermoplastic material into the cellular thermoplastic profile 1253 towards the conveyor 1254. As will be described in more detail below, the extruder 1252 extrudes a cellular thermoplastic material into a desired profile to provide the thermoplastic component unitary composite cushioning structure. The extruded cellular thermoplastic material profile will extruded and pulled on the conveyor 1254 in a continuous process. In this regard, part of the disclosure herein will describe how the unitary composite cushioning structure can be manufactured in a continuous process, as opposed to for example, a discontinuous process.

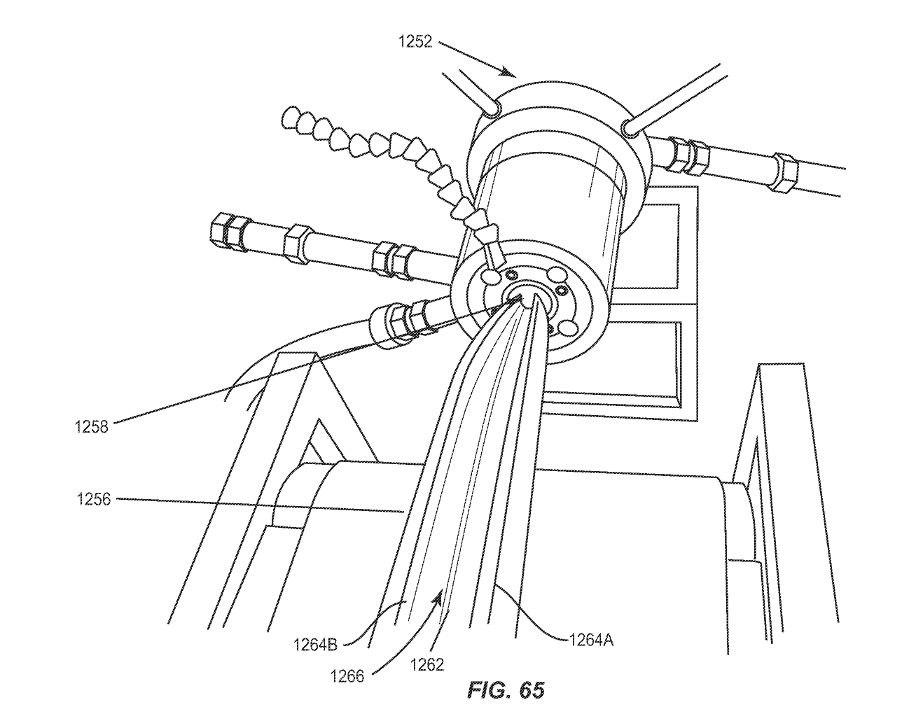

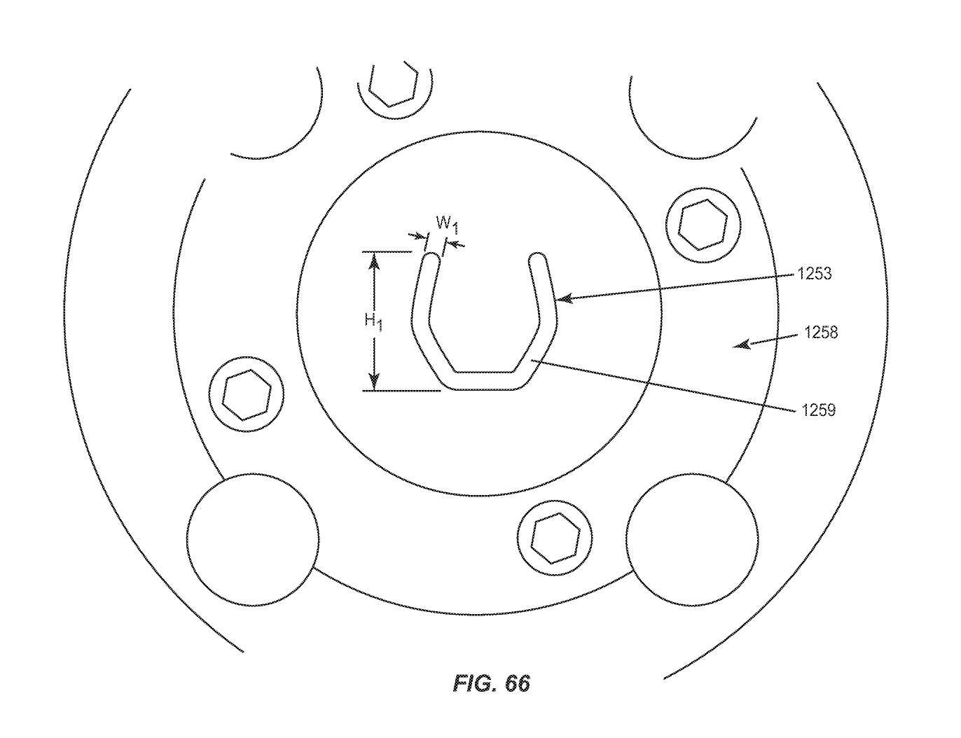

FIG. 65 illustrates a close-up view of the extruder 1252 in the continuous extrusion system 1250 in FIGS. 64A and 64B. As illustrated therein, the initial portion 1256 of the cellular thermoplastic profile 1253 is shown as being extruded by the extruder 1252 adjacent the extruder die 1258 (also illustrated in FIG. 66). As illustrated in FIG. 66, the extruder die 1258 is configured to extrude cellular thermoplastic material 1259 into the desired cellular thermoplastic profile, which is the cellular thermoplastic profile 1253 in this embodiment. In this embodiment, the extruder die 1258 has dimensions of approximately 0.5 inches height H1 with a 1/32″ width W1 wall opening to extrude the cellular thermoplastic material 1259. The cellular thermoplastic material 1259 may be mixed, injected with a blowing agent (e.g., isobutene) to be foamed, plasticized, pressurized, and/or cooled before being extruded by the extruder 1252. The cellular thermoplastic material 1259 may include an adhesion promoter if desired to promote adhesion with the thermoset material to create the continuously propagated stratum.

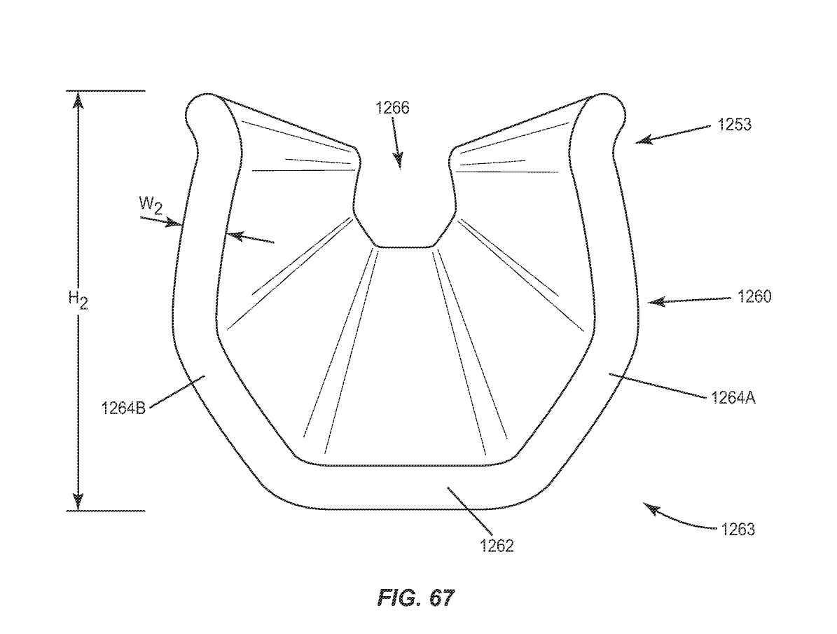

The cellular thermoplastic profile 1253 in this embodiment is extruded in a U-shaped form as illustrated in FIGS. 65 and 67. As shown in FIG. 67, the cellular thermoplastic profile 1253 is extruded with cylindrical shaped walls 1260, having a base portion 1262 and two side walls 1264A, 1264B extending up from the base portion 1262 on each side of the base portion 1262. In this embodiment as a non-limiting example, the continuous extrusion system 1250 is designed to produce the cellular thermoplastic profile 1253 in a height H2 of approximately 2.5 inches with a wall thickness W2 in the cylindrical-shaped walls 1260 of approximately 5/16 inches. An internal chamber 1266 is formed inside the cellular thermoplastic profile 1253. In this embodiment, the internal chamber 1266 is an open chamber and is configured and provided to receive a dispensed thermoset material in a non-solid phase. At least three sides 1263 comprising the base portion 1262 and the sidewalls 1264A, 1264B will surround, contain and hold the thermoset material in place as the thermoset material transforms into a solid form to form the stratum between the thermoset material and the cellular thermoplastic material 1259. The geometric configuration, density, and/or range of cell sizes can be varied in the cellular thermoplastic material 1259 to provide the desired support characteristics in a unitary composite cushioning structure. At the initial portion 1256 of the extruded cellular thermoplastic profile 1253 in FIG. 64, the cellular thermoplastic profile 1253 is not ready to receive the dispensed non-solid phase of thermoset material into the internal chamber 1266. The cellular thermoplastic profile 1253 needs to cool down to provide a more stable form before the thermoset material is dispensed in a non-solid phase into the internal chamber 1266 in this embodiment.

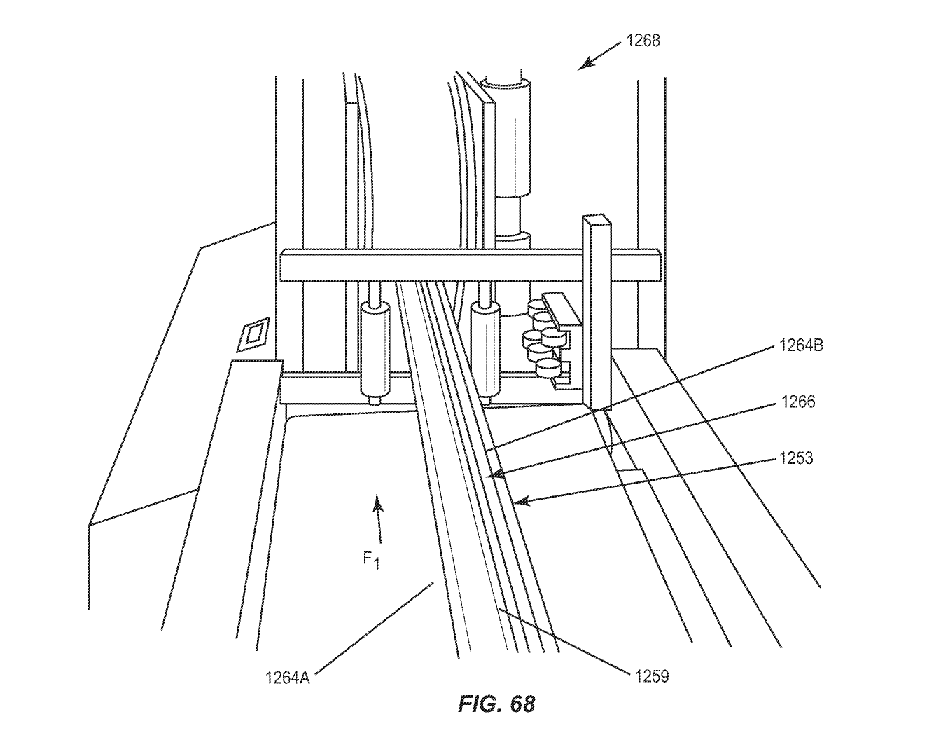

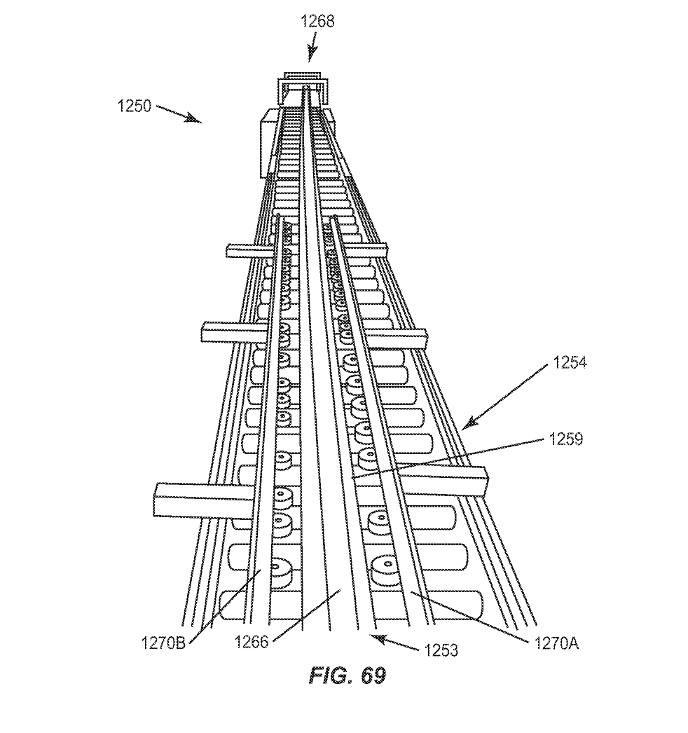

FIG. 68 illustrates the opposite end of the continuous extrusion system 1250 from the extruder 1252. In this embodiment, the puller apparatus 1268 is illustrated. The pulling apparatus 1268 receives and is coupled to the cellular thermoplastic profile 1253 as it is being extruded from the extruder 1252. The pulling apparatus 1268 applies a pulling force F1 as illustrated in FIG. 68 to produce the cellular thermoplastic profile 1253 in an elongated form according to the desired characteristics. The cellular thermoplastic profile 1253 is pulled along the conveyor 1254 from the extruder 1252 to the pulling apparatus 1268, as illustrated in FIG. 69. The conveyor 1254 may be employed with a guide system, such as guide rails 1270A, 1270AB as illustrated in FIG. 69 to guide the extruded cellular thermoplastic profile 1253 from the extruder 1252 to the pulling apparatus 1268. A cooling system may be employed on the conveyor 1254 to cool the cellular thermoplastic profile 1253 to cool the cellular thermoplastic material 1259 after being extruded by the extruder 1252 to allow the cellular thermoplastic material 1259 to more quickly take shape into its profile form to prepare the internal chamber 1266 to receive the non-solid phase of thermoset material.

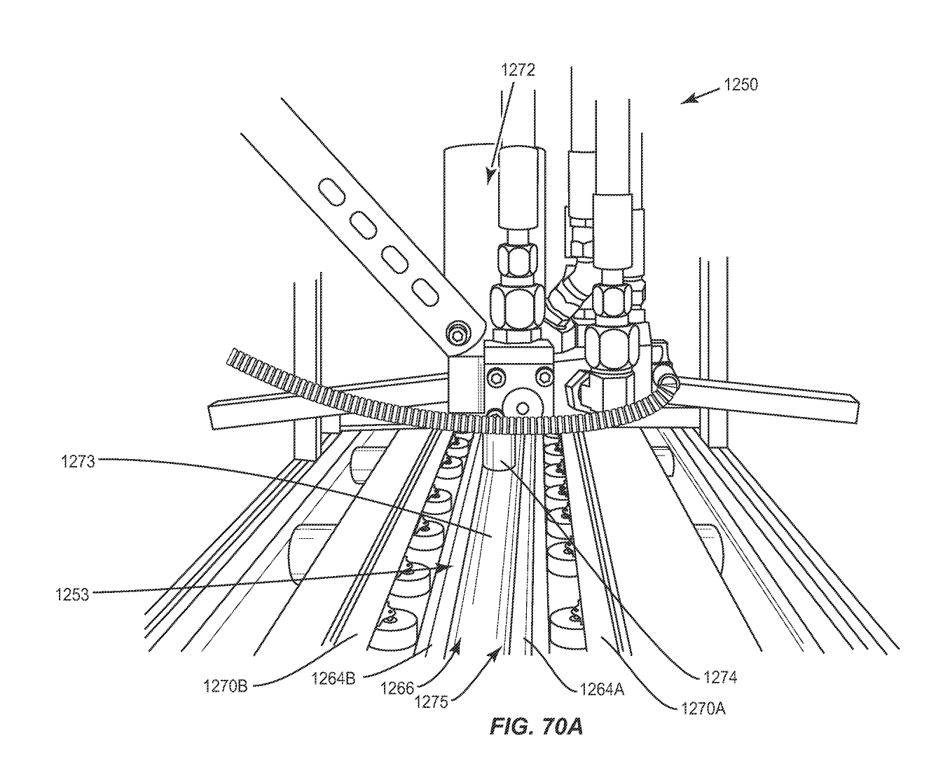

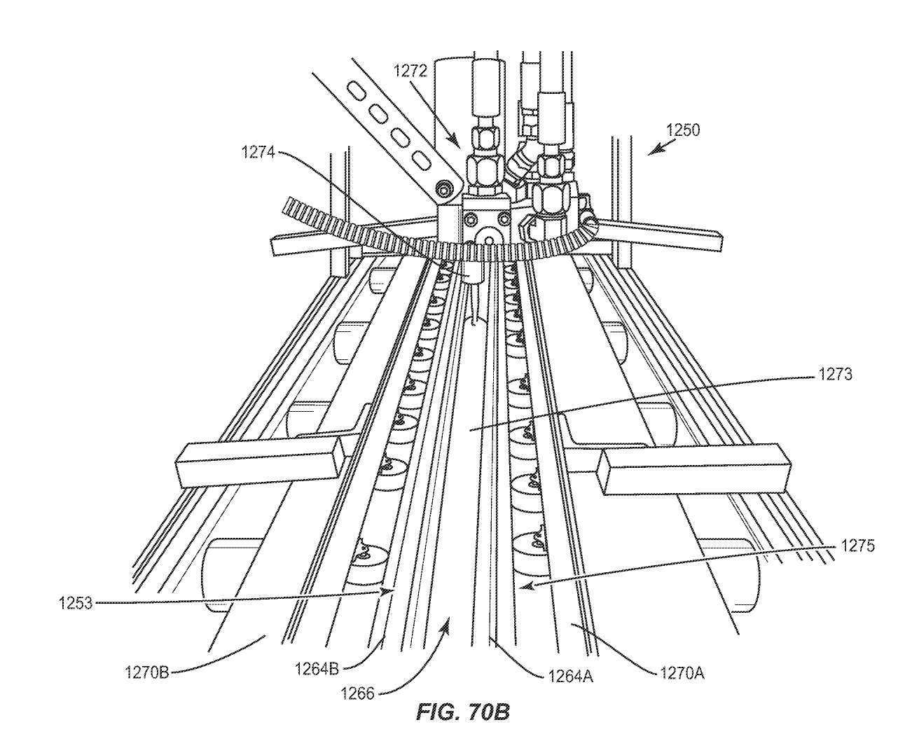

Once the cellular thermoplastic materials 1259 in the cellular thermoplastic profile 1253 has achieved a desired level of stability in formation, a thermoset material can be dispensed into the internal chamber 1266 of the cellular thermoplastic profile 1253. In this regard, FIGS. 70A and 70B illustrates dispensing a thermoset material in a non-solid phase into the internal chamber 1266 of the cellular thermoplastic profile 1253. As illustrated in FIG. 70A, a dispensing apparatus 1272 is provided in the continuous extrusion system 1250. The dispensing apparatus 1272 is lowered and configured to dispense a thermoset material 1273 into the internal chamber 1266 of the cellular thermoplastic profile 1253 as the cellular thermoplastic profile is being continuously extruded and pulling on the conveyor 1254, as illustrated in FIG. 70B. The dispensing apparatus 1272 in this embodiment includes a dispensing head 1274 that is disposed at a point along the conveyor 1254 wherein the cellular thermoplastic profile 1253 is stable enough to receive the thermoset material 1273. The dispensing head 1274 dispenses the thermoset material 1273 continuously as the cellular thermoplastic profile 1253 is continuously extruded to provide a continuous process of producing a unitary composite cushioning structure 1275.

As non-limiting examples, the thermoset material 1273 may be a polyurethane. The polyurethane dispensing process may begin by reacting a liquid isocyanate and a liquid polyol brought to a desired temperature and subjected to an intense high pressure mix. The two streams of isocynate and polyol are brought together in the dispensing head 1274 wherein the two streams are pumped through a defined size orifice to create adequate pressure for mixing. The two streams can then be directed impinged on one antler to create an eddy effect for efficient mixing. An endothermic reaction, which creates carbon dioxide from water within the polyol may begin at the point of impingement. The polyurethane liquid reactant being tempered and mixed is dispensed by the dispensing head 1274 directly into the internal chamber 1266 of the continuously extruded cellular thermoplastic profile 1253 which is moving along the conveyor 1254. The liquid reactant of the polyurethane begins to foam and rise within the internal chamber 1266 of the cellular thermoplastic profile 1253. Alternatively, the two streams could be dispensed separately into the internal chamber 1266 of the cellular thermoplastic profile 1253 by separate dispensing heads if desired.

The thermoset material 1273 free rises inside the internal chamber 1266 of the cellular thermoplastic profile 1253 begins soon after the thermoset material 1273 is dispensed in the internal chamber 1266 of the cellular thermoplastic profile 1253, which is approximately six (6) to eight (8) feet downstream towards the pulling apparatus 1268 from the dispensing head 1274 in this embodiment. The thermoset material 1273 may nominally rise to its maximum rise within the internal chamber 1266 of the cellular thermoplastic profile 1253 at approximately twenty (20) feet and maximum rise approximately thirty (30) to (40) feet downstream towards the pulling apparatus 1268 from the dispensing head 1274 in this embodiment.

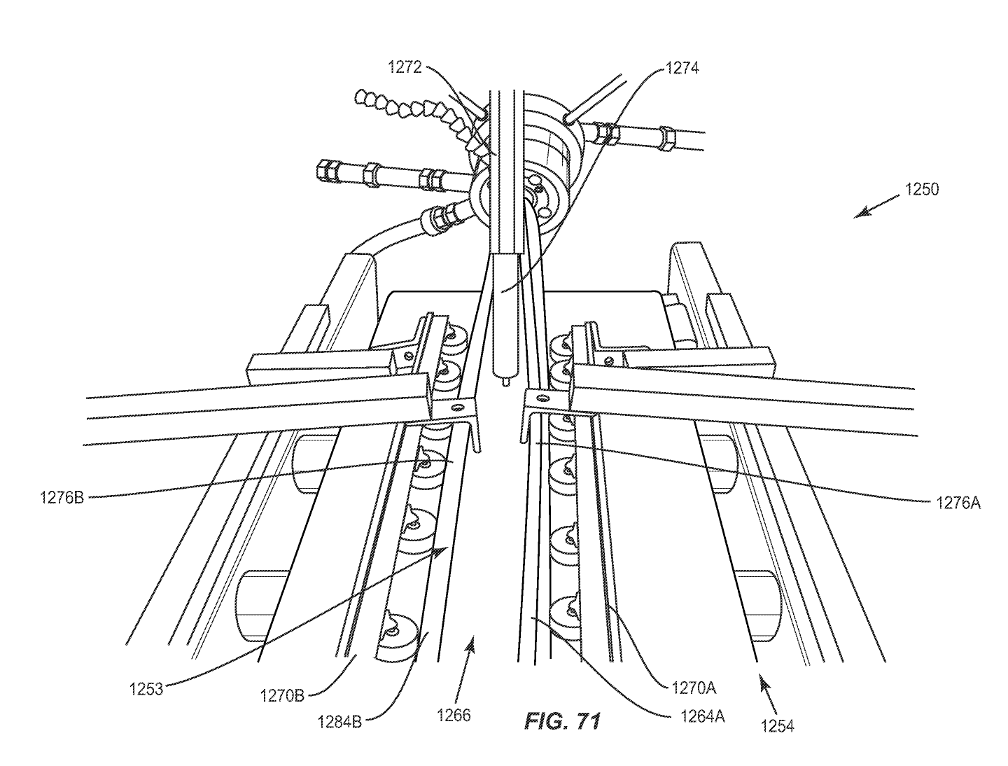

To assist in the dispensing of the thermoset material 1273 into the internal chamber 1266 of the cellular thermoplastic profile 1253, pulling members 1274A, 1274B can be provided along the conveyor 1254 between the extruder 1252 and the dispensing apparatus 1272, as illustrated in FIG. 71, to manipulate and pull the side walls 1264A, 1264B of the cellular thermoplastic profile 1253 apart as the thermoset material 1273 is dispensed, as illustrated in FIGS. 70A and 70B. Further as illustrated in FIG. 71, the conveyor 1254 may include rollers 1278A, 1278B disposed inside the guide rails 1270A, 1270B to assist in conveying the cellular thermoplastic profile 1253 down the conveyor 1254 to the pulling apparatus 1268.

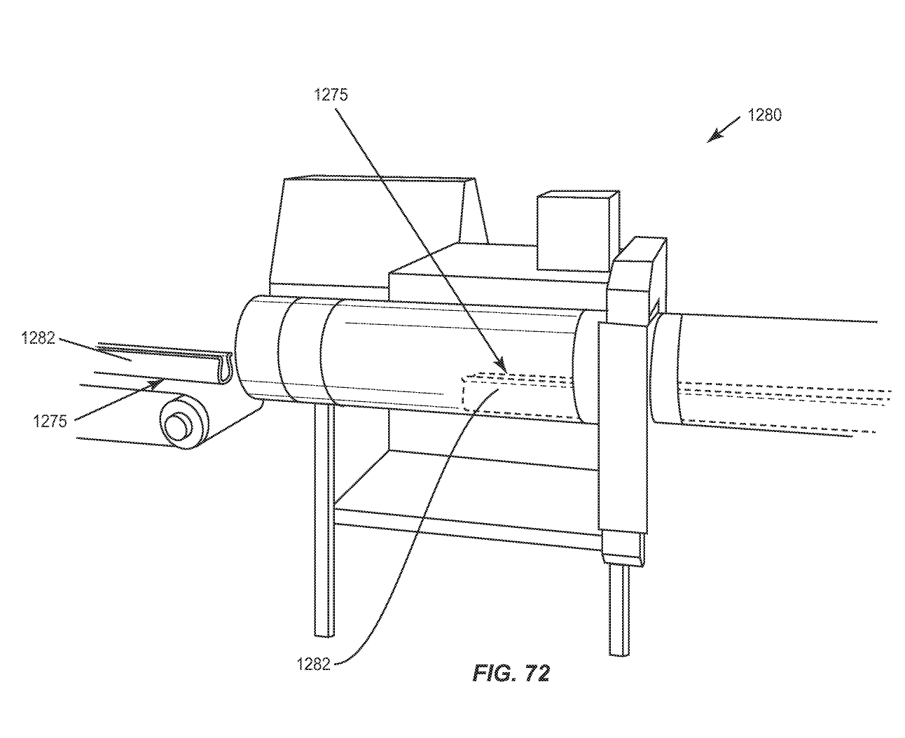

Further, the unitary composite cushioning structure 1275 can be disposed through a cutting machine 1280 downstream of the pulling apparatus 1268 as illustrated in FIG. 72, if desired, to cut the unitary composite cushioning structure 1275 into sections 1282, if desired to produce an inventory of the sections 1282. The cutting machine 1280 may employ any type of cutting apparatus, including but not limited to a knife, fly knife, traveling saw (e.g., band saw, rotary blade saw), and water jet. The cutting machine 1280 should preferably be able to cut partially cured thermoset material 1273 since the thermoset material may not have fully cured by the time the unitary composite cushioning structure 1275 reaches the cutting machine 1280. The sections 1282 can be employed to provide cushioning devices or apparatus, including but not limited to any of the unitary composite cushioning structures discussed above. These sections 1282 may be provide as separate sections in a cushioning structure to provide motion isolation as one example, as previously discussed. The sections 1282 may be arranged horizontally, vertically, or a combination thereof for a cushioning structure.

Although the embodiment of the unitary composite cushioning structure 1275 manufactured by the continuous extrusion system 1250 involves providing a cellular thermoplastic cellular profile 1253 having an internal chamber 1266 that is open, alternatives are possible. For example, the cellular thermoplastic profile could be extruded as a closed profile. In this regard, the extruder die 1258 could be provided that contains a closed die shape to provide a closed cylindrical (or other shaped) cellular thermoplastic profile. In this regard, the closed cellular thermoplastic profile could be cut open and in a continuous process if desired, and the thermoset material 1273 dispensed therein inside an internal chamber in the cellular thermoplastic profile. Thereafter, the opening in the cellular thermoplastic profile could be sealed back closed with the thermoset material disposed therein to form a unitary composite cushioning structure. The cellular thermoplastic profile could be sealed back closed with any technique desired including but not limited to gluing, welding, and stitching. Alternatively, the dispensing head could include needles that are configured to be inserted into a cellular thermoplastic profile and dispense thermoset material inside the cellular thermoplastic profile. In this regard, the dispensing needles could be provided in a needle system that travels on a conveyor above the conveyor 1254 to travel at the same speed as the conveyor 1254 to inject the cellular thermoplastic profile.

Many modifications and other embodiments set forth herein will come to mind to one skilled in the art to which the embodiments pertain having the benefit of the teachings presented in the foregoing descriptions and the associated drawings. The thermoplastic engineered foam profiles may be used in concert with the thermoset materials either singularly and/or in combination with each other to provide unitary composite cushioning structures. A thermoset material can be encapsulated by a thermoplastic material, filled inside the thermoset material, or both. A thermoplastic material can be encapsulated by a thermoset material, filled inside the thermoplastic material, or both. Chemical bonding can be provided between the thermoset and thermoplastic materials. One aspect would be the use of the foam spring profile in concert with the thermoset material as an internal fill to be used in a pocketed coil assembly in a similar fashion to the current metal coil spring variety and covered with the appropriate cloth structure in similar fashion to the metal coil spring design. These composite structure profiles may be produced by direct continuous extrusion, extrusion injection molding, blow molding, casting, thermal forming, and the like, with the most efficient method being one of direct continuous extrusion.

Therefore, it is to be understood that the invention is not to be limited to the specific embodiments disclosed and that modifications and other embodiments are intended to be included within the scope of the appended claims. It is intended that the present invention cover the modifications and variations of this invention provided they come within the scope of the appended claims and their equivalents. Although specific terms are employed herein, they are used in a generic and descriptive sense only and not for purposes of limitation.

What is claimed is:

1. A cushioning layer formed from a thermoplastic material and a thermoset material, comprising:
a plurality of unitary composite cushioning structures spaced apart in a first direction within each row of a plurality of rows, each row of the plurality of rows is spaced apart from an adjacent row in a second direction,
each of the plurality of unitary composite cushioning structures includes a stratum disposed between at least a portion of a thermoplastic material and at least a portion of a thermoset material to secure the at least a portion of the thermoset material to the at least a portion of the thermoplastic material to form the unitary composite cushioning structure,
wherein the first direction and the second direction are orthogonal to each other.

2. The cushioning layer of claim 1, wherein the plurality of unitary composite cushioning structures are equally spaced in at least one of the first direction and second direction.

3. The cushioning layer of claim 1, wherein a row of the plurality of rows is staggered with respect to an adjacent row of the plurality of rows.

4. The cushioning layer of claim 1, comprising a gap between adjacent unitary cushioning structures so that there is no contact between any of the unitary composite cushioning structures.

5. The cushioning layer of claim 1, wherein the thermoplastic material comprises polyethylene.

6. The cushioning layer of claim 1, wherein the thermoset material is foamed latex rubber.

7. The cushioning layer of claim 1, wherein the cushioning layer is disposed upon a base layer including thermoplastic material in a planar form.

8. The cushioning layer of claim 1, wherein the thermoplastic material provides support characteristics and cushioning characteristics.

9. The cushioning layer of claim 1, wherein the thermoset material provides a resilient structure with cushioning characteristics.

10. A mattress assembly for bedding or seating, comprising:
at least one cushioning layer formed from a thermoplastic material and a thermoset material, comprising:
a plurality of unitary composite cushioning structures spaced apart in a first direction within each row of a plurality of rows, each row of the plurality of rows is spaced apart from an adjacent row in a second direction,
each of the plurality of unitary composite cushioning structures includes a stratum disposed between at least a portion of the thermoplastic material and at least a portion of the thermoset material to secure the at least a portion of the thermoset material to the at least a portion of the thermoplastic material to form the unitary composite cushioning structure,
wherein the first direction and the second direction are orthogonal to each other.

11. The mattress assembly of claim 10, wherein the cushion layer is disposed upon a base layer including thermoplastic material in a planar form.

12. The mattress assembly of claim 10, wherein the thermoplastic material provides support characteristics and cushioning characteristics.

13. The mattress assembly of claim 10, wherein the thermoset material provides a resilient structure with cushioning characteristics

14. The mattress assembly of claim 10, wherein the plurality of unitary composite cushioning structures are equally spaced in at least one of the first direction and second direction.

15. The mattress assembly of claim 10, wherein a row of the plurality of rows is staggered with respect to an adjacent row of the plurality of rows.

16. The mattress assembly of claim 10, comprising a gap between adjacent unitary cushioning structures so that there is no contact between any of the unitary composite cushioning structures.

17. The mattress assembly of claim 10, wherein the thermoplastic material comprises polyethylene.

18. The mattress assembly of claim 10, wherein the thermoset material is foamed latex rubber.

19. A unitary composite cushioning structure formed from a thermoplastic material and a thermoset material, comprising:
an outer material including a closed profile comprising a base portion and a head portion including a neck portion therebetween, the outer material including one of the thermoplastic material and the thermoset material;
a core material disposed in the outer material, the core material including one of the thermoplastic material and the thermoset material; and
a stratum disposed between at least a portion of the outer material and at least a portion of the core material to secure the at least a portion of the thermoset material to the at least a portion of the thermoplastic material to form the unitary composite cushioning structure.

20. The unitary composite cushioning structure of claim 19, wherein the outer material comprises the thermoplastic material and the core material comprises the thermoset material.

21. The unitary composite cushioning structure of claim 19, wherein the outer material comprises a thermoset material and the core material comprises a thermoplastic material.

22. A continuous process to produce a unitary composite cushioning structure, comprising:
extruding thermoplastic material into a desired profile using an extruder die;
conveying the thermoplastic material using a conveyor in a direction away from the extruder die;
dispensing with a dispensing unit a thermoset material in a non-solid phase into an internal chamber of the desired profile of the thermoplastic material to form a unitary composite cushioning structure with a stratum of between a portion of the thermoset material and a portion of the thermoplastic material; and
cutting the unitary composite cushioning structure into segments.

23. The continuous process of claim 22, further comprising pulling the thermoplastic material after the extruding with a pulling system.

24. The continuous process of claim 22, further comprising performing a curing process on the unitary composite cushioning structure to cohesively set or adhesively bond the thermoset material to the thermoplastic material.

25. The continuous process of claim 24, wherein the curing process includes mixing a chemical bonding agent in with the thermoplastic material.

26. The continuous process of claim 22, wherein the desired profile comprises a U-shaped form comprising a base portion and two side walls extending up from the base portion.

27. The continuous process of claim 22, further comprising guiding the thermoplastic material from the extruder die to a pulling apparatus using guide rails.

28. The continuous process of claim 22, further comprising forming the internal chamber of the desired profile by cooling the thermoplastic material after the extruding.

29. The continuous process of claim 22, wherein the dispensing the thermoset material comprises bringing two streams of isocynate and polyol together at a dispensing head through an orifice to create an adequate pressure for mixing.

30. The continuous process of claim 22, wherein the dispensing the thermoset material comprises dispensing two streams of isocynate and polyol separately into the internal chamber.

31. The continuous process of claim 26, further comprising manipulating and pulling the two side walls apart of the desired profile between the extruder die and the dispensing unit.

32. The continuous process of claim 22, wherein the dispensing the thermoset material comprises dispensing at an orifice of a dispensing head two streams of isocynate and polyol brought together at the dispensing head to create an adequate pressure for mixing.

33. A mattress assembly, comprising:
a base containing a matrix of openings configured to support an outer diameter of foam springs to retain the foam springs in designated areas;
a top containing a similar matrix of openings configured to retain top portions of the foam springs;
a cover portion disposed atop the top to limit movement of the foam springs; and
side cuts disposed between adjacent foam springs to control cushioning and support characteristics.

34. The mattress assembly of claim 33, wherein each foam spring comprises outer material disposed around a spring.

35. The mattress assembly of claim 33, wherein each foam spring comprises outer material including thermoplastic material and the spring includes foam thermoset material.
